(19) United States
(12) Patent Application Publication
(10) Pub. No.: US 2021/0227604 A1
(43) Pub. Date: Jul. 22, 2021

(54) METHOD AND APPARATUS FOR MONITORING DEVICE-TO-DEVICE SIDELINK CONTROL SIGNAL IN A WIRELESS COMMUNICATION SYSTEM

(71) Applicant: ASUSTek Computer Inc., Taipei City (TW)

(72) Inventors: Chun-Wei Huang, Taipei City (TW); Ming-Che Li, Taipei City (TW); Yi-Hsuan Kung, Taipei City (TW)

(21) Appl. No.: 17/152,001

(22) Filed: Jan. 19, 2021

Related U.S. Application Data
(60) Provisional application No. 62/963,607, filed on Jan. 21, 2020.

(51) Int. Cl. H04W 76/14; H04W 76/28; H04W 72/02; H04W 72/04; H04W 28/02; H04W 72/12

(52) U.S. Cl. CPC H04W 76/14; H04W 76/28; H04W 72/02; H04W 92/18; H04W 28/0278; H04W 72/1278; H04W 72/0453

(57) ABSTRACT

A method and apparatus are disclosed. In an example, a first device receives a configuration and/or an information, wherein the configuration and/or the information is indicative of a DRX pattern, of the second device, associated with monitoring the sidelink resource pool. The first device transmits a signal to at least the second device on a first opportunity of a plurality of opportunities, wherein the signal indicates the second device to perform monitoring and/or sensing for a first duration. The first device selects a first candidate resource in the sidelink resource pool, wherein the first candidate resource is in a sleep time of the DRX pattern of the second device. The first device transmits a first sidelink transmission, including a sidelink data and/or a sidelink traffic, on the first candidate resource to the second device.

### CROSS-REFERENCE TO RELATED APPLICATIONS

The present application claims the benefit of U.S. Provisional Patent Application Ser. No. 62/963,607 filed on Jan. 21, 2020, the entire disclosure of which is incorporated herein in its entirety by reference.

### FIELD

This disclosure generally relates to wireless communication networks, and more particularly, to a method and apparatus for monitoring device-to-device sidelink control signal in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a first device performing sidelink communication with a second device using a sidelink resource pool, the first device receives a configuration and/or an information, wherein the configuration or the information is indicative of a Discontinuous Reception (DRX) pattern, of the second device, associated with monitoring the sidelink resource pool. The first device transmits, based on one or more triggering conditions being met, a signal to at least the second device on a first opportunity of a plurality of opportunities, wherein the signal indicates the second device to perform monitoring and/or sensing for a first duration. The first device selects a first candidate resource in the sidelink resource pool, wherein the first candidate resource is in a sleep time of the DRX pattern of the second device. The first device transmits a first sidelink transmission, comprising a sidelink data and/or a sidelink traffic, on the first candidate resource to the second device.

In an example from the perspective of a first device performing sidelink communication with a second device using a sidelink resource pool, the first device receives a configuration and/or an information, wherein the configuration and/or the information is indicative of a DRX pattern, of the second device, associated with monitoring the sidelink resource pool. The first device transmits a signal to at least the second device on a first opportunity of a plurality of opportunities, wherein the signal indicates the second device to perform monitoring and/or sensing for a first duration. The first device selects a first candidate resource in the sidelink resource pool, wherein the first candidate resource is in a sleep time of the DRX pattern of the second device. The first device transmits a first sidelink transmission, comprising a sidelink data and/or a sidelink traffic, on the first candidate resource to the second device.

In an example from the perspective of a first device performing sidelink communication with a second device using a sidelink resource pool, the first device receives a configuration and/or an information, wherein the configuration and/or the information is indicative of a DRX pattern, of the second device, associated with monitoring the sidelink resource pool. Physical Sidelink Feedback Channel (PSFCH) resources of the sidelink resource pool are configured, periodically with a period of N slots, in slots of the sidelink resource pool. The first device transmits a signal to at least the second device on a first opportunity of a plurality of opportunities, wherein opportunities of the plurality of opportunities are on symbols comprising PSFCH resources in the sidelink resource pool and on one or more frequency units without PSFCH resources. The signal indicates the second device to perform monitoring and/or sensing for a first duration. The first device selects a first candidate resource in the sidelink resource pool, wherein the first candidate resource is in a sleep time of the DRX pattern of the second device. The first device transmits a first sidelink transmission, comprising a sidelink data and/or a sidelink traffic, on the first candidate resource to the second device.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a timing diagram illustrating an exemplary scenario associated with a first device and a second device according to one exemplary embodiment.

FIG. 6 is a timing diagram illustrating an exemplary scenario associated with a first device and a second device according to one exemplary embodiment.

FIG. 7 is a timing diagram illustrating an exemplary scenario associated with a first device and a second device according to one exemplary embodiment.

FIG. 8 is a diagram associated with a sidelink resource pool according to one exemplary embodiment.

FIG. 9 is a timing diagram illustrating an exemplary scenario associated with a first device and a second device according to one exemplary embodiment.

FIG. 10 is a timing diagram illustrating an exemplary scenario associated with a first device and a second device according to one exemplary embodiment.

FIG. 11 is a flow chart according to one exemplary embodiment.

FIG. 12 is a flow chart according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

FIG. 20 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: 3GPP TS 36.213 V15.4.0 (2018-12), “E-UTRA; Physical layer procedures (Release 15)”; 3GPP TS 36.212 V15.4.0 (2018-12), “E-UTRA); Physical layer; Multiplexing and channel coding (Release 15)”; 3GPP TS 36.214 V15.3.0 (2018-09), “E-UTRA); Physical layer; Measurements (Release 15)”; R1-1913680, “Introduction of V2X in NR”, Samsung; R1-1913643, “Introduction of NR V2X”, Nokia; R1-1913601, “Summary of RAN1 Agreements/Working assumptions in WI 5G V2X with NR sidelink”, LG Electronics; 3GPP TS 38.321, V15.7.0, Medium Access Control (MAC) protocol specification. The standards and documents listed above are hereby expressly incorporated by reference in their entirety.

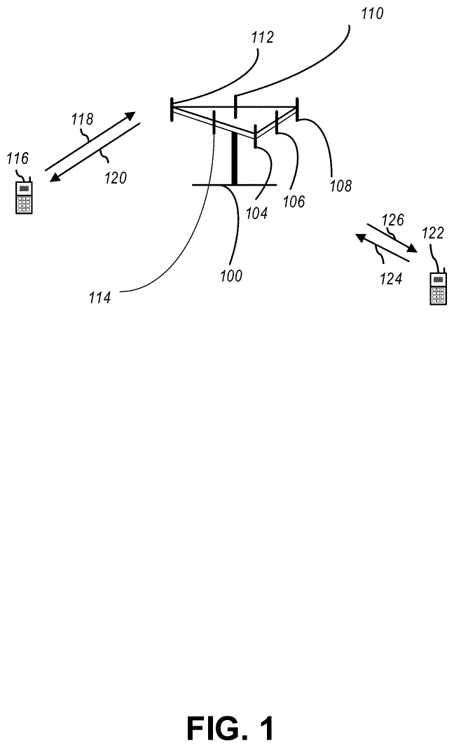

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

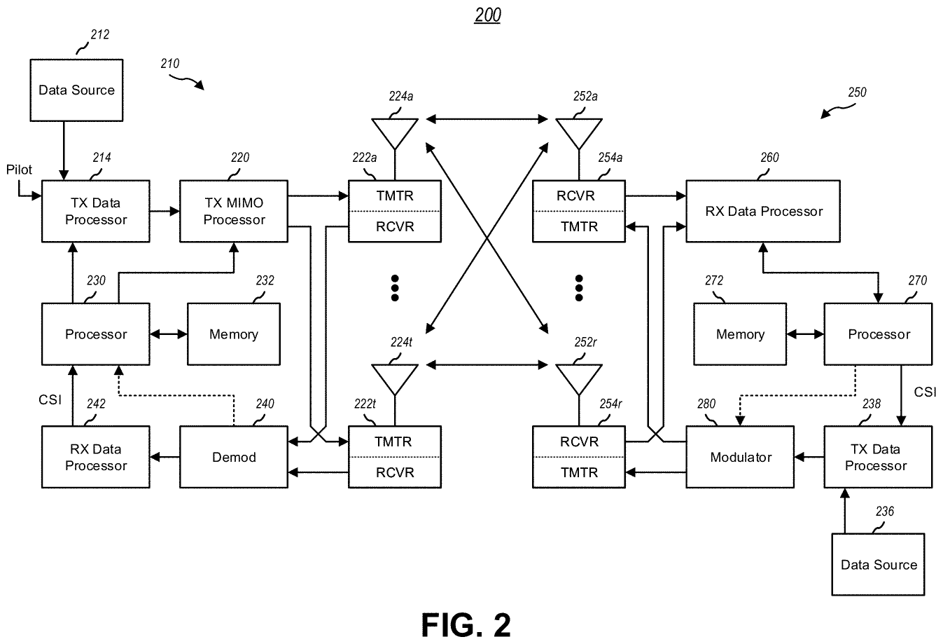

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

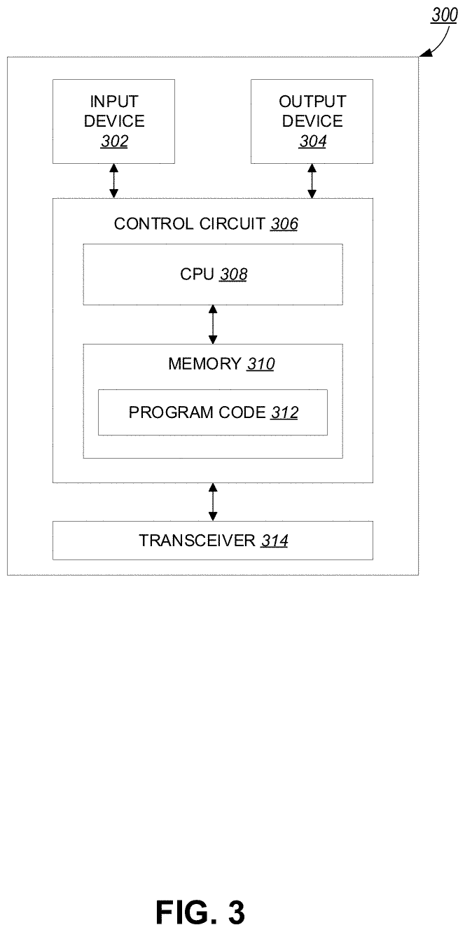

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

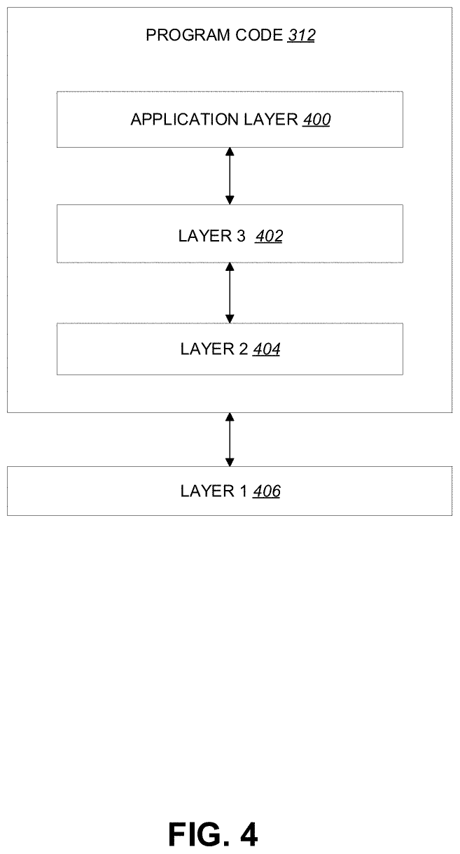

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

3GPP TS 36.213 V15.4.0 (2018-12) specifies UE procedure for V2X transmission in LTE and/or LTE-A. The V2X transmissions may be performed as sidelink transmission mode 3 and/or sidelink transmission mode 4. Some parts of 3GPP TS 36.213 V15.4.0 (2018-12) are quoted below:

### 14.1.1 UE Procedure for Transmitting the PSSCH

[ . . . ]
If the UE transmits SCI format 1 on PSCCH according to a PSCCH resource configuration in subframe n, then for the corresponding PSSCH transmissions of one TB
for sidelink transmission mode 3,
   the set of subframes and the set of resource blocks are determined using the subframe pool indicated by the PSSCH resource configuration (described in Subclause 14.1.5) and using “Retransmission index and Time gap between initial transmission and retransmission” field and “Frequency resource location of the initial transmission and retransmission” field in the SCI format 1 as described in Subclause 14.1.1.4A.
for sidelink transmission mode 4,
   the set of subframes and the set of resource blocks are determined using the subframe pool indicated by the PSSCH resource configuration (described in Subclause 14.1.5) and using “Retransmission index and Time gap between initial transmission and retransmission” field and “Frequency resource location of the initial transmission and retransmission” field in the SCI format 1 as described in Subclause 14.1.1.4B.
      [ . . . ]

### 14.1.1.6 U E Procedure for Determining the Subset of Resources to be Reported to Higher Layers in PSSCH Resource Selection in Sidelink Transmission Mode 4 and in Sensing Measurement in Sidelink Transmission Mode 3

In sidelink transmission mode 4, when requested by higher layers in subframe n for a carrier, the UE shall determine the set of resources to be reported to higher layers for PSSCH transmission according to the steps described in this Subclause. Parameters L_{subCH} the number of sub-channels to be used for the PSSCH transmission in a subframe, P_{rsvp_TX} the resource reservation interval, and prio_{TX} the priority to be transmitted in the associated SCI format 1 by the UE are all provided by higher layers (described in [8]). Cᵣₑₛₑₗ is determined according to Subclause 14.1.1.4B.

In sidelink transmission mode 3, when requested by higher layers in subframe n for a carrier, the UE shall determine the set of resources to be reported to higher layers in sensing measurement according to the steps described in this Subclause. Parameters L_{subCH}, P_{rsvp_TX} and prio_{TX} are all provided by higher layers (described in [11]). Cᵣₑₛₑₗ is determined by Cᵣₑₛₑₗ=10*SL_RESOURCE_RESELECTION_COUNTER, where SL_RESOURCE_RESELECTION_COUNTER is provided by higher layers [11].

If partial sensing is not configured by higher layers then the following steps are used:
1) A candidate single-subframe resource for PSSCH transmission R_{x,y} is defined as a set of L_{subCH} contiguous sub-channels with sub-channel x+j in subframe t_{y}^{SL} where j=0, . . . L_{subcH}−1. The UE shall assume that any set of L_{subCH} contiguous sub-channels included in the corresponding PSSCH resource pool (described in 14.1.5) within the time interval [n+T₁, n+T₂] corresponds to one candidate single-subframe resource, where selections of T₁ and T₂ are up to UE implementations under T₁≤4 and T₂ₘᵢₙ(prio_{TX})≤T₂≤100, if T₂ₘᵢₙ(prio_{IX}) is provided by higher layers for prio_{TX}, otherwise 20≤T₂≤100. UE selection of T₂ shall fulfil the latency requirement. The total number of the candidate single-subframe resources is denoted by Mₜₒₜₐₗ.
2) The UE shall monitor subframes t_{n′-10×P}_{ₛₜₑₚ}^{SL}, t_{n′-10×P}_{ₛₜₑₚ}₊₁^{SL}, . . . , t_{n′-1}^{SL} except for those in which its transmissions occur, where t_{n′}^{SL}=n if subframe n belongs to the set (t₀^{SL}, t₁^{SL}, . . . , t_{T}_{ₘₐₓ}^{SL}), otherwise subframe t_{n′}^{SL} is the first subframe after subframe n belonging to the set (t₀^{SL}, t₁^{SL}, . . . t_{T}_{ₘₐₓ}^{SL}). The UE shall perform the behaviour in the following steps based on PSCCH decoded and S-RSSI measured in these subframes.
3) The parameter Th_{a,b} is set to the value indicated by the i-th SL-ThresPSSCH-RSRP field in SL-ThresPSSCH-RSRP-List where i=a*8+b+1.
4) The set S_{A} is initialized to the union of all the candidate single-subframe resources. The set S_{B} is initialized to an empty set.
5) The UE shall exclude any candidate single-subframe resource R_{x,y} from the set S_{A} if it meets all the following conditions:
   the UE has not monitored subframe t_{z}^{SL} in Step 2.
   there is an integer j which meets y+j×P′_{rsvp_TX}=z+Pₛₜₑₚ×k×q where j=0, 1, . . . , Cᵣₑₛₑₗ−1, P′_{rsvp_TX}=Pₛₜₑₚ×P_{rsvp_TX}/100, k is any value allowed by the higher layer parameter restrictResourceReservationPeriod and q=1, 2, . . . , Q. Here,

$$Q = \frac{1}{k}$$

if k<1 and n′−z≤Pₛₜₑₚ×k, where t_{n′}^{SL}=n if subframe n belongs to the set t₀^{SL}, t₁^{SL}, . . . t_{T}_{ₘₐₓ}^{SL}, otherwise subframe t_{n′}^{SL} is the first subframe belonging to the set to t₀^{SL}, t₁^{SL}, . . . , t_{T}_{ₘₐₓ}^{SL} after subframe n; and Q=1 otherwise.
6) The UE shall exclude any candidate single-subframe resource R_{x,y} from the set S_{A} if it meets all the following conditions:
   the UE receives an SCI format 1 in subframe tₘ^{SL}, and “Resource reservation” field and “Priority” field in the received SCI format 1 indicate the values P_{rsvp_RX} and prio_{RX}, respectively according to Subclause 14.2.1.
   PSSCH-RSRP measurement according to the received SCI format 1 is higher than Thₚᵣᵢₒ_{_{TX,}}ₚᵣᵢₒ_{_{RX}}.
   the SCI format received in subframe tₘ^{SL} or the same SCI format 1 which is assumed to be received in subframe(s)

$${t}_{m + q \times {P}_{step} \times {P}_{rsvp\_RX}}^{S L}$$

determines according to 14.1.1.4C the set of resource blocks and subframes which overlaps with

$${R}_{x , y + j \times {P}_{rsvp\_TX}^{′}}$$

for q=1, 2, . . . , Q and j=0, 1, . . . , Cᵣₑₛₑₗ−1. Here,

$$Q = \frac{1}{{P}_{rsvp\_RX}}$$

if P_{rsvp_RX}<1 and n′−m≤Pₛₜₑₚ×P_{rsvp_RX}, where t_{n′}^{SL}=n if subframe n belongs to the set (t₀^{SL}, t₁^{SL}, . . . , t_{T}_{ₘₐₓ}^{SL}), otherwise subframe t_{n′}^{SL} is the first subframe after subframe n belonging to the set (t₀^{SL}, t₁^{SL}, . . . , t_{T}_{ₘₐₓ}^{SL}); otherwise Q=1.
7) If the number of candidate single-subframe resources remaining in the set S_{A} is smaller than 0.2·Mₜₒₜₐₗ, then Step 4 is repeated with Th_{a,b} increased by 3 dB.
8) For a candidate single-subframe resource R_{x,y} remaining in the set S_{A}, the metric E_{x,y} is defined as the linear average of S-RSSI measured in sub channels x+k for k=0, . . . , L_{subCH}−1 in the monitored subframes in Step 2 that can be expressed by

$${t}_{y \text{-} {P}_{step} * j}^{SL}$$

for a non-negative integer j if

$${P}_{rsvp\_TX} \geq 100 , and {t}_{y - {P}_{rsvp\_TX}^{′} * j}^{SL}$$

for a non-negative integer j otherwise.
9) The UE moves the candidate single-subframe resource R_{x,y} with the smallest metric E_{x,y} from the set S_{A} to S_{B}. This step is repeated until the number of candidate single-subframe resources in the set S_{B} becomes greater than or equal to 0.2·Mₜₒₜₐₗ,
10) When the UE is configured by upper layers to transmit using resource pools on multiple carriers, it shall exclude a candidate single-subframe resource R_{x,y} from S_{B} if the UE does not support transmission in the candidate single-subframe resource in the carrier under the assumption that transmissions take place in other carrier(s) using the already selected resources due to its limitation in the number of simultaneous transmission carriers, its limitation in the supported carrier combinations, or interruption for RF retuning time [10].

The UE shall report set S_{B} to higher layers.

### 14.2.1 UE Procedure for Transmitting the PSCCH

[ . . . ]

For sidelink transmission mode 3,
The UE shall determine the subframes and resource blocks for transmitting SCI format 1 as follows:
   SCI format 1 is transmitted in two physical resource blocks per slot in each subframe where the corresponding PSSCH is transmitted.
   If the UE receives in subframe n DCI format 5A with the CRC scrambled by the SL-V-RNTI, one transmission of PSCCH is in the PSCCH resource L_{Init} (described in Subclause 14.2.4) in the first subframe that is included in (t₀^{SL}, t₁^{SL}, t₂^{SL}, . . . ) and that starts not earlier than

$${T}_{DL} - \frac{{N}_{TA}}{2} \times {T}_{S} + ( 4 + m ) \times {10}^{- 3} .$$

L_{Init} is the value indicated by “Lowest index of the sub-channel allocation to the initial transmission” associated with the configured sidelink grant (described in [8]), (t₀^{SL}, t₁^{SL}, t₂^{SL}, . . . ) is determined by Subclause 14.1.5, the value m is indicated by ‘SL index’ field in the corresponding DCI format 5A according to Table 14.2.1-1 if this field is present and m=0 otherwise, T_{DL} is the start of the downlink subframe carrying the DCI, and N_{TA} and T_{S} are described in [3].
If “Time gap between initial transmission and retransmission” in the configured sidelink grant (described in [8]) is not equal to zero, another transmission of PSCCH is in the PSCCH resource L_{Re TX} in subframe t_{q+SG}_{_{gap}}^{SL}, where SF_{gap} is the value indicated by “Time gap between initial transmission and retransmission” field in the configured sidelink grant, start subframe t_{q}^{SL} corresponds to the subframe n+kᵢₙᵢₜ·L_{Re TX} corresponds to the value n_{subCh}^{start} determined by the procedure in Subclause 14.1.1.4C with the RIV set to the value indicated by “Frequency resource location of the initial transmission and retransmission” field in the configured sidelink grant.
   For sidelink transmission mode 4,
The UE shall determine the subframes and resource blocks for transmitting SCI format 1 as follows:
   SCI format 1 is transmitted in two physical resource blocks per slot in each subframe where the corresponding PSSCH is transmitted.
   If the configured sidelink grant from higher layer indicates the PSCCH resource in subframe tₙ^{SL}, one transmission of PSCCH is in the indicated PSCCH resource m (described in Subclause 14.2.4) in subframe tₙ^{SL}.
      If “Time gap between initial transmission and retransmission” in the configured sidelink grant (described in [8]) is not equal to zero, another transmission of PSCCH is in the PSCCH resource L_{ReTX} in subframe t_{n+SF}_{_{gap}}^{SL} where SF_{gap} is the value indicated by “Time gap between initial transmission and retransmission” field in the configured sidelink grant, L_{ReTX} corresponds to the value n_{subCH}^{start} determined by the procedure in Subclause 14.1.1.4C with the RIV set to the value indicated by “Frequency resource location of the initial transmission and retransmission” field in the configured sidelink grant.
the UE shall set the contents of the SCI format 1 as follows:
   the UE shall set the Modulation and coding scheme as indicated by higher layers.
   the UE shall set the “Priority” field according to the highest priority among those priority(s) indicated by higher layers corresponding to the transport block.
   the UE shall set the Time gap between initial transmission and retransmission field, the Frequency resource location of the initial transmission and retransmission field, and the Retransmission index field such that the set of time and frequency resources determined for PSSCH according to Subclause 14.1.1.4C is in accordance with the PSSCH resource allocation indicated by the configured sidelink grant.
   the UE shall set the Resource reservation field according to table 14.2.1-2 based on indicated value X, where X is equal to the Resource reservation interval provided by higher layers divided by 100.
   Each transmission of SCI format 1 is transmitted in one subframe and two physical resource blocks per slot of the subframe.

TABLE 14.2.1-1
Mapping of DCI format 5A offset field to indicated value m

| SL index field in | Indicated |
|---|---|
| DCI format 5A | value m |
| ‘00’ | 0 |
| ‘01’ | 1 |
| ‘10’ | 2 |
| ‘11’ | 3 |

TABLE 14.2.1-2
Determination of the Resource reservation field in SCI format 1

| Resource | | |
|---|---|---|
| reservation | | |
| field in SCI | Indicated | |
| format 1 | value X | Condition |
| ‘0001’, ‘0010’, . . . , | Decimal | The higher layer decides to |
| ‘1010’ | equivalent of | keep the resource for the |
| | the field | transmission of the next |
| | | transport block and the |
| | | value X meets 1 ≤ X ≤ 10. |
| ‘1011’ | 0.5 | The higher layer decides to |
| | | keep the resource for the |
| | | transmission of the next |
| | | transport block and the |
| | | value X is 0.5. |
| ‘1100’ | 0.2 | The higher layer decides to |
| | | keep the resource for the |
| | | transmission of the next |
| | | transport block and the |
| | | value X is 0.2. |
| ‘0000’ | 0 | The higher layer decides not |
| | | to keep the resource for the |
| | | transmission of the next |
| | | transport block. |
| ‘1101’, ‘1110’, | Reserved | |
| ‘1111’ | | |

3GPP TS 36.214 V15.3.0 (2018-09) specifies some measurements for sidelink transmission in LTE and/or LTE-A. Some parts of 3GPP TS 36.214 V15.3.0 (2018-09) are quoted below:

### 5.1.29 PSSCH Reference Signal Received Power (PSSCH-RSRP)

| | |
|---|---|
| Definition | PSSCH Reference Signal Received Power |
| | (PSSCH-RSRP) is defined as the linear |
| | average over the power contributions |
| | (in [W]) of the resource elements |
| | that carry demodulation reference |
| | signals associated with PSSCH, within |
| | the PRBs indicated by the associated |
| | PSCCH. |
| | The reference point for the PSSCH-RSRP |
| | shall be the antenna connector of the UE. |
| | If receiver diversity is in use by the |
| | UE, the reported value shall not be |
| | lower than the corresponding |
| | PSSCH-RSRP of any of the individual |
| | diversity branches |
| Applicable for | RRC_IDLE intra-frequency, |
| | RRC_IDLE inter-frequency, |
| | RRC_CONNECTED intra-frequency, |
| | RRC_CONNECTED inter-frequency |

NOTE: The power per resource element is determined from the energy received during the useful part of the symbol, excluding the CP.

### 5.1.30 Channel Busy Ratio (CBR)

| | |
|---|---|
| Definition | Channel busy ratio (CBR) measured in subframe |
| | n is defined as follows: |
| | For PSSCH, the portion of sub-channels in the |
| | resource pool whose S-RSSI measured by the UE |
| | exceed a (pre-)configured threshold sensed |
| | over subframes [n − 100, n − 1]; |
| | For PSCCH, in a pool (pre)configured such that |
| | PSCCH may be transmitted with its corresponding |
| | PSSCH in non-adjacent resource blocks, the |
| | portion of the resources of the PSCCH pool |
| | whose S-RSSI measured by the UE exceed a |
| | (pre-)configured threshold sensed over subframes |
| | [n − 100, n − 1], assuming that the PSCCH |
| | pool is composed of resources with a size of |
| | two consecutive PRB pairs in the frequency domain. |
| Applicable for | RRC_IDLE intra-frequency, |
| | RRC_IDLE inter-frequency, |
| | RRC_CONNECTED intra-frequency, |
| | RRC_CONNECTED inter-frequency |

NOTE: The subframe index is based on physical subframe index

### 5.1.31 Channel Occupancy Ratio (CR)

| | |
|---|---|
| Definition | Channel occupancy ratio (CR) evaluated at |
| | subframe n is defined as the total |
| | number of sub-channels used for its |
| | transmissions in subframes [n − a, n − 1] and |
| | granted in subframes [n, n + b] divided |
| | by the total number of configured sub-channels |
| | in the transmission pool over [n − a, n + b]. |
| Applicable for | RRC_IDLE intra-frequency, |
| | RRC_IDLE inter-frequency, |
| | RRC_CONNECTED intra-frequency, |
| | RRC_CONNECTED inter-frequency |

NOTE 1: a is a positive integer and b is 0 or a positive integer; a and b are determined by UE implementation with a+b+1=1000, a>=500, and n+b should not exceed the last transmission opportunity of the grant for the current transmission.
NOTE 2: CR is evaluated for each (re)transmission.
NOTE 3: In evaluating CR, the UE shall assume the transmission parameter used at subframe n is reused according to the existing grant(s) in subframes [n+1, n+b] without packet dropping.
NOTE 4: The subframe index is based on physical subframe index.
NOTE 5: CR can be computed per priority level

3GPP TS 36.212 V15.4.0 (2018-12) specifies Cyclic Redundancy Check (CRC) attachment for downlink shared channel and downlink control information in LTE and/or LTE-A. The downlink shared channel and downlink control information may be for communication between network node and UE, i.e. Uu link. The sidelink shared channel and sidelink control information are for communication between UEs, i.e. PC5 link or sidelink. Some parts of 3GPP TS 36.212 V15.4.0 (2018-12) are quoted below:

### 5.4.3.1.2 SCI Format 1

SCI format 1 is used for the scheduling of PSSCH.
The following information is transmitted by means of the SCI format 1:
Priority—3 bits as defined in subclause 4.4.5.1 of [7].
Resource reservation—4 bits as defined in subclause 14.2.1 of [3].
Frequency resource location of initial transmission and retransmission—└log₂ (N_{subchannel}^{SL}(N_{subchannel}^{SL}+1)/2)┘ bits as defined in subclause 14.1.1.4C of [3].
Time gap between initial transmission and retransmission—4 bits as defined in subclause 14.1.1.4C of [3].
Modulation and coding scheme—5 bits as defined in subclause 14.2.1 of [3].
Retransmission index—1 bit as defined in subclause 14.2.1 of [3].
Transmission format—1 bit, where value 1 indicates a transmission format including rate-matching and TBS scaling, and value 0 indicates a transmission format including puncturing and no TBS-scaling. This field is only present if the transport mechanism selected by higher layers indicates the support of rate matching and TBS scaling.
Reserved information bits are added until the size of SCI format 1 is equal to 32 bits. The reserved bits are set to zero.

Parts of R1-1913680 are quoted below:

### 16.3 UE Procedure for Reporting HARQ-ACK on Sidelink

A UE can be indicated by an SCI format scheduling a PSSCH, in one or more sub-channels from a number of N_{subch}^{PSSCH} sub-channels, to transmit a PSFCH with HARQ-ACK information in response to the PSSCH reception. The UE provides HARQ-ACK information that includes ACK or NACK, or only NACK.

A UE can be provided, by periodPSFCHresource, a number of slots in a resource pool for a period of PSFCH transmission occasion resources. If the number is zero, PSFCH transmissions in the resource pool are disabled.
A UE may be indicated by higher layers to not transmit a PSFCH in response to a PSSCH reception [11, TS 38.321].
If a UE receives a PSSCH in a resource pool and a ZYX field in a SCI format 0_2 scheduling the PSSCH reception indicates to the UE to report HARQ-ACK information for the PSSCH reception [5, TS 38.212], the UE provides the HARQ-ACK information in a PSFCH transmission in the resource pool. The UE transmits the PSFCH in a first slot that includes PSFCH resources and is at least a number of slots, provided by MinTimeGapPSFCH, of the resource pool after a last slot of the PSSCH reception.
A UE is provided, by rbSetPSFCH, a set of M_{PRB,set}^{PSFCH} PRBs in a resource pool for PSFCH transmission in a PRB of the resource pool.

### 16.4 UE Procedure for Transmitting PSCCH

A UE can be provided a number of symbols in a resource pool, by timeResourcePSCCH, starting from a second symbol that is available for SL transmissions in a slot, and a number of PRBs in the resource pool, by frequencyResourcePSCCH, for a PSCCH transmission with a SCI format 0_1.

Parts of R1-1913643 are quoted below:

### 8 Physical Sidelink Shared Channel Related Procedures

[ . . . ]
In the frequency domain, a sidelink resource pool consists of numSubchannel contiguous sub-channels. A sub-channel consists of subchannelsize contiguous PRBs, where numSubchannel and subchannelsize are higher layer parameters.

### 8.1 UE Procedure for Transmitting the Physical Sidelink Shared Channel

Each PSSCH transmission is associated with an PSCCH transmission.
That PSCCH transmission carries the 1^{st} stage of the SCI associated with the PSSCH transmission; the 2^{nd} stage of the associated SCI is carried within the resource of the PSSCH.
If the UE transmits SCI format 0-1 on PSCCH according to a PSCCH resource configuration in slot n and PSCCH resource m, then for the associated PSSCH transmission in the same slot
[ . . . ]

### 8.1.2.1 Resource Allocation in Time Domain

The UE shall transmit the PSSCH in the same slot as the associated PSCCH.
The minimum resource allocation unit in the time domain is a slot.

### 8.1.2.2 Resource Allocation in Frequency Domain

The resource allocation unit in the frequency domain is the sub-channel.
The sub-channel assignment for sidelink transmission is determined using the “Frequency resource assignment” field in the associated SCI.
The lowest sub-channel for sidelink transmission is the sub-channel on which the lowest PRB of the associated PSCCH is transmitted.
[ . . . ]

### 8.1.4 UE Procedure for Determining the Subset of Resources to be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of ms.
   The following higher layer parameters affect this procedure:
t2min_SelectionWindow: internal parameter T₂ₘᵢₙ is set to the corresponding value from higher layer parameter t2min_SelectionWindow for the given value of prio_{TX}.
SL-ThresRSRP_pi_pj: this higher layer parameter provides an RSRP threshold for each combination (pᵢ, pⱼ), where pᵢ is the value of the priority field in a received SCI format 0-1 and pⱼ is the priority of the transmission of the UE selecting resources; for a given invocation of this procedure, pⱼ=Prio_{TX}.
RSforSensing selects if the UE uses the PSSCH-RSRP or PSCCH-RSRP measurement, as defined in subclause 8.4.2.1.
reservationPeriodAllowed
t0_SensingWindow: internal parameter T₀ is defined as the number of slots corresponding to t0_SensingWindow ms.
   The resource reservation interval, P_{rsvp_TX}, if provided, is converted from units of ms to units of logical slots, resulting in P′_{rsvp_TX}.

### Notation:

(t₀^{SL}, t₁^{SL}, t₂^{SL}, . . . ) denotes the set of slots which can belong to a sidelink resource pool and is defined in [TBD].
The following steps are used:
1) A candidate single-slot resource for transmission R_{x,y} is defined as a set of L_{subCH} contiguous sub-channels with sub-channel x+j in slot t_{y}^{SL} where j=0, . . . , L_{subcH}−1. The UE shall assume that any set of L_{subCH} contiguous sub-channels included in the corresponding resource pool within the time interval [n+T₁, n+T₂] correspond to one candidate single-slot resource, where
   selection of T₁ is up to UE implementation under 0≤T₁≤T_{proc,1}, where T_{proc,1} is TBD;
   If T₂ₘᵢₙ is shorter than the remaining packet delay budget (in slots) then T₂ is up to UE implementation subject to T₂ₘᵢₙ≤T₂≤remaining packet budget (in slots); otherwise T₂ is set to the remaining packet delay budget (in slots).
   The total number of candidate single-slot resources is denoted by M total.
2) The sensing window is defined by the range of slots [n−T₀, n−T_{proc,0}) where T₀ is defined above and T_{proc,1} is TBD. The UE shall monitor slots which can belong to a sidelink resource pool within the sensing window except for those in which its own transmissions occur. The UE shall perform the behaviour in the following steps based on PSCCH decoded and RSRP measured in these slots.
3) The internal parameter Th(pᵢ) is set to the corresponding value from higher layer parameter SL-ThresRSRP_pi_pj for pⱼ equal to the given value of prio_{TX} and each priority value pᵢ.
4) The set S_{A} is initialized to the set of all the candidate single-slot resources.
5) The UE shall exclude any candidate single-slot resource R_{x,y} from the set S_{A} if it meets all the following conditions:
   the UE has not monitored slot tₘ^{SL} in Step 2.
   for any periodicity value allowed by the higher layer parameter reservationPeriodAllowed and a hypothetical SCI format 0-1 received in slot tₘ^{SL} with “Resource reservation period” field set to that periodicity value and indicating all subchannels of the resource pool in this slot, condition c in step 6 would be met.
6) The UE shall exclude any candidate single-slot resource R_{x,y} from the set S_{A} if it meets all the following conditions:
   a. the UE receives an SCI format 0-1 in slot tₘ^{SL}, and “Resource reservation period” field, if present, and “Priority” field in the received SCI format 0-1 indicate the values P_{rsvp_RX} and prio_{RX}, respectively according to Subclause [TBD] in [6, TS 38.213];
   b. the RSRP measurement performed, according to subclause 8.4.2.1 for the received SCI format 0-1, is higher than Th(prio_{RX});
   c. the SCI format received in slot tₘ^{SL} or the same SCI format which, if and only if the “Resource reservation period” field is present in the received SCI format 0-1, is assumed to be received in slot(s)

$${t}_{m + q \times {P}_{rsvp\_RX}^{′}}^{S L}$$

determines according to subclause [TBD] in [6, TS 38.213] the set of resource blocks and slots which overlaps with

$${R}_{x , y + j \times {P}_{rsvp\_TX}^{′}}$$

for q=1, 2, . . . , Q and j=0, 1, . . . , Cᵣₑₛₑₗ−1. Here, P′_{rsvp_RX} is P_{rsvp_RX} converted to units of logical slots,

$$Q = ⌈ \frac{{T}_{s c a l}}{{P}_{rsvp\_RX}} ⌉$$

if P_{rsvp_RX}<T_{scal} and n′−m≤P′_{rsvp_RX}, where tₙ^{SL}, =n if slot n belongs to the set (t₀^{SL}, t₁^{SL}, . . . , t_{T}_{ₘₐₓ}^{SL}), otherwise slot t_{n′}^{SL} is the first slot after slot n belonging to the set (t₀^{SL}, t₁^{SL}, . . . , t_{T}_{ₘₐₓ}^{SL}); otherwise Q=1. T_{scal} is FFS.
7) If the number of candidate single-slot resources remaining in the set S_{A} is smaller than 0.2·Mₜₒₜₐₗ, then Th(pᵢ) is increased by 3 dB for each priority value Th(pᵢ) and the procedure continues with step 4.
   The UE shall report set S_{A} to higher layers.

Parts of R1-1913601 are quoted below:

### Agreements:

At least for transmission perspective of a UE in a carrier, at least TDM between PSCCH/PSSCH and PSFCH is allowed for a PSFCH format for sidelink in a slot.

### Agreements:

It is supported, in a resource pool, that within the slots associated with the resource pool, PSFCH resources can be (pre)configured periodically with a period of N slot(s)
   N is configurable, with the following values
      1
      At least one more value>1
   The configuration should also include the possibility of no resource for PSFCH. In this case, HARQ feedback for all transmissions in the resource pool is disabled
HARQ feedback for transmissions in a resource pool can only be sent on PSFCH in the same resource pool

### Agreements:

A sequence-based PSFCH format with one symbol (not including AGC training period) is supported.
   This is applicable for unicast and groupcast including options ½.
   Sequence of PUCCH format 0 is the starting point.

### Agreements:

Resource selection window is defined as a time interval where a UE selects sidelink resources for transmission
   The resource selection window starts T1≥0 after a resource (re-)selection trigger and is bounded by at least a remaining packet delay budget

### Agreements:

For the period of N slot(s) of PSFCH resource, N=2 and N=4 are additionally supported.

### Agreements:

For a PSSCH transmission with its last symbol in slot n, when the corresponding HARQ feedback is due for transmission, it is expected to be in slot n+a where a is the smallest integer larger than or equal to K with the condition that slot n+a contains PSFCH resources.

### Agreements:

At least for the case when the PSFCH in a slot is in response to a single PSSCH:
   Implicit mechanism is used to determine at least frequency and/or code domain resource of PSFCH, within a configured resource pool. At least the following parameters are used in the implicit mechanism:
      Slot index (FFS details) associated with PSCCH/PSSCH/PSFCH
      Sub-channel(s) (FFS details) associated with PSCCH/PSSCH
      Identifier (FFS details) to distinguish each RX UE in a group for Option 2 groupcast HARQ feedback

### Agreements:

At least for mode 2, (Pre-)configuration can limit the maximum number of HARQ (re-) transmissions of a TB
   Up to 32

### Agreements:

In Mode-2, SCI payload indicates sub-channel(s) and slot(s) used by a UE and/or reserved by a UE for PSSCH (re-)transmission(s)

### Agreements:

The resource (re-)selection procedure includes the following steps
   Step 1: Identification of candidate resources within the resource selection window
   Step 2: Resource selection for (re-)transmission(s) from the identified candidate resources

### Agreements:

In Step 1 of the resource (re-)selection procedure, a resource is not considered as a candidate resource if:
   The resource is indicated in a received SCI and the associated L1 SL-RSRP measurement is above an SL-RSRP threshold
      The SL-RSRP threshold is at least a function of the priority of the SL transmission indicated in the received SCI and the priority of the transmission for which resources are being selected by the UE

### Agreements:

For the number of bits of L1 IDs,
   Layer-1 destination ID: 16 bits
   Layer-1 source ID: 8 bits

### Agreements:

In Step 1, initial L1 SL-RSRP threshold for each combination of pᵢ and pⱼ is (pre-)configured, where pᵢ—priority indication associated with the resource indicated in SCI and pⱼ—priority of the transmission in the UE selecting resources

### Agreements:

In Step 1, when the ratio of identified candidate resources to the total number of resources in a resource selection window, is less than X %, all configured thresholds are increased by Y dB and the resource identification procedure is repeated
   At least one value of X=20
Y=3

### Agreements:

For PSSCH-to-HARQ feedback timing, K is the number of logical slots (i.e. the slots within the resource pool)
   Working assumption:
For HARQ feedback in groupcast and unicast, when PSFCH resource is (pre-)configured in the resource pool,
   SCI explicitly indicates whether HARQ feedback is used or not for the corresponding PSSCH transmission.

### Agreements:

For the agreed sequence-based PSFCH format with one symbol (not including AGC training period),
   1 PRB is used.
   Only 1 bit can be carried for the case of N=1, where N denotes the period of slot having PSFCH resource in a resource pool,

### Agreements:

When reservation of a sidelink resource for an initial transmission of a TB at least by an SCI associated with a different TB is disabled, N_{MAX} is 3
   SCI signaling is designed to allow to indicate 1 or 2 or 3 resources at least of the same number of sub-channels with full flexibility in time and frequency position in a window W of a resource pool

### Agreements:

For a given time instance n when resource (re-)selection and re-evaluation procedure is triggered
   The resource selection window starts at time instance (n+T1), T1≥0 and ends at time instance (n+T2)
      The start of selection window T1 is up to UE implementation subject to T1≤T_{proc,1}
      T2 is up to UE implementation with the following details as a working assumption:
         T2≥T2ₘᵢₙ
         If T2ₘᵢₙ>Remaining PDB, then T2ₘᵢₙ is modified to be equal to Remaining PDB
      UE selection of T2 shall fulfil the latency requirement, i.e. T2≤Remaining PDB
   A sensing window is defined by time interval [n−T0, n−T_{proc,0})
      T0 is (pre-)configured, T0>T_{proc,0} FFS further details
   Time instances n, T0, T1, T2, T2ₘᵢₙ are measured in slots, FFS T_{proc,0} and T_{proc,1}
      Working assumption:
A single value of K is (pre-)configured in a resource pool.
K=3 is supported in addition to K=2.

### Agreement:

For implicit mechanism for PSFCH resource determination,
   Support FDM between PSFCH resources used for HARQ feedback of PSSCH transmissions with same starting sub-channel in different slots
For implicit mechanism for PSFCH resource determination,
   In a resource pool, one or multiple PSFCH candidate resources are determined from the starting sub-channel index and slot index used for the corresponding PSSCH
      Within the determined PSFCH candidate resources, PSFCH resource for actual transmission is selected based on at least the following parameters
         For unicast and groupcast HARQ feedback Option 1,
      For groupcast HARQ feedback Option 2,
         Member ID (i.e., the “identifier” agreed in RAN1#97 to distinguish each RX UE in a group for Option 2 groupcast HARQ feedback)
For a PSFCH format,
   In the symbols that can be used for PSFCH transmissions in a resource pool, a set of frequency resources is (pre-)configured for the actual use of PSFCH transmissions (i.e., PSFCH transmissions do not happen in other frequency resources).
      This (pre)configuration includes the case where all the frequency resources in a resource pool are available for the actual PSFCH transmission.

### Agreements:

Repetition of PSFCH format 0 (one-symbol PSFCH format agreed in RAN1#97) to two consecutive symbols is used.
   This implies that, two consecutive symbols are always used for transmission of PSFCH format 0.
   Note: The first symbol can be used for AGC training.

### Agreements:

L1 source ID is carried in 2^{nd} SCI.

### Agreements:

1st SCI includes at least
   Priority (QoS value),
   PSSCH resource assignment (frequency/time resource for PSSCH),
   Resource reservation period (if enabled),
   PSSCH DMRS pattern (if more than one patterns are (pre-)configured),
   2nd SCI format (e.g. information on the size of 2nd SCI),
   [2]-bit information on amount of resources for 2^{nd} SCI (e.g. beta offset or aggregation level)
   Number of PSSCH DMRS port(s)
   5-bit MCS
   FFS on some part of destination ID

### Agreements:

For Rel-16, (normal CP)
   Support 7, 8, 9, . . . , 14 symbols in a slot without SL-SSB for SL operation
      Target reusing Uu DM-RS patterns for each of the symbol-length, with modifications as necessary
         No other additional spec impact is expected for supporting 7, 8, . . . , 13
         # of DM-RS symbols
         2, 3, 4
      For a dedicated carrier, only 14-symbol is mandatory
There is a single (pre-)configured length of SL symbols in a slot without SL-SSB per SL BWP.
There is a single (pre-)configured starting symbol for SL in a slot without SL-SSB per SL BWP.

### Agreements:

Support W to be equal to 32 slots

### Agreements:

On a per resource pool basis, when reservation of a sidelink resource for an initial transmission of a TB at least by an SCI associated with a different TB is enabled:
   A period is additionally signalled in SCI and the same reservation is applied with respect to resources indicated within N_{MAX} within window W at subsequent periods
   A set of possible period values is the following: 0, [1:99], 100, 200, 300, 400, 500, 600, 700, 800, 900, 1000 ms
      <=4 bits are used in SCI to indicate a period
      An actual set of values is (pre-)configured
   Regarding the number of periods
      The number of remaining periodic reservations is not explicitly indicated in SCI

### Agreements:

T2ₘᵢₙ is (pre-)configured per priority indicated in SCI from the following set of values:
   {1, 5, 10, 20}*2^{μ}, where μ=0, 1, 2, 3 for SCS 15, 30, 60, 120 respectively

### Agreements:

In Step 2, randomized resource selection from the identified candidate resources in the selection window is supported

### Agreements:

T0 is (pre)-configured between: 1000+[100]ms and [100]ms

### Agreements:

Support (pre)-configuration per resource pool between:
L1 SL-RSRP measured on DMRS of PSSCH after decoding of associated 1^{st} stage SCI, or
L1 SL-RSRP measured on DMRS of PSCCH for 1^{st} SCI after decoding of associated 1^{st} stage SCI
Note: L1 SL-RSRP is measured only based on one of the above, but not both

### Agreements:

For signaling frequency resources of actual PSFCH transmission, down select one of followings:
   Bitmap indicates RBs in a resource pool

In 3GPP specification 3GPP TS 38.321, V15.7.0, Discontinuous Reception (DRX) is introduced:

### 5.7 Discontinuous Reception (DRX)

The MAC entity may be configured by RRC with a DRX functionality that controls the UE's PDCCH monitoring activity for the MAC entity's C-RNTI, CS-RNTI, INT-RNTI, SFI-RNTI, SP-CSI-RNTI, TPC-PUCCH-RNTI, TPC-PUSCH-RNTI, and TPC-SRS-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in TS 38.213 [6].
RRC controls DRX operation by configuring the following parameters:
drx-onDurationTimer: the duration at the beginning of a DRX Cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity.
   When a DRX cycle is configured, the Active Time includes the time while:
drx-onDurationTimer or drx-InactivityTimer or drx-RetransmissionTimerDL or drx-RetransmissionTimerUL or ra-ContentionResolutionTimer (as described in clause 5.1.5) is running; or
a Scheduling Request is sent on PUCCH and is pending (as described in clause 5.4.4); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clause 5.1.4).
   When DRX is configured, the MAC entity shall:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
   2> stop the drx-RetransmissionTimerDL for the corresponding HARQ process.
1> if a MAC PDU is transmitted in a configured uplink grant:
   2> start the drx-HARQ-RTT-TimerUL for the corresponding HARQ process in the first symbol after the end of the first repetition of the corresponding PUSCH transmission;
   2> stop the drx-RetransmissionTimerUL for the corresponding HARQ process.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a drx-HARQ-RTT-TimerUL expires:
   2> start the drx-RetransmissionTimerUL for the corresponding HARQ process in the first symbol after the expiry of drx-HARQ-RTT-TimerUL.
1> if a DRX Command MAC CE or a Long DRX Command MAC CE is received:
   2> stop drx-onDurationTimer;
   2> stop drx-InactivityTimer.
1> if drx-InactivityTimer expires or a DRX Command MAC CE is received:
   2> if the Short DRX cycle is configured:
      3> start or restart drx-ShortCycleTimer in the first symbol after the expiry of drx-InactivityTimer or in the first symbol after the end of DRX Command MAC CE reception;
      3> use the Short DRX Cycle.
   2> else:
      3> use the Long DRX cycle.
1> if drx-ShortCycleTimer expires:
   2> use the Long DRX cycle.
1> if a Long DRX Command MAC CE is received:
   2> stop drx-ShortCycleTimer;
   2> use the Long DRX cycle.
1> if the Short DRX Cycle is used, and [(SFN×10)+subframe number] modulo (drx-ShortCycle)=(drx-StartOffset) modulo (drx-ShortCycle); or
1> if the Long DRX Cycle is used, and [(SFN×10)+subframe number] modulo (drx-LongCycle)=drx-StartOffset:
   2> start drx-onDurationTimer after drx-SlotOffset from the beginning of the subframe.
1> if the MAC entity is in Active Time:
   2> monitor the PDCCH as specified in TS 38.213 [6];
   2> if the PDCCH indicates a DL transmission:
      3> start the drx-HARQ-RTT-TimerDL for the corresponding HARQ process in the first symbol after the end of the corresponding transmission carrying the DL HARQ feedback;
      3> stop the drx-RetransmissionTimerDL for the corresponding HARQ process.
   2> if the PDCCH indicates a UL transmission:
      3> start the drx-HARQ-RTT-TimerUL for the corresponding HARQ process in the first symbol after the end of the first repetition of the corresponding PUSCH transmission;
      3> stop the drx-RetransmissionTimerUL for the corresponding HARQ process.
   2> if the PDCCH indicates a new transmission (DL or UL):
      3> start or restart drx-InactivityTimer in the first symbol after the end of the PDCCH reception.
1> in current symbol n, if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
   2> not transmit periodic SRS and semi-persistent SRS defined in TS 38.214 [7];
   2> not report CSI on PUCCH and semi-persistent CSI on PUSCH.
1> if CSI masking (csi-Mask) is setup by upper layers:
   2> in current symbol n, if drx-onDurationTimer would not be running considering grants/assignments/DRX Command MAC CE/Long DRX Command MAC CE received until 4 ms prior to symbol n when evaluating all DRX Active Time conditions as specified in this clause:
      3> not report CSI on PUCCH.
         Regardless of whether the MAC entity is monitoring PDCCH or not, the MAC entity transmits HARQ feedback, aperiodic CSI on PUSCH, and aperiodic SRS defined in TS 38.214 [7] when such is expected.
         The MAC entity needs not to monitor the PDCCH if it is not a complete PDCCH occasion (e.g. the Active Time starts or ends in the middle of a PDCCH occasion).

In NR Rel-16, sidelink Vehicle-to-Everything (V2X) is introduced for providing increasing amounts of sidelink services. Sidelink services, scenarios and mechanisms are designed for vehicles for which battery consumption for sidelink communication is less of a concern (as compared to communication devices with smaller batteries, for example). However, in NR Rel-17 sidelink, since communication via PC5 interface is introduced for at least one of pedestrian UEs, vulnerable UEs, bicycle helmets, devices concerning battery (e.g., devices for which battery consumption is a concern), devices concerning power consumption (e.g., devices for which power consumption is a concern), etc., power saving mechanism for the devices shall be considered. In other words, some existing technical mechanisms for vehicle may not be suitable for battery-concerned devices (e.g., devices having a finite amount of stored power, where an amount of power consumed by the devices may have an effect on how long the devices can operate before stored power is depleted). For example, vehicles may always, continually and/or often perform monitoring and/or sensing for a sidelink resource pool and/or a sidelink control channel, while such behavior may drain and/or deplete power of battery-concerned devices. Hence, discontinuous monitoring and/or sensing (e.g., sidelink DRX) may be used as a power saving mechanism for battery-concerned devices. For example, a battery-concerned device may perform monitoring and/or sensing during (e.g., only during) configured (e.g., pre-configured) wake up time. For example, wake up time may correspond to a time during which the battery-concerned device is in wake up mode. In some examples, the battery-concerned device may not perform monitoring and/or sensing during sleep time. However, if a transmitter device (TX device) does not know whether or not a receiver device (RX device) (e.g., a battery-concerned RX device) is in wake up mode, and/or if some data of emergent service comes while the RX device is in sleep mode, the RX device may miss detecting and/or receiving a transmission performed by the TX device. Missing the transmission may cause unnecessary retransmission (e.g., retransmission performed by the TX device) and cause the channel (with which the TX device and the RX device communicated, for example) to become more congested and non-efficient. Thus, one or more techniques and/or devices are provided herein to solve the problem of unnecessary retransmissions and/or to enable the TX device to determine a wake up time of the RX device and/or perform operations based on the wake up time.

A first concept of the present disclosure is that a first device transmits a signal to a second device, where the signal may be a wake up signal and/or a DRX-disabled/deactivated signal. The first device may transmit the signal on a time unit in which the second device is performing monitoring and/or sensing, the second device is in wake up mode and/or the second device is in active time. The second device may monitor a first sidelink Bandwidth Part (SL BWP) (and/or a first sidelink carrier (SL carrier) and/or a first sidelink resource pool (SL resource pool) on the time unit. Alternatively and/or additionally, the second device may monitor a second SL BWP (and/or a second SL carrier and/or a second SL resource pool) on the time unit. The first SL BWP may be a whole BWP and/or may be wider than the second SL BWP. The second SL BWP may be a partial BWP and/or may be narrower than the first SL BWP. In an example, the second SL BWP may be a partial BWP of the first SL BWP and/or the second SL BWP may comprise partial bandwidth of the first SL BWP. The first device transmits the signal within the first SL BWP, or within the second SL BWP. The first device communicates with the second device in a first sidelink resource pool. For example, the first device performs sidelink transmission to the second device in the first sidelink resource pool.

When (and/or after) the second device receives the signal, the second device may keep monitoring and/or sensing (e.g., continue to perform monitoring and/or sensing) based on an indication in the signal. The second device may not perform discontinuous monitoring or discontinuous sensing (in one or more periods) based on the indication of the signal.

The signal may be used for disabling (and/or deactivating) DRX of the second device. The signal may indicate a length of time (e.g., how long) that DRX of the second device is to be disabled (and/or deactivated) by the second device. Alternatively and/or additionally, a disabled/deactivated time duration (e.g., a time duration for which the second device disables and/or deactivates DRX) may be indicated by the signal. Alternatively and/or additionally, the disabled/deactivated time duration may be configured (e.g., pre-configured) (e.g., the second device may be configured and/or pre-configured with the disabled/deactivated time duration). The disabled/deactivated time duration may begin when or after the second device receives the signal. In some examples, after the disabled/deactivated time duration (e.g., when or after the disabled/deactivated time duration ends), the second device may resume DRX. Alternatively and/or additionally, the second device may resume DRX when (and/or in response to) the second device receives a second signal for enabling, activating and/or resuming DRX. The signal may indicate when to start to disable (and/or deactivate) DRX of the second device (e.g., the signal may indicate a starting time, a starting slot and/or a starting symbol of the disabled/deactivated time duration). The signal may indicate one or more symbols and/or one or more slots in which DRX of the second device is to be disabled (and/or deactivated).

The signal is used to update monitoring behavior of the second device for one or more DRX cycles and/or one or more DRX periods.

Alternatively and/or additionally, the signal may be used for (and/or indicative of) enabling (and/or activating) DRX of the second device. The signal may indicate a length of time (e.g., how long) that DRX of the second device is to be enabled (and/or activated) by the second device. In some examples, the second device monitors Physical Sidelink Control Channel (PSCCH) continuously before receiving the signal. Alternatively and/or additionally, the second device may monitor PSCCH discontinuously for a time duration in response to receiving the signal. The time duration may be associated with one or more DRX periods (e.g., the time duration may correspond to a duration of the one or more DRX periods). The time duration may be derived by the second device based on a length and/or periodicity of one or more DRX periods. After the time duration associated with the signal, the second device may not monitor PSCCH discontinuously (e.g., the second device may monitor PSCCH continuously after the time duration associated with the signal).

The signal may indicate to (and/or instruct) the second device to switch BWPs (e.g., switch SL BWPs). The signal may indicate to (and/or instruct) the second device to switch from a first BWP (e.g., a first SL BWP) to a second BWP (e.g., a second SL BWP).

In some examples, the first BWP may be a partial BWP (e.g., a partial SL BWP) and/or the second BWP may be a whole BWP (e.g., a whole SL BWP). Alternatively and/or additionally, the first BWP may be narrower than the second BWP (e.g., the second BWP may be wider than the first BWP). Alternatively and/or additionally, the first BWP may be a partial BWP of the second BWP and/or the first BWP may comprise partial bandwidth of the second BWP.

In some examples, the first BWP may be a whole BWP (e.g., a whole SL BWP) and/or the second BWP may be a partial BWP (e.g., a partial SL BWP). Alternatively and/or additionally, the first BWP may be wider than the second BWP (e.g., the second BWP may be narrower than the first BWP). Alternatively and/or additionally, the second BWP may be a partial BWP of the first BWP and/or the second BWP may comprise partial bandwidth of the first BWP.

The signal is used for indicating to (and/or instructing) the second device to extend a monitoring and/or sensing duration (e.g., a duration of time during which the second device performs monitoring and/or sensing). Alternatively and/or additionally, the signal may be used for indicating to (and/or instructing) the second device to extend a wake up duration (e.g., a duration of time during which the second device is in wake up mode).

The signal may indicate (e.g., explicitly indicate or implicitly indicate) an indication associated with one or more DRX periods. In some examples, a number of periods of the one or more DRX periods (and/or a duration of the one or more DRX periods) may be configured (e.g., pre-configured). For example, when (and/or in response to) the second device receives the signal, the second device may derive and/or determine (based on the configuration of the number of periods, for example) that the indication of the signal corresponds to (and/or lasts for) the number of periods of the one or more DRX periods (such as the configured (e.g., pre-configured) DRX period). The indication may be available, activated and/or applicable until the end of the one or more DRX periods and/or until the start of a next DRX period after the one or more DRX periods. Alternatively and/or additionally, one or more opportunities for monitoring the signal may be in a periodic manner. The signal may indicate a first indication and/or the first indication may be applicable until another signal (received in a later opportunity of the one or more opportunities, for example) indicates a second indication (related to DRX) and/or until other configuration indicates a second indication (related to DRX).

The signal may be sidelink traffic (e.g., a portion of sidelink traffic). The signal may be transmitted with sidelink traffic. The signal may trigger the second device to wake up (e.g., enter wake up mode) for receiving, sensing and/or monitoring one or more reserved resources.

The signal may indicate one or more time units (e.g., one or more time units in the first sidelink resource pool), such as one or more time units after reception of the signal, wherein the second device is originally configured to be in sleep mode in one, some and/or all of the one or more time units (e.g., prior to receiving the signal, the second device may be configured to be in sleep mode in one, some and/or all of the one or more time units). The signal may indicate to (and/or instruct) the second device to be in wake up mode and/or to perform monitoring and/or sensing on the one or more time units.

The signal may indicate one or more frequency units (e.g., one or more frequency units in the first sidelink resource pool), such as one or more frequency units to be used after reception of the signal. The signal may indicate to (and/or instruct) the second device to perform monitoring and/or sensing on the one or more frequency units.

The signal may indicate one or more time units (e.g., one or more time units in the first sidelink resource pool), such as one or more time units after reception of the signal, wherein a duration of the one or more time units may be longer than a periodicity for monitoring the signal (e.g., a periodicity with which the second device monitors the signal periodically). The signal may indicate to (and/or instruct) the second device to be in wake up mode and/or to perform monitoring and/or sensing on the one or more time units.

The signal may indicate one or more time units (e.g., one or more time units in the first sidelink resource pool), such as one or more time units after reception of the signal, wherein a duration of the one or more time units may be equal to the periodicity for monitoring the signal. The signal may indicate to (and/or instruct) the second device to be in wake up mode and/or to perform monitoring and/or sensing on the one or more time units.

In some examples, the periodicity for monitoring the signal is in units of time units (e.g., in units of time units belonging to the first sidelink resource pool) or in units of slots (e.g., in units of slots belonging to the first sidelink resource pool).

The signal may indicate and/or trigger a SL Channel State Information (CSI) report request.

The signal may be a Medium Access Control Control Element (MAC CE) or a control information (e.g., a sidelink control information). Alternatively and/or additionally, the signal may be comprised in (and/or delivered via) a MAC CE or a control information (e.g., a sidelink control information).

The signal may be transmitted via PSCCH, Physical Sidelink Shared Channel (PSSCH) or Physical Sidelink Feedback Channel (PSFCH).

The signal may be a sidelink reference signal.

The signal may be a stand-alone sidelink control information. In some examples, stand-alone sidelink control information may correspond to sidelink control information that is transmitted by itself and/or without other types of information (such as scheduling information). In some examples, stand-alone sidelink control information may mean and/or imply that a sidelink transmission in a time unit and/or a slot (belonging to the first sidelink resource pool) comprises only the sidelink control information (and/or the sidelink transmission does not schedule sidelink data or sidelink traffic). In some examples, stand-alone sidelink control information may mean and/or imply that a sidelink transmission in a time unit and/or a slot (belonging to the first sidelink resource pool) comprises only a 1^{st} stage Sidelink Control Information (SCI) of the sidelink control information and/or a 2^{nd} stage SCI of the sidelink control information (and/or the sidelink transmission does not schedule sidelink data or sidelink traffic).

One or more time units and/or one or more frequency units (indicated by the signal) may be one or more resources in the first sidelink resource pool.

The one or more time units may be one or more slots, one or more mini-slots, one or more subslots, and/or one or more subframes (in the first sidelink resource pool).

The one or more frequency units may be one or more PRBs and/or one or more sub-channels (e.g., a sub-channel of the one or more sub-channels may contain one or more PRBs).

In some examples, the signal is transmitted via one frequency unit (e.g., only one frequency unit). The signal may be transmitted via one sub-channel (e.g., only one sub-channel).

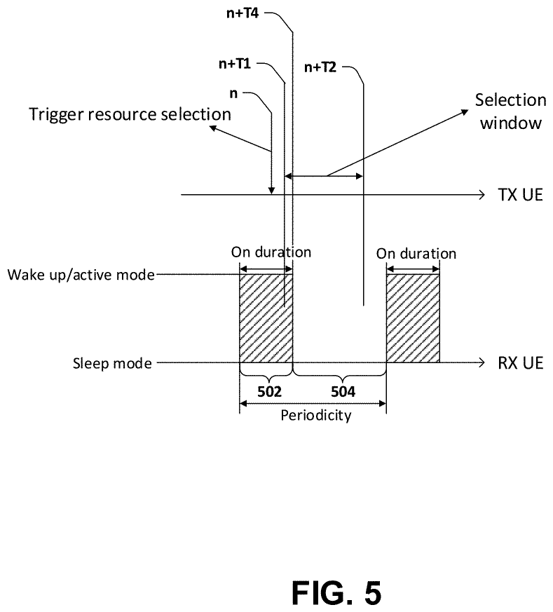

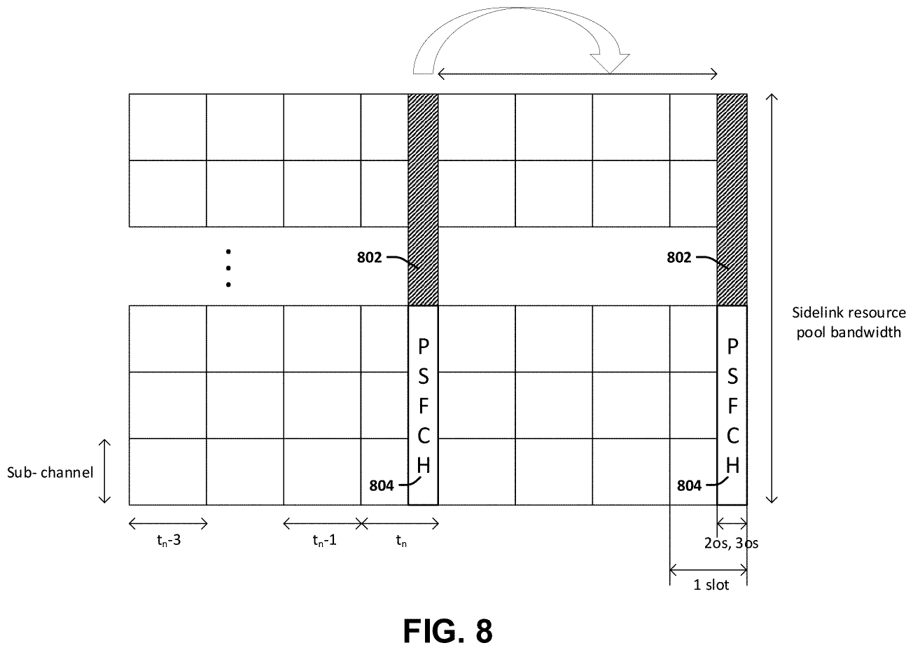

For example, such as in FIG. 5 and/or FIG. 8, the signal may be transmitted in symbols comprising PSFCH. FIG. 8 illustrates a diagram associated with a sidelink resource pool (e.g., the first sidelink resource pool). In some examples, when the second device is in wake up mode and/or On duration (e.g., On duration), the second device monitors, senses and/or receives a whole and/or a wider SL BWP (e.g., a wider SL BWP as compared to a SL BWP that the second device monitors, senses and/or receives when the second device is in sleep mode or another wake up mode). In some examples, with respect to FIG. 8, when the second device is in sleep mode (e.g., a portion of a DRX period excluding On duration), the second device may monitor areas 802 (e.g., the areas 802 are shown as diagonal-line filled regions in FIG. 8) which occupies less frequency resources and/or symbols than areas monitored in the wake up mode. The areas 802 occupy the same symbols as PSFCH regions 804 in the first sidelink resource pool. An area 802 is frequency-division multiplexed (FDMed) with a PSFCH region 804 in a sidelink resource pool (e.g., the first sidelink resource pool). The first device or a network may transmit the signal (to the second device, for example) in an area 802. For example, the first device may request the network to transmit the signal to wake up the second device. The first device, for a link between the first device and one or more devices, may reserve or be configured (e.g., pre-configured) with a third candidate resource in an area 802. The third candidate resource comprises one or more frequency units. The third candidate resource may be present in a periodic manner (e.g., the third candidate resource may be present periodically in response to and/or once the first device selects the third candidate resource, for example). A periodicity for the second device to monitor the signal may be a multiple (e.g., an integer multiple) of the PSFCH periodicity. The periodicity for monitoring the signal may correspond to a periodicity of the areas 802. The periodicity for monitoring the signal may be in units of slots belonging to the sidelink resource pool. In the example shown in FIG. 8, the PSFCH periodicity may be 4 slots and/or the periodicity for monitoring the signal may be 4 slots. The PSFCH periodicity may have other values and/or the periodicity for monitoring the signal may have other values (e.g., the periodicity for monitoring the signal may be 8 slots).

When sidelink traffic comes in (e.g., arrives at) the first device, the first device may perform resource selection. The sidelink traffic may be broadcast or groupcast for devices including the second device (e.g., the sidelink traffic may be for broadcast or groupcast transmission to devices including the second device). Alternatively and/or additionally, the sidelink traffic may be unicast for the second device (e.g., the sidelink traffic may be for unicast transmission to the second device). The first device may select a candidate resource, within a selection window, for transmitting the sidelink traffic (e.g., the selection window may be an original selection window, such as a resource selection window with which the first device is configured and/or pre-configured). The first device may select a candidate resource for transmitting the sidelink traffic, wherein the candidate resource is in a wake up time of the second device (e.g., an original wake up time, such as a wake up time with which the second device is configured and/or pre-configured to be in wake up mode) or in On duration of a DRX pattern of the second device. The first device may be configured (e.g., pre-configured) with a threshold. The threshold may be a number of candidate resources or a number of candidate slots in the selection window (considering the wake up time of the second device, for example). The threshold may be used for determining whether (and/or guaranteeing that) there are enough candidate resources for transmitting the sidelink traffic (e.g., the threshold may be applied to avoid selecting a candidate resource associated with a bad sensing result, for example). The threshold may be used for guaranteeing a number of candidate resources or a number of candidate slots (e.g., the number of candidate resources and/or the number of candidate slots may correspond to the threshold) for initial transmission of the sidelink traffic or a new transmission of the sidelink traffic (considering the wake up time of the second device, for example, such that the candidate resources amounting to the number of candidate resources or the candidate slots amounting to the number of candidate resources are during the wake up time or during On duration of the DRX pattern of the second device). When (and/or after) the second device receives the initial transmission of the sidelink traffic successfully during the wake up time of the second device (e.g., the original wake up time of the second device), the second device may know (e.g., determine) a retransmission resource (e.g., one or more resources for retransmission of the sidelink traffic) based on an indication in the initial transmission. Alternatively and/or additionally, in response to receiving the initial transmission of the sidelink traffic successfully during the wake up time of the second device, the second device may start a timer (e.g., an inactivity timer or a retransmission timer) to guarantee reception of retransmission of the sidelink traffic. Accordingly, even if the first device searches for a first candidate resource for initial transmission of the sidelink traffic (e.g., only searches for the first candidate resource for the initial transmission without searching for one or more candidate resources for retransmission of the sidelink traffic), due to the timer (e.g., the inactivity timer or the retransmission timer), the first device may select one or more second candidate resource after transmitting the first candidate resource. The one or more second candidate resources are within a period of time in which the timer (e.g., the inactivity timer or the retransmission timer) is running. The first device may check whether or not a number of candidate resources or a number of candidate slots, that are before an end of the resource selection window and/or expiration of the timer, is less than the threshold.

If the first device determines that the number of candidate slots or the number of candidate resources during the resource selection window (and/or during the wake up time (e.g., the original wake up time) of the second device) is less than the threshold, the first device may select a first candidate resource (e.g., a candidate resource with a smaller number of frequency units than one or more candidate resources that may be used and/or required for transmitting the sidelink traffic) for transmitting the signal during the wake up time (e.g., the original wake up time) of the second device (e.g., the signal, rather than the sidelink traffic, may be transmitted during the wake up time). If the number of candidate resources or the number of slots is less than the threshold, the first device may transmit the signal on a slot in which the second device performs monitoring and/or performs sensing and/or the first device may stop triggering resource selection (and/or the first device may not trigger resource selection) for transmitting the sidelink traffic and/or the sidelink data. If the number of candidate resources or the number of slots is larger than the threshold, the first device may not transmit the signal and/or the first device may select a first candidate resource delivering the sidelink traffic and/or the sidelink data during a time duration. The time duration may not include sleep time of the second device. In some examples, the time duration may correspond to the disabled/deactivated time duration for which the second device disables and/or deactivates DRX (e.g., the time duration may correspond to at least a portion of the disabled/deactivated time duration, where the at least the portion may not include sleep time of the second device, such as a time during which the battery-concerned device is in sleep mode). Alternatively and/or additionally, the time duration may be associated with one or more DRX periods (e.g., the time duration may correspond to at least a portion of a duration of the one or more DRX periods, where the at least the portion may not include sleep time of the second device).

Alternatively and/or additionally, the first device may select a first candidate resource (e.g., a candidate resource with a smaller number of frequency units than one or more candidate resources that may be used and/or required for transmitting the sidelink traffic) for transmitting at least a portion of the sidelink traffic during the wake up time (e.g., the original wake up time) of the second device. The first device may transmit the first candidate resource during the wake up time (e.g., the original wake up time) of the second device. Based on the first candidate resource, the first device may select, reserve and/or indicate one or more second candidate resources (e.g., one or more candidate resources, wherein the one or more candidate resources have a larger number of frequency units than the first candidate resource) during a sleep time of the second device (e.g., the sleep time may be an original sleep time, such as a sleep time with which the second device is configured and/or pre-configured to be in sleep mode, and/or the sleep time may be after the one or more second candidate resources are selected, reserved and/or indicated). A number of candidate resources of the one or more second candidate resources may be 0 (e.g., the number of candidate resources of the one or more second candidate resources may be 0 if the sidelink traffic is fully transmitted using the first candidate resource), 1, or 2 (or other number of candidate resources). In some examples, the second device may monitor and/or sense the one or more second candidate resources based on an indication and/or reservation of the one or more second candidate resources indicated in the first candidate resource. For example, even if the second device does not successfully decode the first candidate resource (e.g., the second device may not successfully decode at least the portion of the sidelink traffic delivered in the first candidate resource), the second device may monitor and/or sense the one or more second candidate resources based on the indication and/or the reservation of the one or more second candidate resources.

FIG. 5 illustrates a timing diagram of an exemplary scenario associated with the first device (a timeline of which is labeled “TX UE” in FIG. 5) and the second device (a timeline of which is labeled “RX UE” in FIG. 5). In some examples, timelines illustrated in FIGS. 5-7 and FIGS. 9-10 may be representative of (and/or in units of) at least one of time, slots, symbols, frames, subframes, mini-slots, subslots, slots belonging to the first sidelink resource pool, time units belonging to the first sidelink resource pool, symbols belonging to the first sidelink resource pool, frames belonging to the first sidelink resource pool, subframes belonging to the first sidelink resource pool, mini-slots belonging to the first sidelink resource pool, subslots belonging to the first sidelink resource pool, etc. Alternatively and/or additionally, a time unit (e.g., time unit n, time unit n+T1, etc.) described with respect to FIGS. 5-7 and FIGS. 9-10 and/or otherwise referred to herein may correspond to (and/or may be in units of) at least one of a point in time, a period of time (e.g., a period of time shorter than, longer than, or the same as a duration of a slot), a slot, a symbol, a frame, a subframe, a mini-slot, a subslot, a point in time belonging to the first sidelink resource pool, a period of time belonging to the first sidelink resource pool, a slot belonging to the first sidelink resource pool, a symbol belonging to the first sidelink resource pool, a frame belonging to the first sidelink resource pool, a subframe belonging to the first sidelink resource pool, a mini-slot belonging to the first sidelink resource pool, a subslot belonging to the first sidelink resource pool, etc. In some examples, a sidelink traffic comes in (e.g., arrives at) the first device. A higher layer (e.g., Medium Access Control (MAC) layer, Radio Resource Control (RRC) layer, application layer and/or V2X layer) of the first device triggers a physical layer (PHY layer) to perform resource selection in time unit n (e.g., the resource selection may be triggered in response to the sidelink traffic). The first device selects at least one resource within a resource selection window spanning from time unit n+T1 to time unit n+T2. T2 may be restricted and/or bounded by a latency requirement of the sidelink traffic. However, one or more receiving devices (e.g., the second device) may perform monitoring or sensing sidelink resource based on a DRX pattern. A periodicity of the DRX pattern is shown in FIG. 5. A first portion 502 of the periodicity may correspond to wake up time of the second device (e.g., “On duration”) during which the second device is configured to be in wake up mode and/or active mode based on the DRX pattern (e.g., during the wake up time, the second device may perform sensing and/or monitoring). A second portion 504 of the periodicity may correspond to sleep time of the second device during which the second device is configured to be in sleep mode based on the DRX pattern. The first device may be limited to selecting one or more resources (for transmission of the sidelink traffic, for example) that are within a period spanning from the time unit n+T1 (e.g., the time at which the resource selection window begins) to time unit n+T4 (e.g., the time at which On duration of the DRX pattern ends) since one or more receiving devices (e.g., the second device) may be in sleep mode from the time unit n+T4 to the time unit n+T2 (e.g., the time at which the resource selection window ends). In some examples, On duration and/or the periodicity of the DRX pattern may be in units of slots in a sidelink resource pool (e.g., the first sidelink resource pool). Accordingly, due to limiting selection of one or more resources to the period spanning from the time unit n+T1 to the time unit n+T4, there may be few (e.g., less than a threshold) candidate resources, candidate slots, or candidate time units within the resource selection window (e.g., within a period spanning from the time unit n+T1 to the time unit n+T2). If the first device determines that one or more candidate time units, one or more candidate resources, or one or more candidate slots in the resource selection window (e.g., the original resource selection window spanning from the time unit n+T1 to the time unit n+T2) do not meet a requirement (e.g., a requirement that a number of time units, a number of candidate resources, and/or a number of candidate slots in the first sidelink resource pool within the resource selection window meets, such as exceeds, a threshold), the first device may select one or more candidate resources for transmitting the signal (rather than transmitting the sidelink traffic, for example). Since the sidelink traffic may occupy greater than a threshold amount of frequency units (e.g., the sidelink traffic may occupy an amount of sub-channels that exceeds a threshold amount of sub-channels), it may be difficult for the first device to find a candidate resource for transmission of the sidelink traffic within a period spanning from the time unit n+T1 to the time unit n+T4. The first device may select one or more candidate resources, for the signal (e.g., for transmission of the signal), that are within a period spanning from the time unit n+T1 to the time unit n+T4 since the one or more candidate resources for the signal may not occupy more than the threshold amount of frequency units (e.g., the one or more candidate resources may be selected for the signal prior to selecting a candidate resource for the sidelink traffic). A size of the one or more candidate resources (e.g., the size of the one or more candidate resources in frequency domain and/or in time domain) for transmitting the signal being smaller than a size of one or more candidate resources for transmitting the sidelink traffic (and/or the size of the one or more candidate resources for transmitting the signal being less than a threshold size) may enable the first device to indicate to (and/or instruct) one or more receiving devices (e.g., the second device) to extend wake up period (e.g., a period in which a receiving device, such as the second device, is in wake up mode).

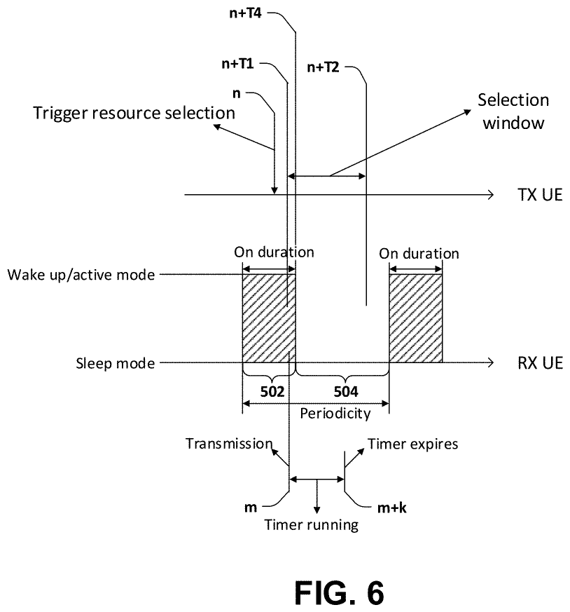

FIG. 6 illustrates a timing diagram of an exemplary scenario associated with the first device (a timeline of which is labeled “TX UE” in FIG. 6) and the second device (a timeline of which is labeled “RX UE” in FIG. 6). In the exemplary scenario of FIG. 6, the first device may select a first candidate resource for the sidelink traffic (e.g., for an initial transmission of the sidelink traffic). The first candidate resource may be selected in a time unit m and/or the first candidate resource may be within the time unit m. For example, the second device may perform a transmission of the sidelink traffic (e.g., an initial transmission of the sidelink traffic) in the time unit m (via the first candidate resource, for example). Alternatively and/or additionally, the first device may transmit a sidelink control information scheduling the first candidate resource for the sidelink traffic. The time unit m may be after the time unit n (in which the first device triggers resource selection, for example) and/or before the time unit n+T4 (in which On duration of the DRX pattern ends, for example). The sidelink control information may or may not reserve one or more resources that are after the On duration of the DRX pattern (e.g., after the wake up time of the second device). When (and/or in response to) the second device receives, monitors and/or senses the transmission of the sidelink traffic in the time unit m (and/or when the second device receives, monitors and/or senses the sidelink control information scheduling the first candidate resource), the second device may start a timer (e.g., an inactivity timer or a transmission timer). The second device may start the timer when (and/or once) the second device receives and/or successfully decodes the sidelink control information (e.g., first stage SCI/1^{st} stage SCI). Alternatively, the second device may start the timer when/once the second device receives and/or successfully decodes an additional sidelink control information (e.g., second stage SCI/2^{nd} stage SCI). Alternatively and/or additionally, the second device may start the timer when (and/or once) the second device transmits sidelink Hybrid Automatic Repeat Request (SL HARQ) feedback associated with the transmission of the sidelink traffic or the sidelink control information. While the timer is running, the second device may monitor and/or sense one or more sidelink resources in the first sidelink resource pool. The first device may select a second candidate resource for retransmission of the sidelink traffic. The first device may select the second candidate resource after the time unit m. The first device may select the second candidate resource such that the second candidate resource is before the time unit n+T2 (e.g., the time at which the resource selection window ends) and before a time unit m+k (e.g., the second candidate resource may be before the earlier of the time unit n+T2 and the time unit m+k). The time unit m+k may correspond to a time unit at which the timer expires (e.g., k may be a length of the timer, such as an inactivity timer length or a transmission timer length).

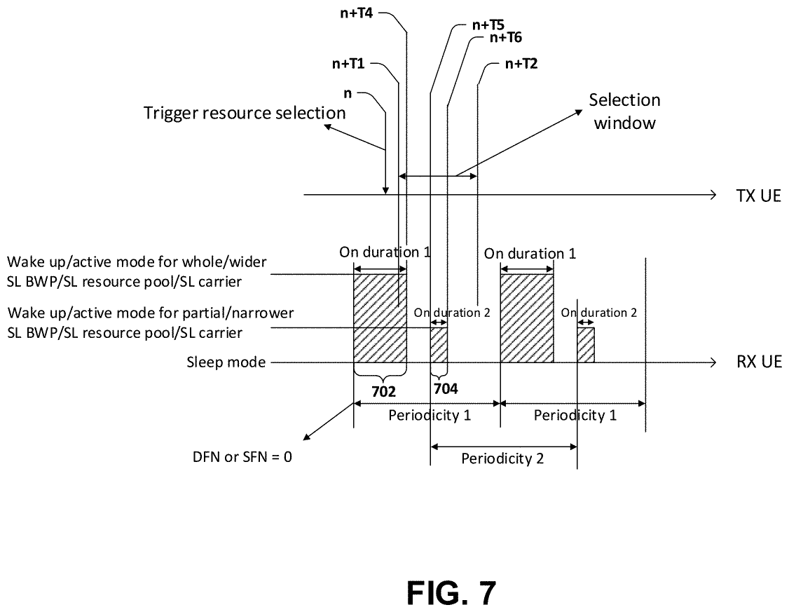

FIG. 7 illustrates a timing diagram of an exemplary scenario associated with the first device (a timeline of which is labeled “TX UE” in FIG. 7) and the second device (a timeline of which is labeled “RX UE” in FIG. 7). In the exemplary scenario of FIG. 7, the first device knows (and/or determines) the DRX pattern of the second device (e.g., a first DRX pattern configuration and/or a second DRX pattern configuration). In some examples, the first DRX pattern configuration has a first periodicity (labeled “Periodicity 1” in FIG. 7) and/or the second DRX pattern configuration has a second periodicity (labeled “Periodicity 2” in FIG. 7). The first periodicity “Periodicity 1” of the first DRX pattern configuration may have a first portion 702 corresponding to a first wake up time (e.g., “On duration 1”) during which the second device is configured to be in a first wake up mode and/or a first active mode, wherein the first wake up mode and/or the first mode are associated with performing sensing and/or monitoring of a first sidelink BWP, a first resource pool and/or a first sidelink carrier. The second periodicity “Periodicity 2” of the second DRX pattern configuration may have a second portion 704 corresponding to a second wake up time (e.g., “On duration 2”) during which the second device is configured to be in a second wake up mode and/or a second active mode, wherein the second wake up mode and/or the first mode are associated with performing sensing and/or monitoring of a second sidelink BWP, a second resource pool and/or a second sidelink carrier. The first sidelink BWP may be wider and/or larger than the second sidelink BWP (e.g., the first sidelink BWP may be a whole sidelink BWP and/or the second sidelink BWP may be a partial BWP). Alternatively and/or additionally, the first resource pool may be wider and/or larger than the second resource pool (e.g., the first resource pool may be a whole resource pool and/or the second resource pool may be a partial resource pool). Alternatively and/or additionally, the first sidelink carrier may be wider and/or larger than the second sidelink carrier (e.g., the first sidelink carrier may be a whole sidelink carrier and/or the second sidelink carrier may be a partial carrier). The first device may select a first candidate resource for the sidelink traffic (e.g., for transmission of the sidelink traffic) within a first period spanning from the time unit n+T1 to the time unit n+T4 or a second period spanning from time unit n+T5 to time unit n+T6. The first period may be in the first wake up time (e.g., “On duration 1”) and/or the second period may be in the second wake up time (e.g., “On duration 2”). For example, the second device may be in the first wake up mode and/or the first active mode during the first period and/or the second device may be in the second wake up mode and/or the second active mode during the second period. The first device may check and/or determine whether or not a number of candidate resources and/or a number of candidate slots in the first period and/or the second period is less than the threshold. In an example, if the first device determines that the number of candidate resources and/or the number of candidate slots is less than the threshold, the first device may select a resource on a time unit in which the second device is in sleep mode (e.g., a time unit in a period spanning from the time unit n+T4 to the time unit n+T5 and/or a time unit in a period spanning from the time unit n+T6 to the time unit n+T2). The first device may select a first candidate resource in a period spanning from n+T1 to n+T4 for transmitting the signal. For example, the signal may indicate to and/or instruct the second device to be in wake up mode (e.g., the first wake up mode) from the time unit n+T4 to the time unit n+T5. The signal may indicate to and/or instruct the second device to be in wake up mode (e.g., the first wake up mode) from the time unit n+T6 to the time unit n+T2 (e.g., the signal may indicate to and/or instruct the second device to be in wake up mode from the time unit n+T6 to the time unit n+T2 in addition to indicating to and/or instructing the second device to be in wake up mode from the time unit n+T4 to the time unit n+T5).

Alternatively and/or additionally, the first device may select a first candidate resource for transmitting the sidelink traffic during a resource selection window (e.g., the resource selection window may span from the time unit n+T1 to the time unit n+T2). In some examples, the first device may select the first candidate resource for transmitting the sidelink traffic prior to determining whether or not to transmit the signal. For example, the first device may select the first candidate resource within the resource selection window regardless of a wake up time of the second device). In some examples, the first device may determine whether or not to select a third candidate resource for transmitting the signal based on whether or not the first candidate resource is during a wake up time of the second device. In an example with respect to FIG. 7, if the first device selects the first candidate resource within a period spanning from the time unit n+T2 to the time unit n+T5 or in a silent portion of a SL BWP within a period spanning from the time unit n+T5 to the time unit n+T6 (e.g., the On duration 2), the first device may trigger and/or select a third candidate resource for transmitting the signal in a period spanning from the time unit n+T1 to the time unit n+T4 (e.g., the On duration 1) or in an active portion of a SL BWP in a period spanning from the time unit n+T5 to the time unit n+T6 (e.g., the On duration 2). The third candidate resource may be before the second candidate resource. In some examples, a silent portion of a SL BWP may correspond to a portion of the SL BWP that is not being monitored and/or sensed (e.g., the second device may not monitor the silent portion of the SL BWP and/or the second device may not receive in the silent portion of the SL BWP). In some examples, an active portion of a SL BWP may correspond to a portion of the SL BWP that is being monitored and/or sensed (e.g., the second device may perform monitoring and/or receiving via the active portion of the SL BWP). In an example with respect to FIG. 7, if the first device selects the first candidate resource within a period spanning from the time unit n+T6 to the time unit n+T2, the first device may trigger and/or select the second candidate resource for transmitting the signal in a period spanning from the time unit n+T1 to the time unit n+T4 and/or in an active portion of a SL BWP in a period spanning from the time unit n+T5 to the time unit n+T6.

Alternatively and/or additionally, the first device may be in network scheduling mode. The first device may receive a Downlink Control Information (DCI) (e.g., a DCI scheduling a SL grant) indicating a scheduled sidelink resource within sleep time of the second device. The first device may transmit the signal to the second UE to indicate to and/or instruct the second UE to being in wake up mode at a time unit of the scheduled sidelink resource (e.g., the first device may transmit the signal to the second device if there is an opportunity (e.g., an available sidelink resource for the signal at a time in which the second device is in wake up mode) for transmitting the signal before the scheduled sidelink resource).

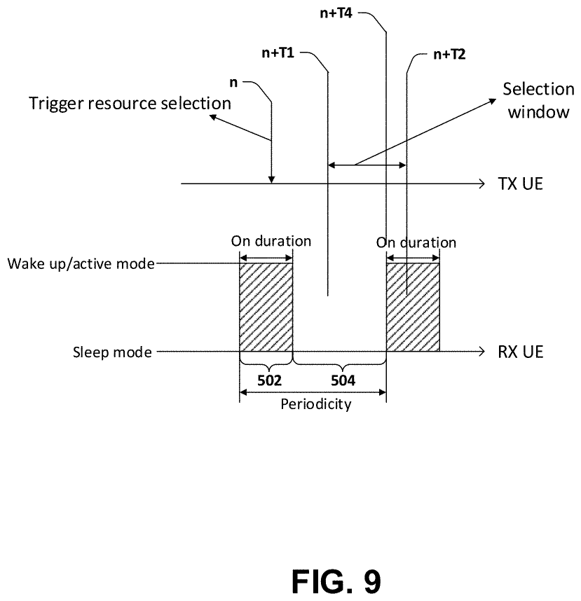

Alternatively and/or additionally, in a scenario in which the number of candidate resources and/or the number of candidate slots is less than the threshold, the first device may not transmit the signal. In the scenario, a wake up time of the second device may be after a sleep time of the second device. In the scenario, the first device may select the first candidate resource from the resource selection window (e.g., the first candidate resource may be within the resource selection window). The first candidate resource may be in the wake up time of the second device. For example, in an exemplary scenario of FIG. 9, the first device (a timeline of which is labeled “TX UE” in FIG. 9) does not have an opportunity (e.g., an available sidelink resource for the signal at a time in which the second device is in wake up mode) for transmitting the signal before the second device (a timeline of which is labeled “RX UE” in FIG. 9) enters sleep mode (e.g., resource selection may be triggered in time unit n, which may be after the second device enters sleep mode in the exemplary scenario of FIG. 9). The first device may select the first candidate resource for transmitting the sidelink traffic in a period spanning from time unit n+T4 to time unit n+T2 (e.g., during which the second device is in wake up mode), wherein the time unit n+T4 may correspond to a time at which the second device enters wake up mode and/or the time unit n+T2 may correspond to an end of the resource selection window).

In some examples, the first device may determine whether or not to transmit the signal to the first device (before the first candidate resource) based on whether or not the number of candidate resources (e.g., candidate resources that are both in the resource selection window and in the wake up time of the second device) and/or the number of candidate slots (e.g., candidate slots that are both in the resource selection window and in the wake up time of the second device) is less than the threshold and/or based on whether or not the first device has at least one opportunity (e.g., at least one available and/or valid opportunity) to transmit the signal (before the first candidate resource, for example).

In some examples, the first device may determine to trigger and/or transmit the signal when (and/or if) an amount of sidelink traffic (e.g., a remaining amount of sidelink traffic) for one or more links between the first device and one or more devices comprising the second device is larger than a size threshold, and/or when (and/or if) the number of candidate resources (e.g., candidate resources that are both in the resource selection window and in the wake up time of the second device) and/or the number of candidate slots (e.g., candidate slots that are both in the resource selection window and in the wake up time of the second device) is less than the threshold, and/or when (and/or if) the first device has at least one opportunity (e.g., at least one available and/or valid opportunity) to transmit the signal (before the first candidate resource, for example). In some examples, the sidelink traffic is aperiodic sidelink traffic and/or the sidelink traffic is not associated with a service with periodic data pattern. In some examples, the sidelink traffic is periodic sidelink traffic and/or the sidelink traffic is associated with a service with periodic data pattern. In some examples, the sidelink traffic has a priority (e.g., is with the priority) higher than a priority threshold. In some examples, the disabled/deactivated time duration may be associated with (and/or determined and/or derived based on) the priority of the sidelink traffic (and/or a highest priority of the sidelink traffic). In some examples, the sidelink traffic has a latency requirement (e.g., is with the latency requirement) shorter than a latency threshold. In some examples, the disabled/deactivated time duration may be associated with (and/or determined and/or derived based on) the latency requirement of the sidelink traffic (and/or a shortest latency requirement and/or a longest latency requirement of the sidelink traffic).

In some examples, the first device may determine to trigger and/or transmit the signal when (and/or if) the first device transmits a Buffer Status Report (BSR) (e.g., a SL BSR) to a network, wherein the BSR comprises a sidelink buffer status for a link between the first device and one or more devices comprising the second device. In some examples, the sidelink buffer status for the link does not indicate zero. In some examples, the sidelink buffer status for the link comprises and/or indicates new sidelink traffic for the link. In some examples, the BSR may be triggered in response to new sidelink traffic for the link coming and/or arriving (e.g., coming and/or arriving at the first device).

In some examples, the first device may determine to trigger and/or transmit the signal when new sidelink traffic for a link between the first device and one or more devices comprising the second device is coming and/or arriving (e.g., coming and/or arriving at the first device).

In some examples, the new sidelink traffic is aperiodic sidelink traffic and/or the new sidelink traffic is not associated with a service with periodic data pattern. In some examples, the new sidelink traffic is periodic sidelink traffic and/or the new sidelink traffic is associated with a service with periodic data pattern. In some examples, the new sidelink traffic has a priority (e.g., is with the priority) higher than a priority threshold. In some examples, the disabled/deactivated time duration may be associated with (and/or determined and/or derived based on) the priority of the new sidelink traffic (and/or a highest priority of the new sidelink traffic). In some examples, the new sidelink traffic has a latency requirement (e.g., is with the latency requirement) shorter than a latency threshold. In some examples, the disabled/deactivated time duration may be associated with (and/or determined and/or derived based on) the latency requirement of the new sidelink traffic (and/or a shortest latency requirement and/or a longest latency requirement of the new sidelink traffic).

In some examples, an available and/or valid opportunity for transmitting the signal means and/or implies that the opportunity is before a selected resource of the first device for transmitting sidelink traffic (e.g., the first candidate resource).

In some examples, an available and/or valid opportunity for transmitting the signal means and/or implies that the opportunity has a processing time (e.g., a guaranteed processing time) before the first candidate resource.

In some examples, an available and/or valid opportunity for transmitting the signal means and/or implies that the opportunity is before the end of the resource selection window of the first device for the sidelink traffic.

In some examples, the processing time may be used for the first device to select the first candidate resource for transmitting the sidelink traffic (e.g., the processing time may comprise a time it takes for the first device to select the first candidate resource).

In some examples, the processing time may be (and/or may comprise and/or may account for) a processing time of the second device for decoding the signal and/or a processing time of the second device to open RF receiver to monitor and/or to receive.

In some examples, the first device is not allowed (and/or is not configured) to select the first candidate resource (and/or a slot comprising the first candidate resource) starting within the processing time.

In some examples, the first device may select the first candidate resource (and/or the slot comprising the first candidate resource) starting after the time unit in which the signal is transmitted plus the processing time (e.g., the first candidate resource may not start before the processing time has passed after the time unit).

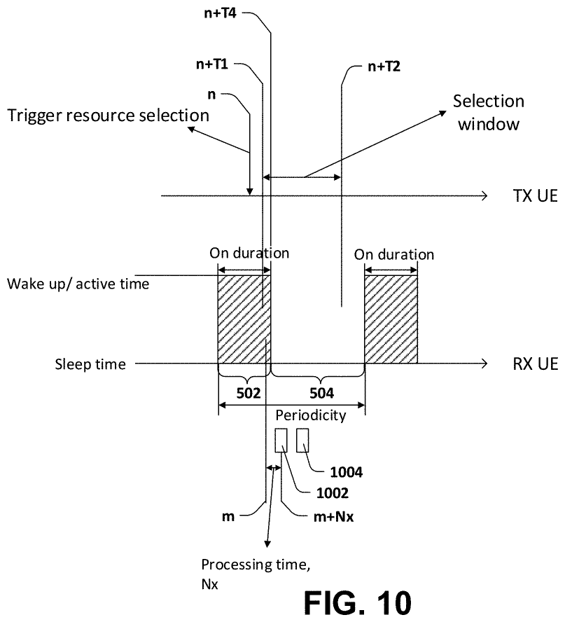

For example, in an exemplary scenario of FIG. 10, the first device (a timeline of which is labeled “TX UE” in FIG. 10) transmits the signal to the second device (a timeline of which is labeled “RX UE” in FIG. 10) in a time unit m. The first device is not allowed (and/or is not configured) to select the first candidate resource within a period spanning from the time unit m to time unit m+Nx. Nx may correspond to the processing time (e.g., Nx may be in units of at least one of symbols, slots, time, etc.). For example, if the first device transmits the signal, the first device is not allowed (and/or is not configured) to select a time unit 1002 (e.g., at least one of a slot, a symbol, a period of time, etc.) as the first candidate resource for transmitting the sidelink traffic based on the time unit 1002 overlapping with the period spanning from the time unit m to the time unit m+Nx (e.g., the processing time). The first device may select the first candidate resource starting from a time unit 1004 (and/or starting from after the time unit 1004) based on a determination that the time unit 1004 (and/or the candidate resource) is after the processing time. If the first device selects the first candidate resource in the time unit 1002, the first device is not allowed (and/or is not configured) to transmit the signal in the time unit m. If the first device selects the first candidate resource in the time unit 1004, the first device may transmit the signal in the time unit m (prior to the first candidate resource).

The first device may derive and/or determine a priority of the signal based on a priority of the sidelink traffic (and/or the first device may derive and/or determine the priority of the signal based on information comprising the priority of the sidelink traffic and other information).

The priority of the signal may be associated with the priority of the sidelink traffic.

The priority of the signal may be equal to the priority of the sidelink traffic.

The priority of the signal may be determined, adjusted and/or tuned based on a wake up time of the second device. The priority of the signal may be determined based on the number of candidate resources (e.g., the number of remaining candidate resources) and/or the number of candidate slots (e.g., the number of remaining candidate slots) during the wake up time of the second device. For example, a higher number of candidate resources (e.g., a higher number of remaining candidate resources) during the wake up time of the second device may correspond to a lower priority of the signal (e.g., the first device may determine the signal to have lower priority and/or less importance if the number of candidate resources is higher). Alternatively and/or additionally, a higher number of candidate slots (e.g., a higher number of remaining candidate slots) during the wake up time of the second device may correspond to a lower priority of the signal (e.g., the first device may determine the signal to have lower priority and/or less importance if the number of candidate slots is higher). Alternatively and/or additionally, a lower number of candidate resources (e.g., a lower number of remaining candidate resources) during the wake up time of the second device may correspond to a higher priority of the signal (e.g., the first device may determine the signal to have higher priority and/or greater importance if the number of candidate resources is lower). Alternatively and/or additionally, a lower number of candidate slots (e.g., a lower number of remaining candidate slots) during the wake up time of the second device may correspond to a higher priority of the signal (e.g., the first device may determine the signal to have higher priority and/or greater importance if the number of candidate slots is lower). The priority of the sidelink traffic may be a reference point and/or a basis for determining the priority of the signal. For example, the priority of the signal may be determined based on the priority of the sidelink traffic, the number of candidate resources (e.g., the number of remaining candidate resources) during the wake up time of the second device and/or the number of candidate slots (e.g., the number of remaining candidate slots) during the wake up time of the second device. Alternatively and/or additionally, the priority of the sidelink traffic may be adjusted and/or tuned based on the number of candidate resources and/or the number of candidate slots during the wake up time of the second device to determine and/or derive the priority of the signal.

The first device determines whether or not to transmit the signal and/or a resource with less frequency units (e.g., less frequency units than one or more resources for transmission of the sidelink traffic) during the wake up time of the second device based on a congestion condition of the first sidelink resource pool. For example, the first device may determine whether to enable or disable transmission of the signal and/or the resource based on the congestion condition (such as based on whether or not the congestion condition meets a threshold congestion). In some examples, if the signal and/or the resource with less frequency units is transmitted, the signal and/or the resource with less frequency units may be used for reserving one or more resources, with a greater amount of frequency units (e.g., greater amount of frequency units than the resource with less frequency units), in the sleep time (e.g., original sleep time) of the second device. Alternatively and/or additionally, if the signal and/or the resource with less frequency units is transmitted, the signal and/or the resource with less frequency units may be used for waking up the second device (e.g., the signal and/or the resource may indicate to and/or instruct the second device to enter wake up mode). In some examples, the resource with less frequency units may deliver the signal, deliver a portion of the sidelink traffic (such as where code rate exceeds code rate_threshold) or deliver all of the sidelink traffic.

The first device may determine and/or derive a channel congestion condition (e.g., channel busy ratio (CBR) and/or channel occupancy ratio (CR)) for the first sidelink resource pool during the wake up time of the second device. For example, the channel congestion condition may correspond to a measure of congestion of the first sidelink resource pool during the wake up time of the second device. In an example where the channel congestion condition corresponds to CBR, if the first device determines and/or derives that the CBR is larger than or equal to a CBR_threshold (e.g., the CBR being larger than or equal to the CBR_threshold may indicate that a channel associated with the first sidelink resource pool is congested and/or that it is difficult to find a candidate resource of the first sidelink resource pool for transmitting the sidelink traffic), the first device may determine to transmit the signal and/or the resource with less frequency units during the wake up time of the second device. If the first device determines and/or derives that the CBR is smaller than or equal to the CBR_threshold (e.g., the CBR being smaller or equal to the CBR_threshold may indicate that a channel associated with the first sidelink resource pool is less congested and/or that a candidate resource of the first sidelink resource pool for transmitting the sidelink traffic can be found), the first device may determine to transmit the sidelink traffic during the wake up time of the second device.

Alternatively and/or additionally, the first device determines whether or not to transmit the signal and/or the resource with less frequency units during the wake up time of the second device based on whether or not the number of candidate resources (e.g., the number of remaining candidate resources) and/or the number of candidate slots (e.g., the number of remaining candidate slots) during the wake up time of the second device is larger than (or equal to) the threshold. For example, the first device may determine whether to enable or disable transmission of the signal and/or the resource based on whether or not the number of candidate resources (e.g., the number of remaining candidate resources) and/or the number of candidate slots (e.g., the number of remaining candidate slots) during the wake up time of the second device is larger than (or equal to) the threshold. For example, in the exemplary scenario of FIG. 6, the first device may determine whether or not to transmit the signal and/or the resource with less frequency units during the wake up time of the second device based on whether or not the number of candidate resources (e.g., the number of remaining candidate resources) and/or the number of candidate slots (e.g., the number of remaining candidate slots) during the period spanning from the time unit n+T1 to the time unit n+T4 is larger than (or equal to) the threshold. For example, the first device may determine to transmit the signal and/or the resource with less frequency units (and/or the first device may enable transmission of the signal and/or the resource with less frequency units) when (and/or if) the number of candidate resources (e.g., the number of remaining candidate resources) and/or the number of candidate slots (e.g., the number of remaining candidate slots) during the period spanning from the time unit n+T1 to the time unit n+T4 is less than (or equal to) the threshold.

The first device may establish a link (e.g., a unicast link) with the second device. When establishing the link and/or before a first time after establishing the link successfully, the second device may transmit a configuration and/or information to the first device. The configuration and/or the information may be (and/or may comprise) at least one of a DRX pattern of the second device, a length of a DRX related timer of the second device, a wake up time of the second device, one or more wake up time positions of the second device, etc. The first device may know (and/or determine based on the configuration and/or the information) when the second device is in wake up mode and/or the second device performs monitoring and/or sensing (e.g., the first device may know and/or determine one or more times, time units and/or slots in which the second device is in wake up mode and/or the second device performs monitoring and/or sensing). In some examples, the second device may receive a configuration and/or an information from a network. The configuration and/or the information indicates a DRX pattern of the second device for monitoring the first sidelink resource pool and/or indicates a plurality of opportunities for monitoring the signal. The second device monitors the signal and/or the first sidelink resource pool based on the configuration and/or the information (e.g., based on the DRX pattern and/or the plurality of opportunities).

Alternatively and/or additionally, the first device may transmit a message indicating a configuration and/or an information to the second device. The configuration may indicate to (and/or instruct) the second device to perform sensing and/or the configuration may be indicative of a plurality of opportunities for monitoring and/or sensing the signal or one or more sets of sidelink traffic (from the first device). The second device may start to use the configuration after the second device receives the configuration (e.g., the second device may start to use the configuration after a timing when the second device receives the configuration). For example, the second device may start to use the configuration after (and/or once) a processing time (e.g., Ny symbols) for decoding and/or processing the configuration has passed after receiving the configuration (e.g., the second device may start to use the configuration at and/or after a timing equal to the processing time plus the timing when the second device receives the configuration). Alternatively and/or additionally, the second device starts to use the configuration after the second device transmits Hybrid Automatic Repeat Request-Acknowledgement (HARQ-ACK) for the configuration. Alternatively and/or additionally, before the second device starts to use the configuration, the second device monitors (e.g., keeps monitoring and/or continues to monitor) the first sidelink resource pool and/or the signal. After the second device starts to use the configuration, the second device performs monitoring the first sidelink resource pool and/or the signal based on the configuration. Alternatively and/or additionally, when (and/or after) the first device establishes a link with the second device, the first device may determine (and/or derive) and/or negotiate a configuration and/or an information (related to one or more opportunities for transmitting the signal). The configuration and/or the information may be a bit-map. The configuration and/or the information may indicate one or more periodic opportunities for monitoring and/or sensing the signal and/or the sidelink traffic (from the first device). The first device may determine the configuration and/or the information based on a sidelink traffic pattern of the first device. For example, the sidelink traffic pattern may comprise or be a sidelink traffic pattern associated with transmission of one or more sets of sidelink traffic to the second device. In some examples, the sidelink traffic pattern of the first device may comprise a plurality of sidelink traffic patterns associated with a plurality of devices comprising the second device. In some examples, when determining the configuration and/or the information, the sidelink traffic pattern associated with transmission of one or more sets of sidelink traffic to the second device may be emphasized (and/or weighted) over other sidelink traffic patterns associated with transmission of sets of sidelink traffic to devices other than the second device. The first device may determine the configuration and/or the information based on one or more sidelink traffic characteristics (e.g., a sidelink traffic periodicity of one or more sets of sidelink traffic to the second device). The first device and/or the second device may be configured (e.g., pre-configured) with a list of configurations. The list of configurations may be associated with the first sidelink resource pool. The configuration may be an entry (e.g., one configuration entry) in the list of configurations. The bit-map may be indicative of one or more slots (e.g., one or more sidelink slots) in the first sidelink resource pool in which the second device is in wake up mode for monitoring the signal. The bit map may be applied for slots in the first sidelink resource pool. In some examples, the bit-map may comprise one or more zeros “0” corresponding to one or more slots in which the second device is in sleep mode and/or one or more ones “1” corresponding to one or more slots in which the second device is in wake up mode for monitoring the signal. The bit-map may be applied in a periodic manner. For example, if the bit-map is 20 bits and indicates 00000111110000111000, the bit map may apply for slots with indexes t0˜t19, slots with indexes t20˜t39, slots with indexes t40˜t59, . . . , wherein the slot indexes (e.g., “tx”) means, implies and/or represents a slot index in the first sidelink resource pool. Each slot with index tx may or may not be contiguous in time domain to a neighbor slot with index tx−1 or tx+1. For slot indexes t0˜t19, the second device at least monitors the signal on slots with indexes t5˜t9 and t14˜t16 (such as based on the bit-map indicating 00000111110000111000).

Alternatively and/or additionally, a first configuration (e.g., a configuration related to DRX for monitoring and/or sensing one or more resources in the first sidelink resource pool) is common for the first sidelink resource pool. In some examples, the first device and the second device may know (and/or determine) a second configuration (e.g., a configuration related to DRX for monitoring and/or sensing one or more resources in the first sidelink resource pool). In some examples, the second configuration is dedicated to the link between the first device and the second device. In some examples, the second device transmits the second configuration to the first device. In some examples, devices that use resources in the first sidelink resource pool (e.g., all devices that use resources in the first sidelink resource pool) may know (and/or determine) the first configuration. The first configuration and/or the second configuration may be used (as a power saving mechanism, for example) by one or more devices (e.g., pedestrian UE) to save power (and/or reduce battery consumption). The second configuration may indicate a second sidelink resource pool dedicated for monitoring and/or receiving the signal. For example, the second sidelink resource pool may provide one or more opportunities for monitoring the signal. The one or more opportunities for monitoring the signal may be periodic. The first device may transmit the signal on the second sidelink resource pool to indicate to (and/or instruct) the second device to enter wake up mode to receive one or more sidelink transmissions (e.g., one or more future sidelink transmissions) in the first sidelink resource pool. The first device may transmit the sidelink traffic and/or the signal on an opportunity based on the first configuration (related to a first DRX pattern). The first device may transmit the signal on an opportunity based on the second configuration (related to a second DRX pattern). In some examples, an opportunity that is indicated by the second configuration (e.g., only the second configuration) and that is not indicated by the first configuration may be used for transmitting the signal (e.g., the opportunity may only be used for transmitting the signal, and/or may not be used for one or more other types of transmissions, other than the signal, such as sidelink traffic). The second configuration may provide one or more additional opportunities for monitoring one or more sidelink transmissions, the sidelink traffic and/or the signal. The second configuration may provide one or more opportunities for monitoring the signal (e.g., the one or more opportunities may be for monitoring only the signal and/or the one or more opportunities may not be for monitoring one or more other types of transmissions, other than the signal, such as sidelink traffic). The second configuration may indicate a periodicity for monitoring the signal. In some examples, the periodicity for monitoring the signal may be a multiple (e.g., an integer multiple) of the PSFCH periodicity. The second configuration may indicate one or more symbols comprising PSFCHs that may provide the third candidate resource for monitoring the signal. In some examples, the third candidate resource may be dedicated to the link (between the first device and the second device). In some examples, the first device is configured to (and/or needs to and/or is required to) perform random selection and/or sensing based selection for the third candidate resource. In some examples, the third candidate resource may be associated with identity (ID) related information of the first device and/or ID related information of the second device (e.g., Layer 1 (L1) or Layer 2 (L2) source ID of the first device, and/or link ID, and/or L1 or L2 destination ID of the second device). The second device may be configured (by the network) with a dedicated third candidate resource (for monitoring the signal) and/or a plurality of dedicated opportunities for monitoring the signal. The second device may receive the second configuration from the network. The second device may be in sidelink network scheduling mode. When (and/or after) the second device establishes the link with the first device, the second device may indicate, to the first device, the second configuration, the third candidate resource and/or a plurality of opportunities for monitoring the signal. The second device may provide the third candidate resource to the first device such that the first device can determine when to transmit the signal (to indicate to and/or instruct the second device to enter wake up mode). In some examples, the second device senses and/or monitors the signal in an intersection (e.g., one or more overlapping portions) of the first configuration and the second configuration (e.g., the overlapping portions may correspond to slots in the first sidelink resource pool that are indicated by both the first configuration and the second configuration). In some examples, the second device senses and/or monitors a union of the first configuration and the second configuration (e.g., the second device senses and/or monitors slots in the first sidelink resource pool that are indicated by either the first configuration or the second configuration). In some examples, the first device may transmit the signal in a slot and/or time unit indicated by the intersection (e.g., overlapping portion) of the first configuration and the second configuration. In some examples, the first device may transmit the signal in a slot and/or time unit indicated by the union of the first configuration and the second configuration. For example, in FIG. 7, the first configuration related to DRX may be indicative of the On duration 1 and/or the first periodicity “Periodicity 1” of the first DRX pattern configuration (and/or an offset to direct frame number (DFN) 0 (e.g., DFN=0) and/or system frame number (SFN) 0 (e.g., SFN=0), and/or inactivity timer, HARQRTTtimer, retransmission timer and/or bandwidth size of a monitored and/or sensed SL BWP). The second configuration related to DRX may be indicative of the On duration 2 and/or the second periodicity “Periodicity 2” (and/or an offset to DFN 0 and/or SFN 0 and/or inactivity timer and/or HARQRTTtimer and/or retransmission timer and/or bandwidth size of a monitored and/or sensed SL BWP). The second device may monitor and/or perform sensing for a first SL BWP during On duration 1. The second device may monitor and/or perform sensing for a second SL BWP during On duration 2. The first SL BWP may be wider than the second SL BWP. For a time unit indicated by the first configuration and the second configuration, the second device may monitor and/or performs sensing based on the first configuration (e.g., the first SL BWP that is wider than the second SL BWP). Alternatively and/or additionally, the first configuration and the second configuration may indicate the same bandwidth size of SL BWP (e.g., sensed and/or monitored SL BWP). For example, the first SL BWP may have the same size as the second SL BWP. In some examples, if a wake up-related timer (e.g., inactivity timer and/or retransmission timer) is running during at least a portion of a period (e.g., On duration 2) in which the second device is configured to monitor the second SL BWP (e.g., the narrower SL BWP corresponding to On duration 2), the second device may monitor the first SL BWP (e.g., the wider SL BWP corresponding to On duration 1) and/or the whole SL BWP during the period (e.g., On duration 2). In the exemplary scenario of FIG. 7, if the second device receives an initial sidelink transmission (from the first device) during a period spanning from time unit n+T1 to time unit n+T4 and the second device starts an inactivity timer which runs during at least a portion of a period spanning from time unit n+T5 to time unit n+T6 in time domain (e.g., On duration 2), the second device may monitor the wider SL BWP (e.g., the first SL BWP corresponding to On duration 1) during the period spanning from time unit n+T5 to time unit n+T6.

Alternatively and/or additionally, a configuration (e.g., pre-configuration) in the first sidelink resource pool may be indicative of one or more opportunities for monitoring, sensing and/or transmitting the signal. The first device may transmit the signal on one or more configured (e.g., pre-configured) opportunities of the configuration (e.g., the one or more configured opportunities may be configured for monitoring, sensing and/or transmitting the signal). In some examples, the second device may monitor (e.g., monitor the signal) and/or enter wake up mode for monitoring (e.g., monitoring the signal) on the one or more configured opportunities and/or on a plurality of time units containing the one or more configured opportunities. The second device may monitor and/or enter wake up mode based on a DRX pattern of the second device and/or based on the configuration.

Alternatively and/or additionally, the first device may transmit the sidelink traffic with the signal in a time unit in which the second device monitors, receives and/or decodes (e.g., the second device may receive and/or decode the sidelink traffic with the signal via the time unit).

At an opportunity (of the one or more opportunities configured for monitoring, sensing and/or transmitting the signal, for example), the first device may or may not transmit the signal.

The second device may monitor at least the one or more opportunities for the signal.

The third candidate resource may comprise one time unit and/or one slot in the first sidelink resource pool and/or in the second sidelink resource pool.

The third candidate resource may comprise more than one time unit and/or more than one slot in the first sidelink resource pool and/or in the second sidelink resource pool.

The third candidate resource may comprise one frequency unit, one sub-channel and/or one PRB in the first sidelink resource pool and/or in the second sidelink resource pool.

The third candidate resource may comprise more than one frequency unit, more than one sub-channel and/or more than one PRB in the first sidelink resource pool and/or in the second sidelink resource pool.

The second device may transmit a response (to the first device, for example) in response to receiving the signal.

The first device may enable the second device to transmit the response when the first device transmits the signal (regardless of channel congestion condition, for example).

The first device may not be configured to (and/or may not be allowed to and/or may be prohibited from) disable the second device to transmit the response when the first device transmits the signal.

The response may be HARQ-ACK for the signal.

The response is associated with the signal.

The first device may determine whether or not the second device knows to enter and/or remain in wake up mode based on whether or not the first device receives the response (regardless of whether content of the response is Acknowledgement (ACK) or Negative Acknowledgement (NACK), for example). For example, the first device may determine that the second device knows to enter and/or remain in wake up mode (and/or that the second device will be in wake up mode) during one or more time units indicated by the signal based on reception of the response from the second device. Alternatively and/or additionally, the first device may determine that the second device does not know to enter and/or remain in wake up mode (and/or that the second device may not be in wake up mode) during one or more time units indicated by the signal based on not receiving the response from the second device.

The first device may retransmit the signal in response to not receiving the response from the second device (e.g., the first device may retransmit the signal in response to no response (that is in response to the signal) being received from the second device).

In some examples, a number of candidate resources and/or a number of candidate slots during a period of time (such as discussed herein with respect to example embodiments and/or at least some of FIGS. 5-10) means and/or implies slots and/or resources (e.g., only slots and/or resources) that are within the period of time and that belong to a sidelink resource pool (e.g., the first sidelink resource pool). For example, the number of candidate resources may correspond to a number of candidate resources, of the first sidelink resource pool, that are within the period of time. The number of candidate slots may correspond to a number of slots, of the first sidelink resource pool, that are within the period of time.

In some examples, a wake up time (in a DRX period) of a device corresponds to a time during which the device monitors and/or performs sensing.

In some examples, a sleep time (in a DRX period) of a device corresponds to a time during which the device may not monitor and/or may not perform sensing.

In some examples, a DRX period may be equal to, the same as, and/or replaced by a DRX cycle.

In some examples, the wake up time (in a DRX period) may mean, represent and/or correspond to active time (in a DRX procedure and/or a DRX cycle).

In some examples, the sleep time (in a DRX period) may mean, represent and/or correspond to non-active time (in a DRX procedure and/or a DRX cycle).

A second concept of the present disclosure is that a first device transmits a signal to one or more receiving devices in a group, where the signal may be a wake up signal and/or a DRX-disabled/deactivated signal. The group is associated with groupcast sidelink transmission (e.g., devices of the group may perform transmissions to each other via groupcast sidelink transmission). The group comprises a second device (and a third device). In some examples, a DRX of the group (e.g., a DRX pattern, such as a group DRX pattern associated with the group) is used by devices, in the group, that are associated with power saving concerns (e.g., devices, such as battery-concerned RX devices, that employ one or more power saving mechanisms to save power). In some examples, the DRX of the group is common to devices in the group. In some examples, devices in the group may have different DRXs (e.g., different DRX patterns) for monitoring groupcast sidelink transmission for the group (e.g., each device in the group may have a different DRX). In some examples, the DRX pattern of the group may be an intersection of the different DRX patterns of the group (e.g., an intersection of each device's DRX pattern) and/or a periodicity of the DRX pattern of the group may be a common multiple (e.g., lowest common multiple) of the different DRX periodicities of the group. In some examples, a DRX pattern may be associated with an On duration, a periodicity (e.g., a DRX periodicity), a DRX offset, HARQRTTtimer, an inactivity timer and/or a retransmission timer. In some examples, a DRX pattern may correspond to a length of a DRX related timer, a wake up time and/or one or more wake up time positions.

The signal may indicate that (and/or instruct that) one or more devices in the group be in wake up mode (during one or more times).

Alternatively and/or additionally, signal may indicate that (and/or instruct that) all devices in the group be in wake up mode (during one or more times).

When (and/or in response to) the second device receives the signal indicating to (and/or instructing) the second device to enter and/or be in wake up mode, the second device may keep monitoring and/or sensing (e.g., continue to perform monitoring and/or sensing) based on an indication in the signal. The second device may not perform discontinuous monitoring or discontinuous sensing (in one or more periods) based on the indication of the signal.

When (and/or in response to) the third device receives the signal indicating to (and/or instructing) the third device not to enter wake up mode and/or not to be in wake up mode, the third device may be in sleep mode (and/or continue to be in sleep mode) based on an indication in the signal. The third device may perform discontinuous monitoring or discontinuous sensing (in one or more periods) based on the indication of the signal.

The signal may be used for disabling (and/or deactivating) DRX of the group.

Alternatively and/or additionally, the signal may be used for disabling (and/or deactivating) DRX of one or more devices in the group. In some examples, the one or more devices comprises all devices of the group. Alternatively and/or additionally, the one or more devices may comprise one or some devices of the group. The signal may indicate a length of time (e.g., how long) that DRX is to be disabled (and/or deactivated) by the one or more devices. Alternatively and/or additionally, a disabled/deactivated time duration for which the one or more devices disables and/or deactivates DRX may be indicated by the signal. Alternatively and/or additionally, the disabled/deactivated time duration may be configured (e.g., pre-configured) (e.g., the one or more devices may be configured and/or pre-configured with the disabled/deactivated time duration). The disabled/deactivated time duration may begin when or after the one or more devices receive the signal. In some examples, after the disabled/deactivated time duration (e.g., when or after the disabled/deactivated time duration ends), the one or more devices may resume DRX. Alternatively and/or additionally, the one or more devices may resume DRX when (and/or in response to) the one or more devices receives a second signal for enabling, activating and/or resuming DRX. The signal may indicate when to start to disable (and/or deactivate) DRX of the one or more devices (e.g., the signal may indicate a starting time, a starting slot and/or a starting symbol of the disabled/deactivated time duration). The signal may indicate one or more symbols and/or one or more slots in which DRX of the one or more devices is to be disabled (and/or deactivated).

The signal is used to update monitoring behavior of the group (e.g., the one or more devices of the group) for one or more DRX cycles and/or one or more DRX periods.

Alternatively and/or additionally, the signal may be used for (and/or indicative of) enabling (and/or activating) DRX of the one or more devices in the group. The signal may indicate a length of time (e.g., how long) that DRX of the one or more devices is to be enabled (and/or activated) by the one or more devices. In some examples, the one or more devices monitor PSCCH continuously (e.g., may not monitor PSCCH discontinuously) before receiving the signal. Alternatively and/or additionally, the one or more devices may monitor PSCCH discontinuously for a time duration in response to receiving the signal. The time duration may be associated with one or more DRX periods (e.g., the time duration may correspond to a duration of the one or more DRX periods). The time duration may be derived by the one or more devices based on a length and/or periodicity of one or more DRX periods. After the time duration associated with the signal, the one or more devices may not monitor PSCCH discontinuously (e.g., one or more devices may monitor PSCCH continuously after the time duration associated with the signal). Alternatively and/or additionally, the one or more devices in the group may stop using DRX when (and/or in response to) the one or more devices in the group receive another signal for disabling, deactivating and/or stopping DRX. The signal may indicate when to start to enable (and/or activate) DRX of the one or more devices. The signal may indicate which symbol or which slot to enable (and/or activate) DRX of the one or more devices.

The signal may indicate (e.g., explicitly indicate or implicitly indicate) an indication associated with one or more DRX periods. In some examples, a number of periods of the one or more DRX periods (and/or a duration of the one or more DRX periods) may be configured (e.g., pre-configured). For example, when (and/or in response to) a device of the one or more devices receives the signal, the device may derive and/or determine (based on the configuration of the number of periods, for example) that the indication of the signal corresponds to (and/or lasts for and/or is applicable to) the number of periods of the one or more DRX periods (such as the configured (e.g., pre-configured) DRX period).

The signal may indicate to (and/or instruct) the one or more devices to switch BWPs (e.g., switch SL BWPs). The signal may indicate to (and/or instruct) the one or more devices to switch from a first BWP (e.g., a first SL BWP) to a second BWP (e.g., a second SL BWP).

In some examples, the first BWP may be a partial BWP (e.g., a partial SL BWP) and/or the second BWP may be a whole BWP (e.g., a whole SL BWP). Alternatively and/or additionally, the first BWP may be narrower than the second BWP (e.g., the second BWP may be wider than the first BWP). Alternatively and/or additionally, the first BWP may be a partial BWP of the second BWP and/or the first BWP may comprise partial bandwidth of the second BWP.

In some examples, the first BWP may be a whole BWP (e.g., a whole SL BWP) and/or the second BWP may be a partial BWP (e.g., a partial SL BWP). Alternatively and/or additionally, the first BWP may be wider than the second BWP (e.g., the second BWP may be narrower than the first BWP). Alternatively and/or additionally, the second BWP may be a partial BWP of the first BWP and/or the second BWP may comprise partial bandwidth of the first BWP.

The signal is used for indicating to (and/or instructing) the one or more devices to extend a monitoring and/or sensing duration (e.g., a duration of time during which the one or more devices perform monitoring and/or sensing). Alternatively and/or additionally, the signal may be used for indicating to (and/or instructing) the one or more devices to extend a wake up duration (e.g., a duration of time during which the one or more devices are in wake up mode).

The signal may indicate an indication associated with one or more DRX periods. The indication may be available, activated and/or applicable until the end of the one or more DRX periods and/or until the start of a next DRX period after the one or more DRX periods. Alternatively and/or additionally, one or more opportunities for monitoring the signal may be in a periodic manner. The signal may indicate a first indication and/or the first indication may be applicable until another signal (e.g., another signal that may be a same type of signal as the signal) indicates a second indication (related to DRX) and/or until other configuration indicates a second indication (related to DRX).

The signal may be sidelink traffic (e.g., a portion of sidelink traffic). The signal may be transmitted with sidelink traffic. The signal may trigger the second device to wake up (e.g., enter wake up mode) for receiving, sensing and/or monitoring one or more reserved resources.

The signal may indicate one or more time units (e.g., one or more time units in a sidelink resource pool associated with the group), such as one or more time units after reception of the signal, wherein a device of the one or more devices is originally configured to be in sleep mode in one, some and/or all of the one or more time units (e.g., prior to receiving the signal, the device may be configured to be in sleep mode in one, some and/or all of the one or more time units). The signal may indicate to (and/or instruct) the one or more devices to be in wake up mode and/or to perform monitoring and/or sensing on the one or more time units.

The signal may indicate one or more frequency units (e.g., one or more frequency units in the sidelink resource pool), such as one or more frequency units to be used after reception of the signal. The signal may indicate to (and/or instruct) the one or more devices to perform monitoring and/or sensing on the one or more frequency units.

The signal may indicate one or more time units (e.g., one or more time units in the sidelink resource pool), such as one or more time units after reception of the signal, wherein a duration of the one or more time units may be larger than a periodicity for monitoring the signal. The signal may indicate to (and/or instruct) the one or more devices to be in wake up mode and/or to perform monitoring and/or sensing on the one or more time units.

The signal may indicate one or more time units (e.g., one or more time units in the sidelink resource pool), such as one or more time units after reception of the signal, wherein a duration of the one or more time units may be equal to the periodicity for monitoring the signal. The signal may indicate to (and/or instruct) the one or more devices to be in wake up mode and/or to perform monitoring and/or sensing on the one or more time units.

In some examples, the periodicity for monitoring the signal is in units of time units (e.g., in units of time units belonging to the sidelink resource pool) or in units of slots (e.g., in units of slots belonging to sidelink resource pool).

In some examples, the signal may be a Physical HARQ Indicator Channel (PHICH) signal and/or a PHICH-like signal (e.g., the signal may have one or more characteristics of a PHICH signal).

In some examples, the signal is transmitted via a groupcast sidelink transmission.

The signal may be a MAC CE or a control information (e.g., a sidelink control information). Alternatively and/or additionally, the signal may be comprised in (and/or delivered via) a MAC CE or a control information (e.g., a sidelink control information).

The signal may be transmitted via PSCCH, PSSCH or PSFCH.

The signal may be a sidelink reference signal.

The signal may be a stand-alone sidelink control information. In some examples, stand-alone sidelink control information may correspond to sidelink control information that is transmitted by itself and/or without other types of information (such as scheduling information). In some examples, stand-alone sidelink control information may mean and/or imply that a sidelink transmission in a time unit and/or a slot (belonging to the sidelink resource pool) comprises only the sidelink control information (and/or the sidelink transmission does not schedule sidelink data or sidelink traffic). In some examples, stand-alone sidelink control information may mean and/or imply that a sidelink transmission in a time unit and/or a slot (belonging to the sidelink resource pool) comprises only a 1^{st} stage SCI of the sidelink control information and/or a 2^{nd} stage SCI of the sidelink control information (and/or the sidelink transmission does not schedule sidelink data or sidelink traffic).

One or more time units and/or one or more frequency units (indicated by the signal) may be one or more resources in the sidelink resource pool.

The one or more time units may be one or more slots, one or more mini-slots, one or more subslots, and/or one or more subframes (in the sidelink resource pool).

The one or more frequency units may be one or more PRBs and/or one or more sub-channels (e.g., a sub-channel of the one or more sub-channels may contain one or more PRBs).

In some examples, the signal is transmitted via one frequency unit (e.g., only one frequency unit).

When sidelink traffic comes in (e.g., arrives at) the first device, the first device may perform resource selection. The first device may select a candidate resource, within a selection window, for transmitting the sidelink traffic (e.g., the selection window may be an original selection window, such as a resource selection window with which the first device is configured and/or pre-configured). The first device may select a candidate resource for transmitting the sidelink traffic, wherein the candidate resource is in a wake up time of the group (e.g., an original wake up time, such as a wake up time with which devices of the group (e.g., some and/or all receiving devices of the group) are configured and/or pre-configured to be in wake up mode) or in On duration of a DRX pattern of the group. The first device may be configured (e.g., pre-configured) with a threshold. The threshold may be a number of candidate resources or a number of candidate slots in the selection window (considering the wake up time of the group, for example). The threshold may be used for determining whether (and/or guaranteeing that) there are enough candidate resources for transmitting the sidelink traffic (e.g., the threshold may be applied to avoid selecting a candidate resource associated with a bad sensing result, for example). The threshold may be used for guaranteeing a number of candidate resources or a number of candidate slots (e.g., the number of candidate resources and/or the number of candidate slots may correspond to the threshold) for initial transmission of the sidelink traffic or a new transmission of the sidelink traffic (considering the wake up time of the group, for example, such that the candidate resources amounting to the number of candidate resources or the candidate slots amounting to the number of candidate resources are during the wake up time or during On duration of the DRX pattern of the group).

If the first device determines that the number of candidate slots or the number of candidate resources during the resource selection window (and/or during the wake up time (e.g., the original wake up time) of the group) is less than the threshold, the first device may select a first candidate resource (e.g., a candidate resource with a smaller number of frequency units than one or more candidate resources that may be used and/or required for transmitting the sidelink traffic) for transmitting the signal during the wake up time (e.g., the original wake up time) of the group (e.g., the signal, rather than the sidelink traffic, may be transmitted during the wake up time of the group).

Alternatively and/or additionally, the first device may select a first candidate resource (e.g., a candidate resource with a smaller number of frequency units than one or more candidate resources that may be used and/or required for transmitting the sidelink traffic) for transmitting at least a portion of the sidelink traffic during the wake up time (e.g., the original wake up time) of the group. The first device may transmit the first candidate resource during the wake up time (e.g., the original wake up time) of the group. Based on the first candidate resource, the first device may select, reserve and/or indicate one or more second candidate resources (e.g., one or more candidate resources, wherein the one or more candidate resources have a larger number of frequency units than the first candidate resource) during a sleep time of the group (e.g., the sleep time may be an original sleep time, such as a sleep time with which devices of the group are configured and/or pre-configured to be in sleep mode, and/or the sleep time may be after the one or more second candidate resources are selected, reserved and/or indicated). A number of candidate resources of the one or more second candidate resources may be 0 (e.g., the number of candidate resources of the one or more second candidate resources may be 0 if the sidelink traffic is fully transmitted using the first candidate resource), 1, or 2 (or other number of candidate resources). In some examples, the second device and/or the third device may monitor and/or sense the one or more second candidate resources based on an indication and/or reservation of the one or more second candidate resources indicated in the first candidate resource. For example, even if the second device and/or the third device do not successfully decode the first candidate resource (e.g., the second device and/or the third device may not successfully decode at least the portion of the sidelink traffic delivered in the first candidate resource), the second device and/or the third device may monitor and/or sense the one or more second candidate resources based on the indication and/or the reservation of the one or more second candidate resources.

Alternatively and/or additionally, the first device may select a first candidate resource for transmitting the sidelink traffic during a resource selection window (e.g., the resource selection window may span from the time unit n+T1 to the time unit n+T2 in the exemplary scenarios of FIGS. 5-7 and FIGS. 9-10). In some examples, the first device may select the first candidate resource for transmitting the sidelink traffic prior to determining whether or not to transmit the signal. For example, the first device may select the first candidate resource within the resource selection window regardless of the wake up time of the group). In some examples, the first device may determine whether or not to select a third candidate resource for transmitting the signal based on whether or not the first candidate resource is during the wake up time of the group.

Alternatively and/or additionally, in a scenario in which the number of candidate resources and/or the number of candidate slots is less than the threshold, the first device may not transmit the signal. In the scenario, the wake up time of the group may be after a sleep time of the group. In the scenario, the first device may select the first candidate resource from the resource selection window (e.g., the first candidate resource may be within the resource selection window). The first candidate resource may be in the wake up time of the group. For example, in an exemplary scenario of FIG. 9, the first device (a timeline of which is labeled “TX UE” in FIG. 9) does not have an opportunity (e.g., an available sidelink resource for the signal at a time in which the group is in wake up mode) for transmitting the signal before receiving devices of the group (a timeline of which is labeled “RX UE” in FIG. 9) enters sleep mode (e.g., resource selection may be triggered in time unit n, which may be after the receiving devices of the group enter sleep mode in the exemplary scenario of FIG. 9). The first device may select the first candidate resource for transmitting the sidelink traffic in a period spanning from time unit n+T4 to time unit n+T2 (e.g., during which the receiving devices of the group are in wake up mode), wherein the time unit n+T4 may correspond to a time at which the receiving devices of the group enter wake up mode and/or the time unit n+T2 may correspond to an end of the resource selection window).

In some examples, the first device may determine whether or not to transmit the signal to the first device (before the first candidate resource) based on whether or not the number of candidate resources (e.g., candidate resources that are both in the resource selection window and in the wake up time of the group) and/or the number of candidate slots (e.g., candidate slots that are both in the resource selection window and in the wake up time of the group) is less than the threshold and/or based on whether or not the first device has at least one opportunity (e.g., at least one available and/or valid opportunity) to transmit the signal (before the first candidate resource, for example).

In some examples, an available and/or valid opportunity for transmitting the signal means and/or implies that the opportunity is before a selected resource of the first device for transmitting sidelink traffic (e.g., the first candidate resource).

In some examples, an available and/or valid opportunity for transmitting the signal means and/or implies that the opportunity has a processing time (e.g., a guaranteed processing time) before the first candidate resource.

In some examples, an available and/or valid opportunity for transmitting the signal means and/or implies that the opportunity is before the end of the resource selection window of the first device for the sidelink traffic.

In some examples, the processing time may be used for the first device to select the first candidate resource for transmitting the sidelink traffic (e.g., the processing time may comprise a time it takes for the first device to select the first candidate resource).

In some examples, the processing time may be (and/or may comprise and/or may account for) a most conservative device's processing time in the group for decoding the signal and/or a most conservative device's processing time in the group to open RF receiver to monitor and/or to receive. In some examples, the most conservative device's processing time in the group means and/or implies that the processing time is a maximum (e.g., longest) processing time among devices (e.g., receiving devices) of the group. For example, the processing time may be (and/or may comprise and/or may account for) a maximum processing time among processing times of devices (e.g., receiving devices) of the group for decoding the signal and/or a maximum processing time among processing times of devices (e.g., receiving devices) of the group for opening RF receiver to monitor and/or to receive.

In some examples, the first device is not allowed (and/or is not configured) to select the first candidate resource (and/or a slot comprising the first candidate resource) starting within the processing time.

In some examples, the first device may select the first candidate resource (and/or the slot comprising the first candidate resource) starting after the time unit in which the signal is transmitted plus the processing time (e.g., the first candidate resource may not start before the processing time has passed after the time unit).

When (and/or after) the second device joins the group, the second device may receive a configuration and/or an information related to the group. The configuration and/or the information may be (and/or may comprise) at least one of a DRX pattern of the group, a length of a DRX related timer of the group, a wake up time of the group, one or more wake up time positions of the group, etc. The second device may know (and/or determine based on the configuration and/or the information) when the group is in wake up mode (e.g., when devices of the group are in wake up mode) and/or when devices of the group perform monitoring and/or sensing (e.g., the second device may know and/or determine one or more time units in which the group is in wake up mode and/or devices of the group perform monitoring and/or sensing). The second device may know (and/or determine based on the configuration and/or the information) when the second device is in wake up mode, when the second device shall enter wake up mode, and/or when the second device shall perform monitoring and/or sensing (e.g., the second device may know and/or determine one or more time units in which the second is in wake up mode, shall enter wake up mode and/or shall perform monitoring and/or sensing).

Alternatively and/or additionally, when (and/or after) the second device joins the group, the first device may transmit a message indicating a configuration and/or an information to the second device. The first device may be a leader device of the group. The configuration and/or the information may be indicative of sensing and/or one or more opportunities for monitoring and/or sensing the signal. The configuration and/or the information may be a bit-map. The configuration and/or the information may indicate periodic opportunities for monitoring and/or sensing the signal. The first device may determine the configuration and/or the information based on one or more sidelink traffic characteristics (e.g., a sidelink traffic periodicity of one or more sets of sidelink traffic to the second device).

Alternatively and/or additionally, a first configuration (e.g., a configuration related to DRX for monitoring and/or sensing one or more resources in the sidelink resource pool) is common for the sidelink resource pool. In some examples, the first configuration is common for the group. In some examples, devices in the group may know (and/or determine) a second configuration (e.g., a configuration related to DRX of the group for monitoring and/or sensing one or more resources in the sidelink resource pool). In some examples, the second configuration is dedicated to the group. In some examples, devices that use resources in the sidelink resource pool (e.g., all devices that use resources in the sidelink resource pool) may know (and/or determine) the first configuration. The first configuration and/or the second configuration may be used (as a power saving mechanism, for example) by one or more devices (e.g., pedestrian UE) to save power (and/or reduce battery consumption). The second configuration may indicate a second sidelink resource pool dedicated for monitoring and/or receiving the signal. For example, the second sidelink resource pool may provide one or more opportunities for monitoring the signal. The one or more opportunities for monitoring the signal may be periodic. The first device may transmit the signal on the second sidelink resource pool to indicate to (and/or instruct) the second device to enter wake up mode to receive one or more sidelink transmissions (e.g., one or more future sidelink transmissions) in the sidelink resource pool. The second configuration may provide one or more additional opportunities for monitoring one or more sidelink transmissions, the sidelink traffic and/or the signal. The second configuration may provide one or more opportunities for monitoring the signal (e.g., the one or more opportunities may be for monitoring only the signal and/or the one or more opportunities may not be for monitoring one or more other types of transmissions, other than the signal, such as sidelink traffic). The second configuration may indicate a periodicity for monitoring the signal. In some examples, the periodicity for monitoring the signal may be a multiple (e.g., an integer multiple) of the PSFCH periodicity. The second configuration may indicate one or more symbols comprising PSFCHs that may provide the third candidate resource for monitoring the signal. In some examples, the third candidate resource may be dedicated to the group. In some examples, the first device is configured to (and/or needs to and/or is required to) perform random selection and/or sensing based selection for the third candidate resource. In some examples, the first device is configured (e.g., pre-configured), such as by the network) with the third candidate resource for transmitting the signal. In some examples, the first device may transmit information related to the third candidate resource and/or the second configuration to devices in the group (such as via a groupcast sidelink transmission). In some examples, the third candidate resource may be associated with ID related information of the first device and/or ID related information of the group (e.g., L1 or L2 source ID of the first device, and/or group destination ID of the groupd). In some examples, devices in the group sense and/or monitor the signal in an intersection (e.g., one or more overlapping portions) of the first configuration and the second configuration (e.g., the overlapping portions may correspond to slots in the sidelink resource pool that are indicated by both the first configuration and the second configuration). In some examples, devices in the group sense and/or monitor a union of the first configuration and the second configuration (e.g., devices in the group sense and/or monitor slots in the sidelink resource pool that are indicated by either the first configuration or the second configuration). In some examples, the first device may transmit the signal in a slot and/or time unit indicated by the intersection (e.g., overlapping portion) of the first configuration and the second configuration. In some examples, the first device may transmit the signal in a slot and/or time unit indicated by the union of the first configuration and the second configuration.

Alternatively and/or additionally, a configuration (e.g., pre-configuration) in the first sidelink resource pool may be indicative of one or more opportunities for monitoring, sensing and/or transmitting the signal. The first device may transmit the signal on one or more configured (e.g., pre-configured) opportunities of the configuration (e.g., the one or more configured opportunities may be configured for monitoring, sensing and/or transmitting the signal). In some examples, devices in the group may monitor (e.g., monitor the signal) and/or enter wake up mode for monitoring (e.g., monitoring the signal) on the one or more configured opportunities and/or on a plurality of time units containing the one or more configured opportunities. The devices in the group may monitor and/or enter wake up mode based on a DRX pattern of the group and/or based on the configuration.

Alternatively and/or additionally, the first device may transmit the sidelink traffic with the signal in a time unit in which devices in the group monitor, receive and/or decode (e.g., the devices in the group may receive and/or decode the sidelink traffic with the signal via the time unit).

In some examples, the first device may determine to trigger and/or transmit the signal when (and/or if) an amount of sidelink traffic (e.g., a remaining amount of sidelink traffic) for the group is larger than a size threshold, and/or when (and/or if) the number of candidate resources (e.g., candidate resources that are both in the resource selection window and in the wake up time of the group) and/or the number of candidate slots (e.g., candidate slots that are both in the resource selection window and in the wake up time of the group) is less than the threshold, and/or when (and/or if) the first device has at least one opportunity (e.g., at least one available and/or valid opportunity) to transmit the signal (before the first candidate resource, for example). In some examples, the sidelink traffic is aperiodic sidelink traffic and/or the sidelink traffic is not associated with a service with periodic data pattern. In some examples, the sidelink traffic is periodic sidelink traffic and/or the sidelink traffic is associated with a service with periodic data pattern. In some examples, the sidelink traffic has a priority (e.g., is with the priority) higher than a priority threshold. In some examples, the disabled/deactivated time duration may be associated with (and/or determined and/or derived based on) the priority of the sidelink traffic (and/or a highest priority of the sidelink traffic). In some examples, the sidelink traffic has a latency requirement (e.g., is with the latency requirement) shorter than a latency threshold. In some examples, the disabled/deactivated time duration may be associated with (and/or determined and/or derived based on) the latency requirement of the sidelink traffic (and/or a shortest latency requirement and/or a longest latency requirement of the sidelink traffic).

In some examples, the first device may determine to trigger and/or transmit the signal when (and/or if) the first device transmits a BSR (e.g., a SL BSR) to a network, wherein the BSR comprises a sidelink buffer status for the group. In some examples, the sidelink buffer status for the link does not indicate zero. In some examples, the sidelink buffer status for the link comprises and/or indicates new sidelink traffic for the link. In some examples, the BSR may be triggered in response to new sidelink traffic for the link coming and/or arriving (e.g., coming and/or arriving at the first device).

In some examples, the first device may determine to trigger and/or transmit the signal when new sidelink traffic for the group is coming and/or arriving (e.g., coming and/or arriving at the first device).

In some examples, the new sidelink traffic is aperiodic sidelink traffic and/or the new sidelink traffic is not associated with a service with periodic data pattern. In some examples, the new sidelink traffic is periodic sidelink traffic and/or the new sidelink traffic is associated with a service with periodic data pattern. In some examples, the new sidelink traffic has a priority (e.g., is with the priority) higher than a priority threshold. In some examples, the disabled/deactivated time duration may be associated with (and/or determined and/or derived based on) the priority of the new sidelink traffic (and/or a highest priority of the new sidelink traffic). In some examples, the new sidelink traffic has a latency requirement (e.g., is with the latency requirement) shorter than a latency threshold. In some examples, the disabled/deactivated time duration may be associated with (and/or determined and/or derived based on) the latency requirement of the new sidelink traffic (and/or a shortest latency requirement and/or a longest latency requirement of the new sidelink traffic).

At an opportunity (of the one or more opportunities configured for monitoring, sensing and/or transmitting the signal, for example), the first device may or may not transmit the signal.

The second device (and/or one or more other devices of the group) may monitor at least the one or more opportunities for the signal.

The third candidate resource may comprise one time unit and/or one slot in the first sidelink resource pool and/or in the second sidelink resource pool.

The third candidate resource may comprise more than one time unit and/or more than one slot in the first sidelink resource pool and/or in the second sidelink resource pool.

The third candidate resource may comprise one frequency unit, one sub-channel and/or one PRB in the first sidelink resource pool and/or in the second sidelink resource pool.

The third candidate resource may comprise more than one frequency unit, more than one sub-channel and/or more than one PRB in the first sidelink resource pool and/or in the second sidelink resource pool.

Devices in the group (e.g., receiving devices in the group and/or each device in the group) may transmit a response (in each associated resource) in response to receiving the signal.

A portion of devices in the group (e.g., one, some and/or all receiving devices in the group) transmits a response (in each associated resource) in response to receiving the signal. In some examples, the portion of devices are devices indicated (and/or instructed) to enter and/or remain in wake up mode by the signal.

The first device may enable the second device to transmit the response when the first device transmits the signal (regardless of channel congestion condition, for example).

The first device may not be configured to (and/or may not be allowed to and/or may be prohibited from) disable the second device to transmit the response when the first device transmits the signal.

The first device may indicate the second device to transmit one or more messages (e.g., the response).

The first device may indicate groupcast HARQ-ACK option 2 to the group (e.g., devices that receive the signal and/or that are configured to transmit a response to the signal may each have an associated resource for transmitting a response in response to a groupcast sidelink transmission).

The response may be HARQ-ACK for the signal.

The response is associated with the signal.

The first device may determine whether or not the second device knows to enter and/or remain in wake up mode based on whether or not the first device receives the response (regardless of whether content of the response is ACK or NACK, for example). For example, the first device may determine that the second device knows to enter and/or remain in wake up mode (and/or that the second device will be in wake up mode) during one or more time units indicated by the signal based on reception of the response from the second device. Alternatively and/or additionally, the first device may determine that the second device does not know to enter and/or remain in wake up mode (and/or that the second device may not be in wake up mode) during one or more time units indicated by the signal based on not receiving the response from the second device.

The first device may retransmit the signal in response to not receiving the response from the second device (e.g., the first device may retransmit the signal in response to no response (that is in response to the signal) being received from the second device).

With respect to one or more embodiments herein, such as one or more techniques, devices, concepts, methods and/or alternatives described above, a PSFCH periodicity (e.g., a PSFCH slot periodicity) is N=1 or 2 or 4 slots (or other number of slots) (e.g., the PSFCH periodicity may be in units of slots belonging to the sidelink resource pool and/or the first sidelink resource pool).

With respect to one or more embodiments herein, the first device may be a vehicle UE, a pedestrian UE and/or a TX UE performing sidelink transmission.

With respect to one or more embodiments herein, the second device may be a pedestrian UE, a battery-concerned UE and/or a UE associated with one or more power saving concerns.

With respect to one or more embodiments herein, the third device may be a pedestrian UE, a battery-concerned UE and/or a UE associated with one or more power saving concerns.

With respect to one or more embodiments herein, the network may be a gNB, an eNB, a base station, a network node and/or a TRP.

With respect to one or more embodiments herein, the sidelink transmission may be transmitted via PC5 interface.

With respect to one or more embodiments herein, in some examples, a sidelink transmission that is unicast may correspond to a transmission that a peer device (or a pair device) can receive and/or decode successfully (e.g., only the peer device (or the pair device) can receive and/or decode the sidelink transmission successfully).

With respect to one or more embodiments herein, in some examples, a sidelink transmission that is unicast may correspond to a transmission that comprises and/or indicates an ID for the peer device (or the pair device) (e.g., L1/L2-destination ID).

With respect to one or more embodiments herein, in some examples, a sidelink transmission that is groupcast correspond to a transmission that devices in a group (e.g., a sidelink group) may receive and/or decode successfully (e.g., only devices in the group can receive and/or decode the sidelink transmission successfully).

With respect to one or more embodiments herein, in some examples, a sidelink transmission that is groupcast may correspond to a transmission that comprises and/or indicates an ID for the group.

With respect to one or more embodiments herein, in some examples, a DRX period may be equal to, the same as, and/or replaced by a DRX cycle.

With respect to one or more embodiments herein, in some examples, the DRX (discussed above) is performed for sidelink. In some examples, the DRX (discussed above) is not performed for Uu link.

With respect to one or more embodiments herein, in some examples, the second device performs the DRX for the link between the first device and the second device.

With respect to one or more embodiments herein, in some examples, the second device performs the DRX for the sidelink group comprising at least the first device and the second device.

With respect to one or more embodiments herein, when DRX for sidelink of a device is activated, enabled and/or started, the device may monitor a sidelink control channel discontinuously (in time domain perspective).

With respect to one or more embodiments herein, when DRX for sidelink of a device is deactivated, disabled and/or stopped, the device may not monitor a sidelink control channel discontinuously (in time domain perspective) (e.g. the device may monitor a sidelink control channel continuously in time domain when the DRX is deactivated, disabled and/or stopped).

With respect to one or more embodiments herein, the sidelink control channel is PSCCH or is delivered by a PSCCH.

If a device is in wake up mode, the device may be in wake up time and/or in active time and/or the device may monitor a sidelink control channel.

In some examples, a device being in wake up may be replaced by the device being awake and/or the device being in active time (for a BWP, for example).

In some examples, when the first device has an emergent sidelink traffic to transmit and there are no candidate slots and/or resources during a wake up time of the second device, the first device may transmit the signal.

One, some and/or all of the foregoing techniques and/or embodiments can be formed to a new embodiment.

In some examples, embodiments disclosed herein, such as embodiments described with respect to the first concept and the second concept, may be implemented independently and/or separately. Alternatively and/or additionally, a combination of embodiments described herein, such as embodiments described with respect to the first concept and/or the second concept, may be implemented. Alternatively and/or additionally, a combination of embodiments described herein, such as embodiments described with respect to the first concept and/or the second concept, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

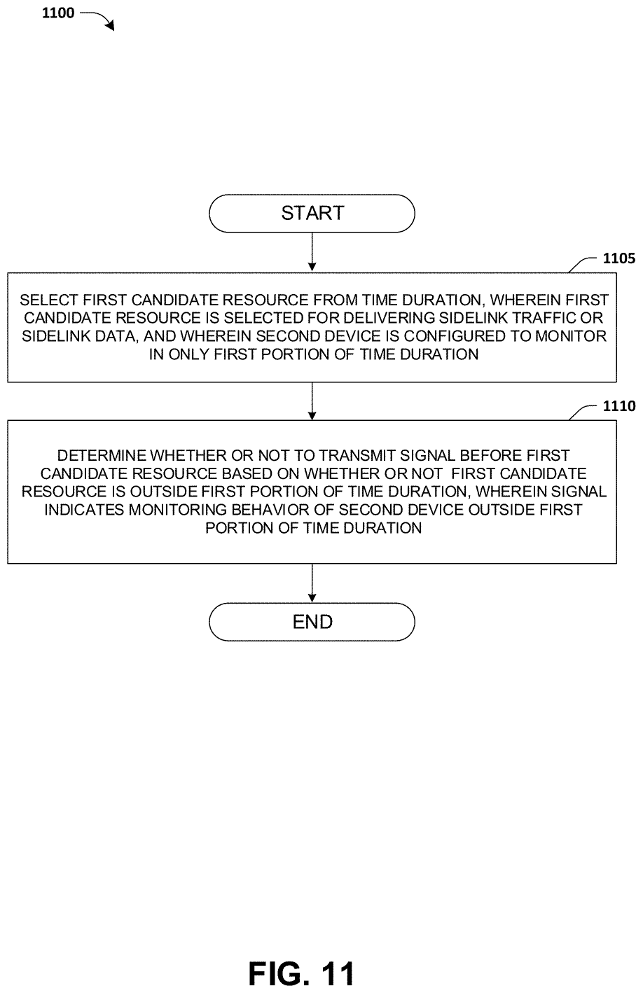

FIG. 11 is a flow chart 1100 according to one exemplary embodiment from the perspective of a first device performing sidelink communication with a second device using a sidelink resource pool, wherein the second device monitors discontinuously (e.g., the second device monitors the sidelink resource pool discontinuously). In step 1105, the first device selects a first candidate resource from a time duration (e.g., the first candidate resource may be selected from one or more resources in the time duration), wherein the first candidate resource is selected for delivering a sidelink traffic or a sidelink data, and wherein the second device is configured to monitor (e.g., monitor the sidelink resource pool) in only a first portion of the time duration. In step 1110, the first device determines whether or not to transmit a signal before the first candidate resource based on whether or not the first candidate resource is outside the first portion of the time duration, wherein the signal indicates monitoring behavior (e.g., updated monitoring behavior) of the second device outside the first portion of the time duration. For example, the signal may indicate to and/or instruct the second device to monitor (e.g., monitor the sidelink resource pool) in a second portion of the time duration, wherein the second portion of the time duration is outside the first portion of the time duration (e.g., the first candidate resource may be in the second portion of the time duration). The first device may transmit the signal if the first candidate resource is outside the first portion of the time duration.

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to select a first candidate resource from a time duration, wherein the first candidate resource is selected for delivering a sidelink traffic or a sidelink data, and wherein the second device is configured to monitor in only a first portion of the time duration, and (ii) to determine whether or not to transmit a signal before the first candidate resource based on whether or not the first candidate resource is outside the first portion of the time duration, wherein the signal indicates monitoring behavior of the second device outside the first portion of the time duration. Furthermore, the CPU 308 can execute the program code 312 to perform one, some and/or all of the above-described actions and steps and/or others described herein.

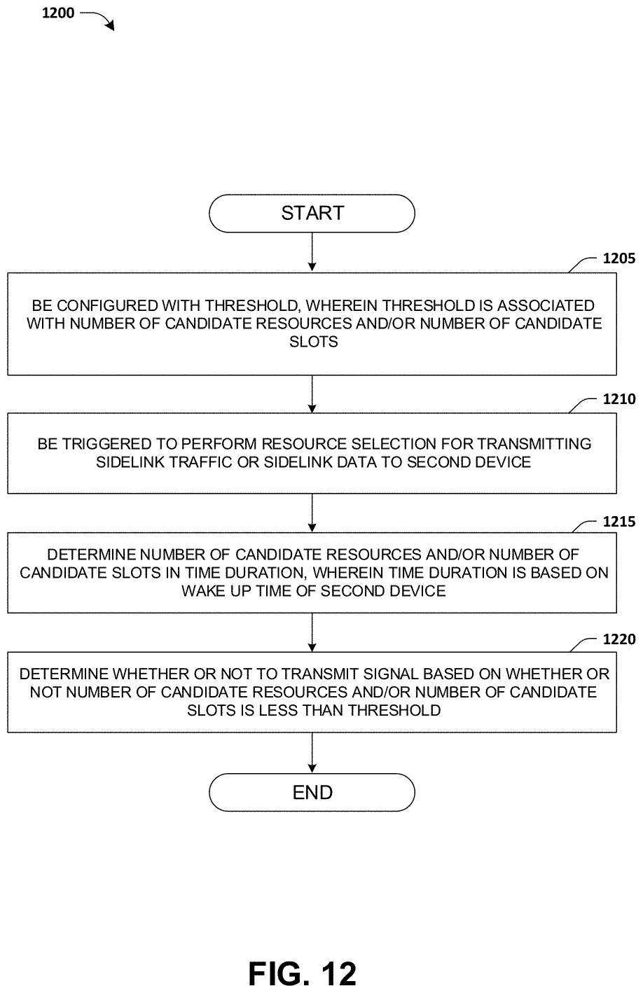

FIG. 12 is a flow chart 1200 according to one exemplary embodiment from the perspective of a first device performing sidelink communication with a second device using a sidelink resource pool, wherein the second device monitors discontinuously (e.g., the second device monitors the sidelink resource pool discontinuously). In step 1205, the first device is configured (e.g., pre-configured) with a threshold, wherein the threshold is associated with a number of candidate resources and/or a number of candidate slots. In step 1210, the first device is triggered to perform resource selection (and/or the first device triggers performance of the resource selection) for transmitting a sidelink traffic or a sidelink data to the second device. In step 1215, the first device determines (e.g., derive) a number of candidate resources or a number of candidate slots in a time duration, wherein the time duration is based on a wake up time of the second device. For example, the time duration may correspond to a period in which a resource selection window, associated with the resource selection, overlaps with the wake up time. In step 1220, the first device determines whether or not to transmit a signal based on whether or not the number of candidate resources and/or the number of candidate slots is less than the threshold.

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to be configured with a threshold, wherein the threshold is associated with a number of candidate resources and/or a number of candidate slots, (ii) to be triggered to perform resource selection (and/or trigger performance of the resource selection) for transmitting a sidelink traffic or a sidelink data to the second device, (iii) to determine a number of candidate resources or a number of candidate slots in a time duration, wherein the time duration is based on a wake up time of the second device, and (iv) to determine whether or not to transmit a signal based on whether or not the number of candidate resources and/or the number of candidate slots is less than the threshold. Furthermore, the CPU 308 can execute the program code 312 to perform one, some and/or all of the above-described actions and steps and/or others described herein.

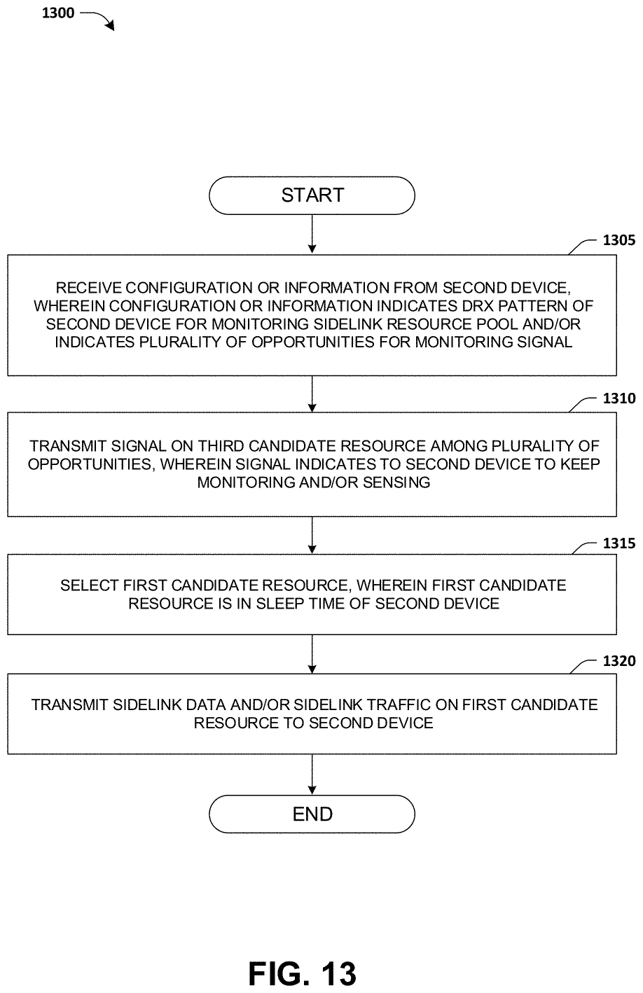

FIG. 13 is a flow chart 1300 according to one exemplary embodiment from the perspective of a first device performing sidelink communication with a second device using a sidelink resource pool, wherein the second device monitors discontinuously (e.g., the second device monitors the sidelink resource pool discontinuously). In step 1305, the first device receives a configuration or an information from the second device, wherein the configuration or the information indicates a DRX pattern of the second device for monitoring the sidelink resource pool and/or indicates a plurality of opportunities for monitoring a signal. In step 1310, the first device transmits the signal on a third candidate resource among the plurality of opportunities, wherein the signal indicates to (and/or instructs) the second device to keep monitoring and/or sensing (regardless of the DRX pattern of the second device, for example). In step 1315, the first device selects a first candidate resource, wherein the first candidate resource is in a sleep time of the second device (e.g., an original sleep time of the second device, such as a sleep time corresponding to the DRX pattern of the second device). In step 1320, the first device transmits a sidelink data and/or a sidelink traffic on the first candidate resource to the second device. For example, the second device may perform monitoring and/or sensing during the first candidate resource based on the signal (and thus, the second device may receive the sidelink data and/or the sidelink traffic, for example).

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to receive a configuration or an information from the second device, wherein the configuration or the information indicates a DRX pattern of the second device for monitoring the sidelink resource pool and/or indicates a plurality of opportunities for monitoring a signal, (ii) to transmit the signal on a third candidate resource among the plurality of opportunities, wherein the signal indicates to (and/or instructs) the second device to keep monitoring and/or sensing (regardless of the DRX pattern of the second device, for example), (iii) to select a first candidate resource, wherein the first candidate resource is in a sleep time of the second device, and (iv) to transmit a sidelink data and/or a sidelink traffic on the first candidate resource to the second device. Furthermore, the CPU 308 can execute the program code 312 to perform one, some and/or all of the above-described actions and steps and/or others described herein.

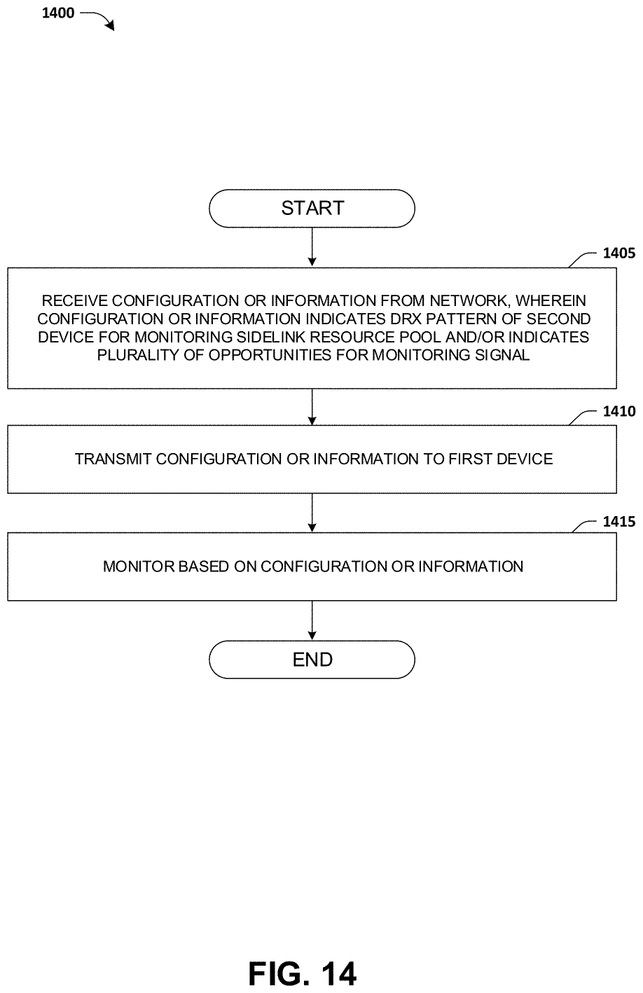

FIG. 14 is a flow chart 1400 according to one exemplary embodiment from the perspective of a second device performing sidelink communication with a first device using a sidelink resource pool, wherein the second device monitors discontinuously (e.g., the second device monitors the sidelink resource pool discontinuously). In step 1405, the second device receives a configuration or an information from a network, wherein the configuration or the information indicates a DRX pattern of the second device for monitoring the sidelink resource pool and/or indicates a plurality of opportunities for monitoring a signal. In step 1410, the second device transmits the configuration or the information to the first device (e.g., and/or the second device transmits a message, indicative of at least some of the configuration or the information, to the first device). In step 1415, the second device monitors (e.g., monitors the sidelink resource pool) based on the configuration or the information.

Referring back to FIGS. 3 and 4, in one exemplary embodiment of a second device performing sidelink communication with a first device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the second device (i) to receive a configuration or an information from a network, wherein the configuration or the information indicates a DRX pattern of the second device for monitoring the sidelink resource pool and/or indicates a plurality of opportunities for monitoring a signal, (ii) to transmit the configuration or the information to the first device, and (iii) to monitor based on the configuration or the information. Furthermore, the CPU 308 can execute the program code 312 to perform one, some and/or all of the above-described actions and steps and/or others described herein.

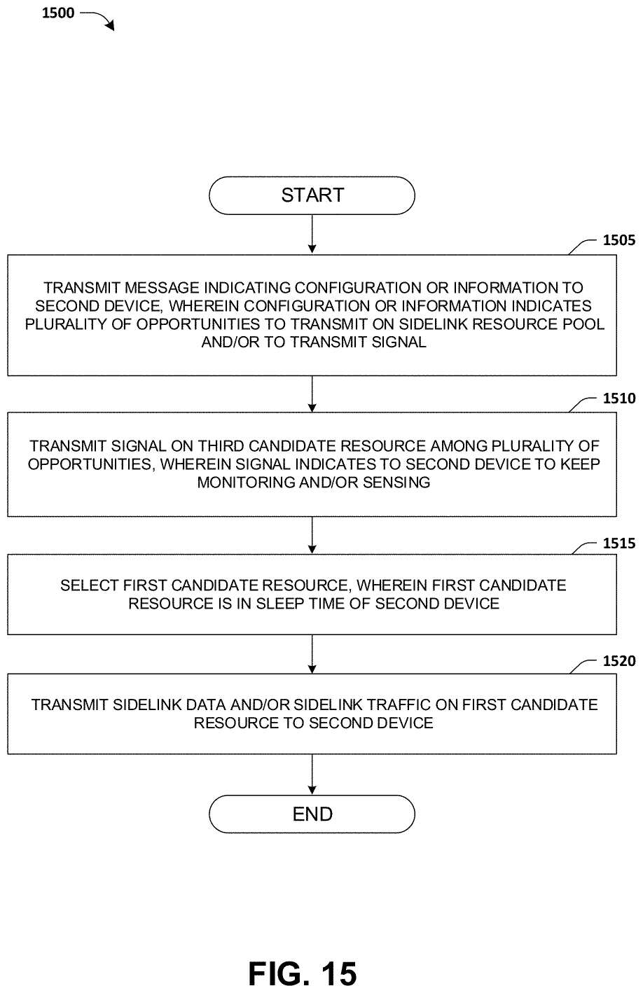

FIG. 15 is a flow chart 1500 according to one exemplary embodiment from the perspective of a first device performing sidelink communication with a second device using a sidelink resource pool, wherein the second device monitors discontinuously (e.g., the second device monitors the sidelink resource pool discontinuously). In step 1505, the first device transmits a message indicating a configuration or an information to the second device, wherein the configuration or the information indicates a plurality of opportunities to transmit on the sidelink resource pool and/or to transmit a signal. In step 1510, the first device transmits the signal on a third candidate resource among the plurality of opportunities, wherein the signal indicates to (and/or instructs) the second device to keep monitoring and/or sensing (regardless of a DRX pattern of the second device, for example). In step 1515, the first device selects a first candidate resource, wherein the first candidate resource is in a sleep time of the second device (e.g., an original sleep time of the second device, such as a sleep time corresponding to the DRX pattern of the second device). In step 1520, the first device transmits a sidelink data and/or a sidelink traffic on the first candidate resource to the second device. For example, the second device may perform monitoring and/or sensing during the first candidate resource based on the signal (and thus, the second device may receive the sidelink data and/or the sidelink traffic, for example).

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to transmit a message indicating a configuration or an information to the second device, wherein the configuration or the information indicates a plurality of opportunities to transmit on the sidelink resource pool and/or to transmit a signal, (ii) to transmit the signal on a third candidate resource among the plurality of opportunities, wherein the signal indicates to the second device to keep monitoring and/or sensing (regardless of a DRX pattern of the second device, for example), (iii) to select a first candidate resource, wherein the first candidate resource is in a sleep time of the second device, and (iv) to transmit a sidelink data and/or a sidelink traffic on the first candidate resource to the second device. Furthermore, the CPU 308 can execute the program code 312 to perform one, some and/or all of the above-described actions and steps and/or others described herein.

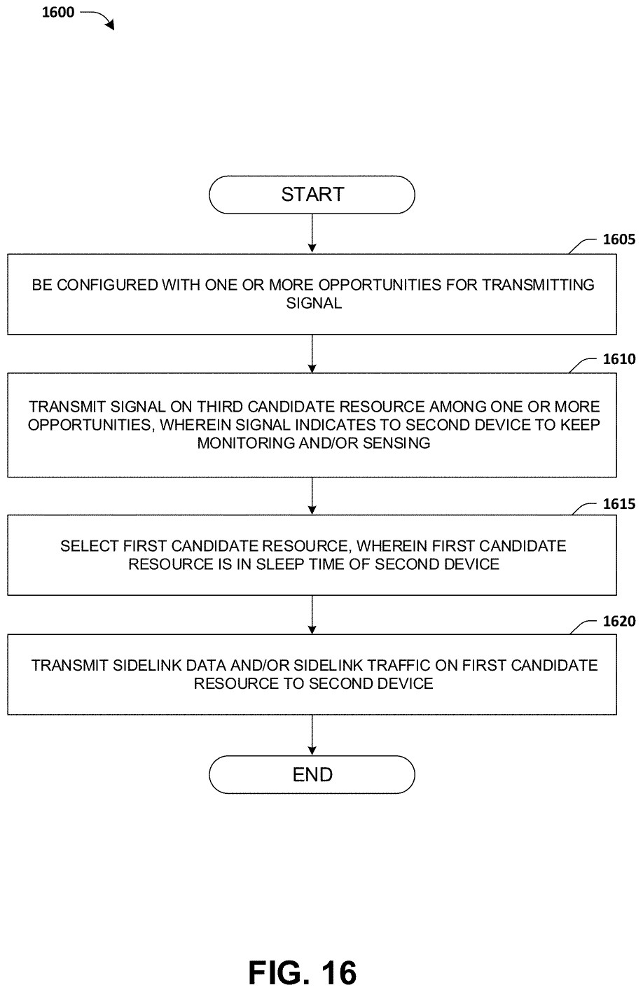

FIG. 16 is a flow chart 1600 according to one exemplary embodiment from the perspective of a first device performing sidelink communication with a second device using a sidelink resource pool, wherein the second device monitors discontinuously (e.g., the second device monitors the sidelink resource pool discontinuously). In step 1605, the first device is configured (e.g., pre-configured) with one or more opportunities for transmitting a signal. In step 1610, the first device transmits the signal on a third candidate resource among the one or more opportunities, wherein the signal indicates to (and/or instructs) the second device to keep monitoring and/or sensing (regardless of a DRX pattern of the second device, for example). In step 1615, the first device selects a first candidate resource, wherein the first candidate resource is in a sleep time of the second device (e.g., an original sleep time of the second device, such as a sleep time corresponding to the DRX pattern of the second device). In step 1620, the first device transmits a sidelink data and/or a sidelink traffic on the first candidate resource to the second device. For example, the second device may perform monitoring and/or sensing during the first candidate resource based on the signal (and thus, the second device may receive the sidelink data and/or the sidelink traffic, for example).

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to be configured with one or more opportunities for transmitting a signal, (ii) to transmit the signal on a third candidate resource among the one or more opportunities, wherein the signal indicates to the second device to keep monitoring and/or sensing (regardless of a DRX pattern of the second device, for example), (iii) to select a first candidate resource, wherein the first candidate resource is in a sleep time of the second device, and (iv) to transmit a sidelink data and/or a sidelink traffic on the first candidate resource to the second device. Furthermore, the CPU 308 can execute the program code 312 to perform one, some and/or all of the above-described actions and steps and/or others described herein.

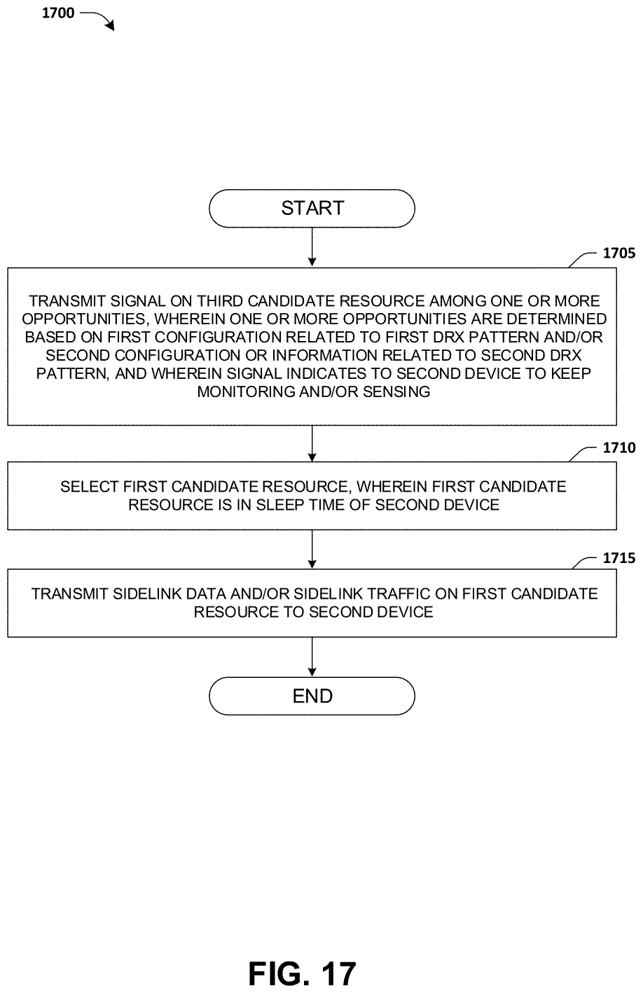

FIG. 17 is a flow chart 1700 according to one exemplary embodiment from the perspective of a first device performing sidelink communication with a second device using a sidelink resource pool, wherein the second device monitors discontinuously (e.g., the second device monitors the sidelink resource pool discontinuously). In step 1705, the first device transmits a signal on a third candidate resource among one or more opportunities, wherein the one or more opportunities are determined (e.g., derived) based on a first configuration related to a first DRX pattern and/or a second configuration or an information related to a second DRX pattern, and wherein the signal indicates to (and/or instructs) the second device to keep monitoring and/or sensing (regardless of a DRX pattern, such as the first DRX pattern and/or the second DRX pattern, of the second device, for example). In step 1710, the first device selects a first candidate resource, wherein the first candidate resource is in a sleep time of the second device (e.g., an original sleep time of the second device, such as a sleep time corresponding to the first DRX pattern and/or the second DRX pattern of the second device). In step 1715, the first device transmits a sidelink data and/or a sidelink traffic on the first candidate resource to the second device. For example, the second device may perform monitoring and/or sensing during the first candidate resource based on the signal (and thus, the second device may receive the sidelink data and/or the sidelink traffic, for example).

Referring back to FIGS. 3 and 4, in one exemplary embodiment of a first device performing sidelink communication with a second device using a sidelink resource pool, the device 300 includes a program code 312 stored in the memory 310. The second device monitors discontinuously (e.g., the second device monitors the sidelink resource pool discontinuously). The CPU 308 could execute program code 312 to enable the first device (i) to transmit a signal on a third candidate resource among one or more opportunities, wherein the one or more opportunities are determined based on a first configuration related to a first DRX pattern and/or a second configuration or an information related to a second DRX pattern, and wherein the signal indicates to the second device to keep monitoring and/or sensing (regardless of a DRX pattern, such as the first DRX pattern and/or the second DRX pattern, of the second device, for example), (ii) to select a first candidate resource, wherein the first candidate resource is in a sleep time of the second device, and (iii) to transmit a sidelink data and/or a sidelink traffic on the first candidate resource to the second device. Furthermore, the CPU 308 can execute the program code 312 to perform one, some and/or all of the above-described actions and steps and/or others described herein.

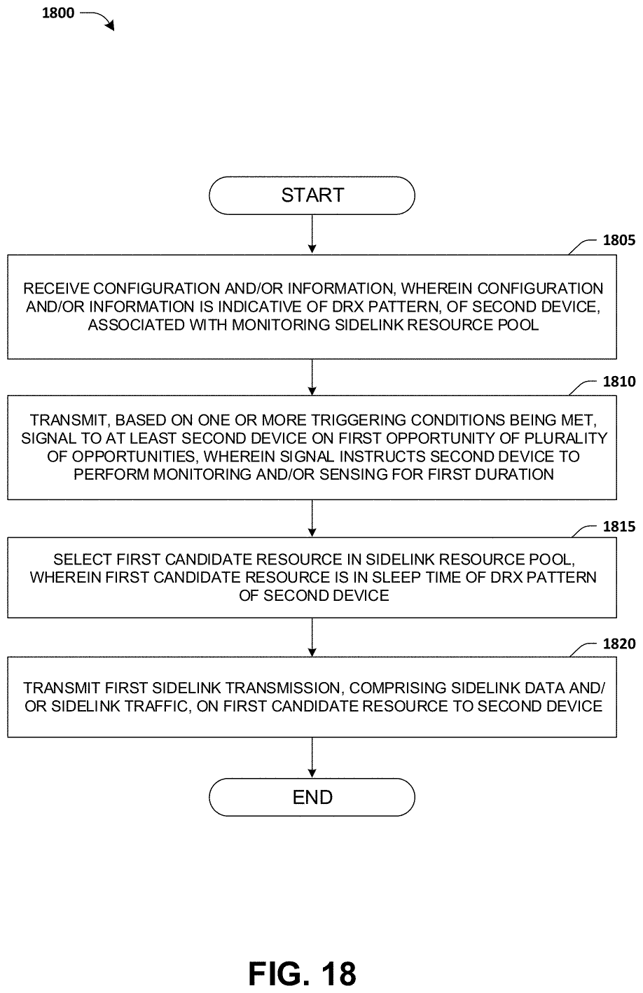

FIG. 18 is a flow chart 1800 according to one exemplary embodiment from the perspective of a first device performing sidelink communication with a second device using a sidelink resource pool. In step 1805, the first device receives a configuration and/or an information, wherein the configuration and/or the information is indicative of a DRX pattern, of the second device, associated with monitoring the sidelink resource pool (e.g., the second device may monitor the sidelink resource pool based on the DRX pattern). In step 1810, the first device transmits, based on one or more triggering conditions being met, a signal to at least the second device on a first opportunity (e.g., on one opportunity) of a plurality of opportunities, wherein the signal instructs (and/or indicates to) the second device to perform monitoring and/or sensing for a first duration. For example, the signal may indicate the second UE to keep (e.g., continue) monitoring and/or sensing for the first duration. Alternatively and/or additionally, the signal may indicate the second UE to extend a time (e.g., a wake up time) during which the second UE monitors and/or senses. In step 1815, the first device selects a first candidate resource in the sidelink resource pool, wherein the first candidate resource is in a sleep time of the DRX pattern of the second device. For example, the sleep time may correspond to an original sleep time of the second device, such as a sleep time with which the second device is configured (via the DRX pattern, for example) before the first device transmits the signal. In step 1820, the first device transmits a first sidelink transmission, comprising a sidelink data and/or a sidelink traffic, on the first candidate resource to the second device.

In some examples, the first candidate resource is within the first duration. For example, the second device may perform monitoring and/or receiving during the first candidate resource based on the signal (and thus, the second device may receive the first sidelink transmission, for example).

In one embodiment, a triggering condition of the one or more triggering conditions is met (and/or the one or more triggering conditions are met) if new sidelink traffic, comprising the sidelink traffic, becomes available for transmission (e.g., available at the first device), wherein the new sidelink traffic is for at least the second device, and/or the new sidelink traffic is for a link between the first device and at least the second device.

In one embodiment, a triggering condition of the one or more triggering conditions is met (and/or the one or more triggering conditions are met) when new sidelink traffic for a link between the first device and at least the second device is coming (e.g., arriving at the first device) and/or when new sidelink data for at least the second device becomes available for transmission.

In one embodiment, the first device determines (and/or derives) a CBR associated with the sidelink resource pool (e.g., the CBR may be derived for and/or over the sidelink resource pool). A triggering condition of the one or more triggering conditions is met (and/or the one or more triggering conditions are met) if the CBR is larger than or equal to a CBR threshold.

In one embodiment, a triggering condition of the one or more triggering conditions is met (and/or the one or more triggering conditions are met) if (and/or when) the first device transmits a BSR (e.g., a SL BSR) indicative of (and/or comprising) a sidelink buffer status associated with a link between the first device and at least the second device (e.g., the sidelink buffer status may be a buffer status for the link). The first device transmits the BSR to a network node.

In one embodiment, a triggering condition of the one or more triggering conditions is met (and/or the one or more triggering conditions are met) if an amount of sidelink traffic (e.g., an amount of remaining sidelink traffic at the first device) for a link between the first device and at least the second device is larger than a size threshold. For example, the amount of sidelink traffic may correspond to an amount of sidelink traffic available for transmission via the link between the first device and at least the second device.

In one embodiment, the first device performs a sidelink resource selection procedure based on a resource selection window to select the first candidate resource. A triggering condition of the one or more triggering conditions is met (and/or the one or more triggering conditions are met) if a number of candidate resources, that are in the resource selection window and in a wake up time of the DRX pattern of the second device, is less than a first number threshold and/or if a number of candidate slots, that are in the resource selection window and in the wake up time of the DRX pattern of the second device, is less than a second number threshold. In one embodiment, the first candidate resource is in the resource selection window.

In one embodiment, the first device performs a sidelink resource selection procedure based on a resource selection window to select the first candidate resource. The first candidate resource is in the resource selection window. A triggering condition of the one or more triggering conditions is met (and/or the one or more triggering conditions are met) if a ratio of first resources to second resources is less than a first ratio threshold and/or if a ratio of first slots to second slots is less than a second ratio threshold. In one embodiment, the first resources may correspond to candidate resources in the sidelink resource pool that are identified by the first device and/or that are in the resource selection window and in a wake up time of the DRX pattern of the second device. The second resources may correspond to a total number of resources that are in the resource selection window and in the wake up time of the DRX pattern of the second device. The first slots may correspond to candidate slots in the sidelink resource pool that are identified by the first device and/or that are in the resource selection window and in the wake up time of the DRX pattern of the second device. The second slots may correspond to a total number of slots that are in the resource selection window and in the wake up time of the DRX pattern of the second device. In one embodiment, the first resources may correspond to candidate resources in the sidelink resource pool that are in the resource selection window and in a wake up time of the DRX pattern of the second device. The second resources may correspond to candidate resources in the sidelink resource pool that are in the resource selection window. The first slots may correspond to candidate slots in the sidelink resource pool that are in the resource selection window and in a wake up time of the DRX pattern of the second device. The second slots may correspond to candidate slots in the sidelink resource pool that are in the resource selection window.

In one embodiment, the first device triggers and/or performs a sidelink resource selection procedure to select at least one sidelink resource (e.g., the first candidate resource) in a resource selection window.

In one embodiment, a triggering condition of the one or more triggering conditions is met (and/or the one or more triggering conditions are met) if the first device has at least one opportunity (e.g., available and/or valid opportunity) to transmit the signal (and/or if the at least one opportunity is before the first candidate resource).

In one embodiment, a triggering condition of the one or more triggering conditions is met (and/or the one or more triggering conditions are met) if a first priority of the sidelink traffic and/or a second priority of the sidelink data is higher than a priority threshold.

In one embodiment, a triggering condition of the one or more triggering conditions is met (and/or the one or more triggering conditions are met) if a first latency requirement of the sidelink traffic and/or a second latency requirement of the sidelink data is shorter than a latency threshold (e.g., the first latency requirement corresponds to a first latency that is shorter than the latency threshold and/or the second latency requirement corresponds to a second latency that is shorter than the latency threshold).

In one embodiment, the sidelink traffic is aperiodic sidelink traffic and/or the sidelink traffic is not associated with a service with a periodic data pattern.

In one embodiment, the signal is used for disabling and/or deactivating the DRX pattern of the second device for at least the first duration (such that the DRX pattern is not effective and/or applied by the second device for at least the first duration, for example). In one embodiment, the signal is used for disabling and/or deactivating DRX functionality of the second device for at least the first duration (such that monitoring performed by the second device during at least the first duration is not based on the DRX functionality and/or the DRX pattern, for example).

In one embodiment, the signal indicates a length of time for the DRX pattern of the second device to be disabled and/or deactivated.

In one embodiment, the signal indicates one or more DRX periods (e.g., the signal may indicate to (and/or instruct) the second device to disable and/or deactivate the DRX pattern and/or to be in wake up mode for the one or more DRX periods).

In one embodiment, the signal indicates the first duration.

In one embodiment, the first duration ends at a next opportunity, following the first opportunity, of the plurality of opportunities (e.g., the next opportunity may correspond to an opportunity following the first opportunity, where no other opportunity of the plurality of opportunities is between the first opportunity and the next opportunity).

In one embodiment, the first duration ends at an end of the one or more DRX periods and/or a start of a next DRX period following the one or more DRX periods (e.g., the next DRX period may correspond to a DRX period following the one or more DRX periods, where no other DRX period is between the one or more DRX periods and the next DRX period).

In one embodiment, the first duration ends at a start of a next DRX period following a current DRX period. The current DRX period may correspond to a DRX period during which the signal is transmitted. The next DRX period may correspond to a DRX period following the current DRX period, where no other DRX period is between the current DRX period and the next DRX period.

In one embodiment, the first duration comprises a current DRX cycle (and/or a portion of the current DRX cycle). The current DRX cycle may correspond to a DRX cycle during which the signal is transmitted.

In one embodiment, the signal instructs (and/or indicates to) the second device to switch from a first BWP to a second BWP.

In one embodiment, the first BWP is narrower than the second BWP. The first BWP is a partial BWP of the second BWP. The first BWP comprises partial bandwidth of the second BWP.

In one embodiment, the first BWP is wider than the second BWP. The second BWP is a partial BWP of the first BWP. The second BWP comprises partial bandwidth of the first BWP.

In one embodiment, opportunities of the plurality of opportunities are periodic (e.g., the plurality of opportunities are in a periodic manner). Alternatively and/or additionally, transmitting the signal is performed on symbols comprising PSFCH resources in the sidelink resource pool and on one or more frequency units without PSFCH resources (e.g., without any PSFCH resources). Alternatively and/or additionally, transmitting the signal is performed on symbols comprising PSFCH resources in the sidelink resource pool and on one or more frequency units not configured for PSFCH resources (e.g., not configured for any PSFCH resources).

In one embodiment, the signal is a MAC CE.

In one embodiment, the signal is a sidelink control information.

In one embodiment, the signal is a reference signal.

In one embodiment, the signal is a stand-alone sidelink control information.

In one embodiment, transmitting the signal is performed via PSCCH, PSSCH or PSFCH.

In one embodiment, transmitting the first sidelink transmission to the second device is performed after transmitting the signal to at least the second device.

In one embodiment, a first time of the first candidate resource is after a second time that the first device transmits the signal. For example, the first candidate resource may be in a timing (and/or a time unit and/or a slot) that is after the first device transmits the signal.

In one embodiment, the first device receives, from the second device, a response to the signal. A timing of the first candidate resource is during the first duration. Selecting the first candidate resource that is in the sleep time of the DRX pattern of the second device is based on and/or in response to receiving the response to the signal. For example, the first device may be allowed and/or configured to select a candidate resource (e.g., the first candidate resource) in the sleep time of the DRX pattern of the second device based on (and/or in response to) receiving the response to the signal.

Referring back to FIGS. 3 and 4, in one exemplary embodiment of a first device performing sidelink communication with a second device using a sidelink resource pool, the device 300 includes a program code 312 stored in the memory 310. The CPU 308 could execute program code 312 to enable the first device (i) to receive a configuration and/or an information, wherein the configuration and/or the information is indicative of a DRX pattern, of the second device, associated with monitoring the sidelink resource pool, (ii) to transmit, based on one or more triggering conditions being met, a signal to at least the second device on a first opportunity of a plurality of opportunities, wherein the signal instructs (and/or indicates to) the second device to perform monitoring and/or sensing for a first duration, (iii) to select a first candidate resource in the sidelink resource pool, wherein the first candidate resource is in a sleep time of the DRX pattern of the second device, and (iv) to transmit a first sidelink transmission, comprising a sidelink data and/or a sidelink traffic, on the first candidate resource to the second device. Furthermore, the CPU 308 can execute the program code 312 to perform one, some and/or all of the above-described actions and steps and/or others described herein.

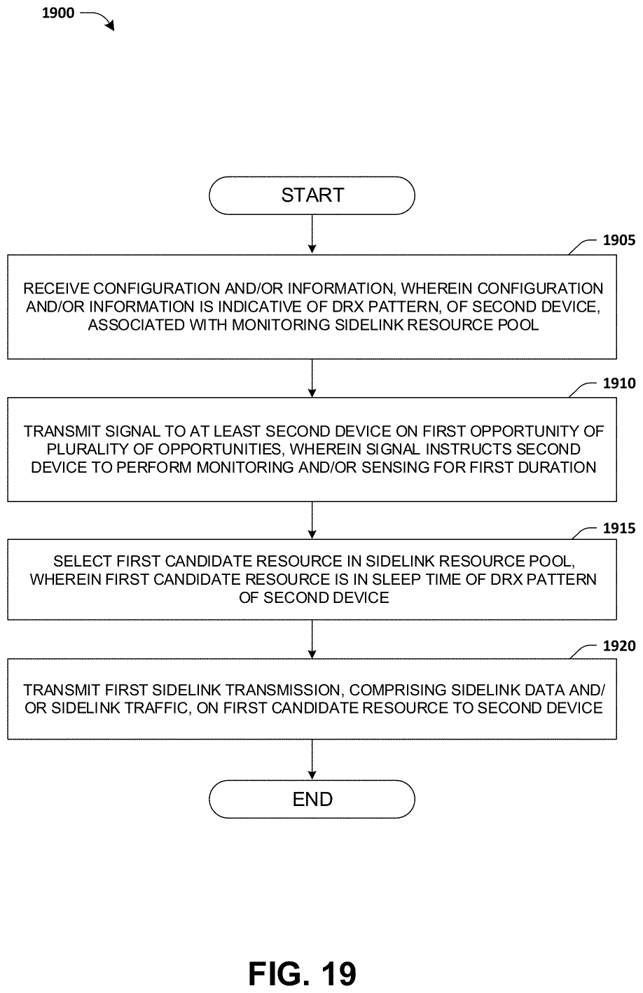

FIG. 19 is a flow chart 1900 according to one exemplary embodiment from the perspective of a first device performing sidelink communication with a second device using a sidelink resource pool. In step 1905, the first device receives a configuration and/or an information, wherein the configuration and/or the information is indicative of a DRX pattern, of the second device, associated with monitoring the sidelink resource pool (e.g., the second device may monitor the sidelink resource pool based on the DRX pattern). In step 1910, the first device transmits a signal to at least the second device on a first opportunity (e.g., on one opportunity) of a plurality of opportunities, wherein the signal instructs (and/or indicates to) the second device to perform monitoring and/or sensing for a first duration. For example, the signal may indicate the second UE to keep (e.g., continue) monitoring and/or sensing for the first duration. Alternatively and/or additionally, the signal may indicate the second UE to extend a time (e.g., a wake up time) during which the second UE monitors and/or senses. In step 1915, the first device selects a first candidate resource in the sidelink resource pool, wherein the first candidate resource is in a sleep time of the DRX pattern of the second device. For example, the sleep time may correspond to an original sleep time of the second device, such as a sleep time with which the second device is configured (via the DRX pattern, for example) before the first device transmits the signal. In step 1920, the first device transmits a first sidelink transmission, comprising a sidelink data and/or a sidelink traffic, on the first candidate resource to the second device.

In some examples, the first candidate resource is within the first duration. For example, the second device may perform monitoring and/or receiving during the first candidate resource based on the signal (and thus, the second device may receive the first sidelink transmission, for example).

In one embodiment, the first device receives, from the second device, a response to the signal. A timing of the first candidate resource is during the first duration. Selecting the first candidate resource that is in the sleep time of the DRX pattern of the second device is based on and/or in response to receiving the response to the signal. For example, the first device may be allowed and/or configured to select a candidate resource (e.g., the first candidate resource) in the sleep time of the DRX pattern of the second device based on (and/or in response to) receiving the response to the signal.

In one embodiment, the sidelink traffic is aperiodic sidelink traffic and/or the sidelink traffic is not associated with a service with a periodic data pattern.

In one embodiment, the signal is used for disabling and/or deactivating the DRX pattern of the second device for at least the first duration (such that the DRX pattern is not effective and/or applied by the second device for at least the first duration, for example). In one embodiment, the signal is used for disabling and/or deactivating DRX functionality of the second device for at least the first duration (such that monitoring performed by the second device during at least the first duration is not based on the DRX functionality and/or the DRX pattern, for example).

In one embodiment, the signal indicates a length of time for the DRX pattern of the second device to be disabled and/or deactivated.

In one embodiment, the signal indicates one or more DRX periods (e.g., the signal may indicate to (and/or instruct) the second device to disable and/or deactivate the DRX pattern and/or to be in wake up mode for the one or more DRX periods).

In one embodiment, the signal indicates the first duration.

In one embodiment, the first duration ends at a next opportunity, following the first opportunity, of the plurality of opportunities (e.g., the next opportunity may correspond to an opportunity following the first opportunity, where no other opportunity of the plurality of opportunities is between the first opportunity and the next opportunity).

In one embodiment, the first duration ends at an end of the one or more DRX periods and/or a start of a next DRX period following the one or more DRX periods (e.g., the next DRX period may correspond to a DRX period following the one or more DRX periods, where no other DRX period is between the one or more DRX periods and the next DRX period).

In one embodiment, the first duration ends at a start of a next DRX period following a current DRX period. The current DRX period may correspond to a DRX period during which the signal is transmitted. The next DRX period may correspond to a DRX period following the current DRX period, where no other DRX period is between the current DRX period and the next DRX period.

In one embodiment, the first duration comprises a current DRX cycle (and/or a portion of the current DRX cycle). The current DRX cycle may correspond to a DRX cycle during which the signal is transmitted.

In one embodiment, the signal instructs (and/or indicates to) the second device to switch from a first BWP to a second BWP.

In one embodiment, the first BWP is narrower than the second BWP. The first BWP is a partial BWP of the second BWP. The first BWP comprises partial bandwidth of the second BWP.

In one embodiment, the first BWP is wider than the second BWP. The second BWP is a partial BWP of the first BWP. The second BWP comprises partial bandwidth of the first BWP.

In one embodiment, opportunities of the plurality of opportunities are periodic (e.g., the plurality of opportunities are in a periodic manner). Alternatively and/or additionally, transmitting the signal is performed on symbols comprising PSFCH resources in the sidelink resource pool and on one or more frequency units without PSFCH resources (e.g., without any PSFCH resources). Alternatively and/or additionally, transmitting the signal is performed on symbols comprising PSFCH resources in the sidelink resource pool and on one or more frequency units not configured for PSFCH resources (e.g., not configured for any PSFCH resources).

In one embodiment, the signal is a MAC CE.

In one embodiment, the signal is a sidelink control information.

In one embodiment, the signal is a reference signal.

In one embodiment, the signal is a stand-alone sidelink control information.

In one embodiment, transmitting the signal is performed via PSCCH, PSSCH or PSFCH.

In one embodiment, transmitting the first sidelink transmission to the second device is performed after transmitting the signal to at least the second device.

In one embodiment, a first time of the first candidate resource is after a second time that the first device transmits the signal. For example, the first candidate resource may be in a timing (and/or a time unit and/or a slot) that is after the first device transmits the signal.

Referring back to FIGS. 3 and 4, in one exemplary embodiment of a first device performing sidelink communication with a second device using a sidelink resource pool, the device 300 includes a program code 312 stored in the memory 310. The CPU 308 could execute program code 312 to enable the first device (i) to receive a configuration and/or an information, wherein the configuration and/or the information is indicative of a DRX pattern, of the second device, associated with monitoring the sidelink resource pool, (ii) to transmit a signal to at least the second device on a first opportunity of a plurality of opportunities, wherein the signal instructs (and/or indicates to) the second device to perform monitoring and/or sensing for a first duration, (iii) to select a first candidate resource in the sidelink resource pool, wherein the first candidate resource is in a sleep time of the DRX pattern of the second device, and (iv) to transmit a first sidelink transmission, comprising a sidelink data and/or a sidelink traffic, on the first candidate resource to the second device. Furthermore, the CPU 308 can execute the program code 312 to perform one, some and/or all of the above-described actions and steps and/or others described herein.

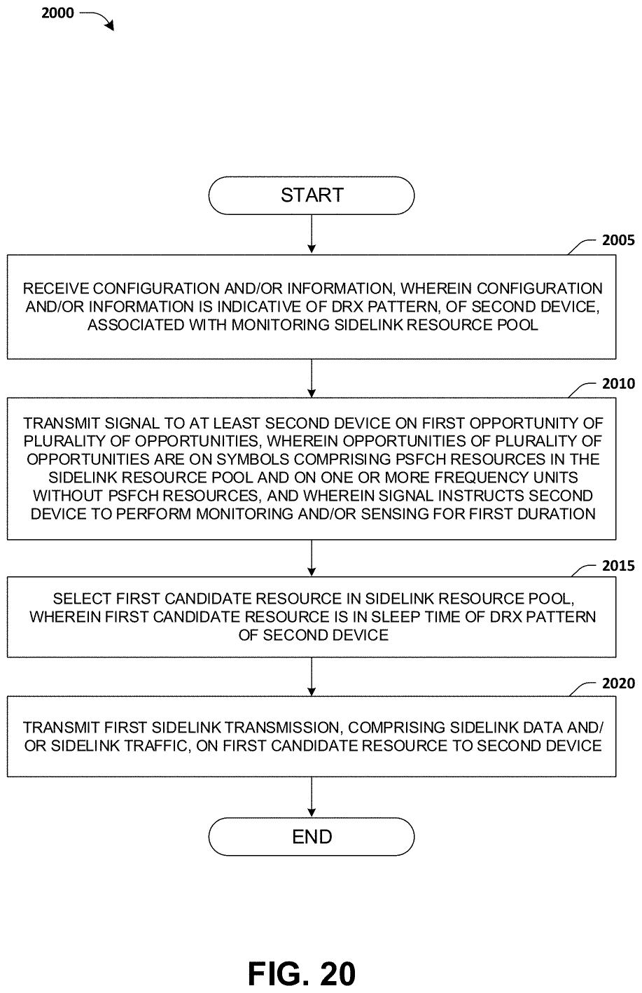

FIG. 20 is a flow chart 2000 according to one exemplary embodiment from the perspective of a first device performing sidelink communication with a second device using a sidelink resource pool. PSFCH resources of the sidelink resource pool are configured, periodically with a period of N slots, in slots of the sidelink resource pool. In step 2005, the first device receives a configuration and/or an information, wherein the configuration and/or the information is indicative of a DRX pattern, of the second device, associated with monitoring the sidelink resource pool (e.g., the second device may monitor the sidelink resource pool based on the DRX pattern). In step 2010, the first device transmits a signal to at least the second device on a first opportunity (e.g., on one opportunity) of a plurality of opportunities, wherein opportunities of the plurality of opportunities are on symbols comprising PSFCH resources in the sidelink resource pool and on one or more frequency units without PSFCH resources (e.g., one or more frequency units without any PSFCH resources), and wherein the signal instructs (and/or indicates to) the second device to perform monitoring and/or sensing for a first duration. For example, the signal may indicate the second UE to keep (e.g., continue) monitoring and/or sensing for the first duration. Alternatively and/or additionally, the signal may indicate the second UE to extend a time (e.g., a wake up time) during which the second UE monitors and/or senses. In step 2015, the first device selects a first candidate resource in the sidelink resource pool, wherein the first candidate resource is in a sleep time of the DRX pattern of the second device. For example, the sleep time may correspond to an original sleep time of the second device, such as a sleep time with which the second device is configured (via the DRX pattern, for example) before the first device transmits the signal. In step 2020, the first device transmits a first sidelink transmission, comprising a sidelink data and/or a sidelink traffic, on the first candidate resource to the second device.

In some examples, the first candidate resource is within the first duration. For example, the second device may perform monitoring and/or receiving during the first candidate resource based on the signal (and thus, the second device may receive the first sidelink transmission, for example).

In one embodiment, the signal indicates a length of time for the DRX pattern of the second device to be disabled and/or deactivated.

In one embodiment, the signal indicates one or more DRX periods (e.g., the signal may indicate to (and/or instruct) the second device to disable and/or deactivate the DRX pattern and/or to be in wake up mode for the one or more DRX periods).

In one embodiment, the signal indicates the first duration.

In one embodiment, the first duration ends at a next opportunity, following the first opportunity, of the plurality of opportunities (e.g., the next opportunity may correspond to an opportunity following the first opportunity, where no other opportunity of the plurality of opportunities is between the first opportunity and the next opportunity).

In one embodiment, the first duration ends at an end of the one or more DRX periods and/or a start of a next DRX period following the one or more DRX periods (e.g., the next DRX period may correspond to a DRX period following the one or more DRX periods, where no other DRX period is between the one or more DRX periods and the next DRX period).

In one embodiment, the first duration ends at a start of a next DRX period following a current DRX period. The current DRX period may correspond to a DRX period during which the signal is transmitted. The next DRX period may correspond to a DRX period following the current DRX period, where no other DRX period is between the current DRX period and the next DRX period.

In one embodiment, the first duration comprises a current DRX cycle (and/or a portion of the current DRX cycle). The current DRX cycle may correspond to a DRX cycle during which the signal is transmitted.

In one embodiment, the sidelink traffic is aperiodic sidelink traffic and/or the sidelink traffic is not associated with a service with a periodic data pattern.

In one embodiment, the signal is used for disabling and/or deactivating the DRX pattern of the second device for at least the first duration (such that the DRX pattern is not effective and/or applied by the second device for at least the first duration, for example). In one embodiment, the signal is used for disabling and/or deactivating DRX functionality of the second device for at least the first duration (such that monitoring performed by the second device during at least the first duration is not based on the DRX functionality and/or the DRX pattern, for example).

In one embodiment, the signal instructs (and/or indicates to) the second device to switch from a first BWP to a second BWP.

In one embodiment, the first BWP is narrower than the second BWP. The first BWP is a partial BWP of the second BWP. The first BWP comprises partial bandwidth of the second BWP.

In one embodiment, the first BWP is wider than the second BWP. The second BWP is a partial BWP of the first BWP. The second BWP comprises partial bandwidth of the first BWP.

In one embodiment, the signal is a MAC CE.

In one embodiment, the signal is a sidelink control information.

In one embodiment, the signal is a reference signal.

In one embodiment, the signal is a stand-alone sidelink control information.

In one embodiment, transmitting the signal is performed via PSCCH, PSSCH or PSFCH.

In one embodiment, transmitting the first sidelink transmission to the second device is performed after transmitting the signal to at least the second device.

In one embodiment, a first time of the first candidate resource is after a second time that the first device transmits the signal. For example, the first candidate resource may be in a timing (and/or a time unit and/or a slot) that is after the first device transmits the signal.

In one embodiment, the first device receives, from the second device, a response to the signal. A timing of the first candidate resource is during the first duration. Selecting the first candidate resource that is in the sleep time of the DRX pattern of the second device is based on and/or in response to receiving the response to the signal. For example, the first device may be allowed and/or configured to select a candidate resource (e.g., the first candidate resource) in the sleep time of the DRX pattern of the second device based on (and/or in response to) receiving the response to the signal.

Referring back to FIGS. 3 and 4, in one exemplary embodiment of a first device, the device 300 includes a program code 312 stored in the memory 310. PSFCH resources of the sidelink resource pool are configured, periodically with a period of N slots, in slots of the sidelink resource pool. The CPU 308 could execute program code 312 to enable the first device (i) to receive a configuration and/or an information, wherein the configuration and/or the information is indicative of a DRX pattern, of the second device, associated with monitoring the sidelink resource pool, (ii) to transmit a signal to at least the second device on a first opportunity of a plurality of opportunities, wherein opportunities of the plurality of opportunities are on symbols comprising PSFCH resources in the sidelink resource pool and on one or more frequency units without PSFCH resources, and wherein the signal instructs (and/or indicates to) the second device to perform monitoring and/or sensing for a first duration, (iii) to select a first candidate resource in the sidelink resource pool, wherein the first candidate resource is in a sleep time of the DRX pattern of the second device, and (iv) to transmit a first sidelink transmission, comprising a sidelink data and/or a sidelink traffic, on the first candidate resource to the second device. Furthermore, the CPU 308 can execute the program code 312 to perform one, some and/or all of the above-described actions and steps and/or others described herein.

A communication device (e.g., a device, a sidelink device, a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 11-20. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 11-20, and/or one, some and/or all of the above-described actions and steps and/or others described herein.

It may be appreciated that applying one or more of the techniques presented herein may result in one or more benefits including, but not limited to, increased efficiency of communication between devices (e.g., a first device and a second device performing sidelink communication). The increased efficiency may be a result of enabling the first device to transmit a communication (e.g., sidelink traffic and/or sidelink data) to the second device within a resource selection window, even if a sleep time of a DRX pattern of the second device is during the resource selection window. For example, the first device may transmit a signal indicating to (and/or instructing) the second device to perform monitoring and/or sensing on a candidate resource selected for transmission of the communication, and thus the second device may receive the communication on the candidate resource (even if the candidate resource is during the sleep time of the DRX pattern of the second device). Accordingly, the first device may not have to retransmit the communication to the second device.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a first device performing sidelink communication with a second device using a sidelink resource pool, the method comprising:
receiving at least one of a configuration or an information, wherein at least one of the configuration or the information is indicative of a Discontinuous Reception (DRX) pattern, of the second device, associated with monitoring the sidelink resource pool;
transmitting, based on one or more triggering conditions being met, a signal to at least the second device on a first opportunity of a plurality of opportunities, wherein the signal indicates the second device to perform at least one of monitoring or sensing for a first duration;
selecting a first candidate resource in the sidelink resource pool, wherein the first candidate resource is in a sleep time of the DRX pattern of the second device; and
transmitting a first sidelink transmission, comprising at least one of a sidelink data or a sidelink traffic, on the first candidate resource to the second device.

2. The method of claim 1, wherein a triggering condition of the one or more triggering conditions is met if:
new sidelink traffic, comprising the sidelink traffic, becomes available for transmission, wherein the new sidelink traffic is at least one of:
for at least the second device; or
for a link between the first device and at least the second device.

3. The method of claim 1, comprising:
determining a channel busy ratio (CBR) associated with the sidelink resource pool, wherein a triggering condition of the one or more triggering conditions is met if the CBR is larger than or equal to a CBR threshold.

4. The method of claim 1, wherein a triggering condition of the one or more triggering conditions is met if:
the first device transmits a buffer status report (BSR), to a network node, indicative of a sidelink buffer status associated with a link between the first device and at least the second device.

5. The method of claim 1, wherein a triggering condition of the one or more triggering conditions is met if:
an amount of sidelink traffic for a link between the first device and at least the second device is larger than a size threshold.

6. The method of claim 1, comprising:
performing a sidelink resource selection procedure based on a resource selection window to select the first candidate resource, wherein:
a triggering condition of the one or more triggering conditions is met if at least one of:
a number of candidate resources, that are in the resource selection window and in a wake up time of the DRX pattern of the second device, is less than a first number threshold; or
a number of candidate slots, that are in the resource selection window and in the wake up time of the DRX pattern of the second device, is less than a second number threshold.

7. The method of claim 1, wherein a triggering condition of the one or more triggering conditions is met if:
the first device has at least one opportunity to transmit the signal.

8. The method of claim 1, wherein a triggering condition of the one or more triggering conditions is met if:
at least one of a first priority of the sidelink traffic or a second priority of the sidelink data is higher than a priority threshold.

9. The method of claim 1, wherein a triggering condition of the one or more triggering conditions is met if:
at least one of a first latency requirement of the sidelink traffic or a second latency requirement of the sidelink data is shorter than a latency threshold.

10. The method of claim 1, wherein at least one of:
the sidelink traffic is aperiodic sidelink traffic; or
the sidelink traffic is not associated with a service with a periodic data pattern.

11. The method of claim 1, wherein:
the signal is used for at least one of disabling or deactivating the DRX pattern of the second device for at least the first duration.

12. The method of claim 1, wherein at least one of:
the signal indicates a length of time for the DRX pattern of the second device to be at least one of disabled or deactivated;
the signal indicates one or more DRX periods;
the signal indicates the first duration;
the first duration ends at a next opportunity, following the first opportunity, of the plurality of opportunities;
the first duration ends at at least one of an end of the one or more DRX periods or a start of a next DRX period following the one or more DRX periods;
the first duration ends at a start of a next DRX period following a current DRX period; or
the first duration comprises a current DRX cycle.

13. The method of claim 1, wherein:
the signal indicates the second device to switch from a first Bandwidth Part (BWP) to a second BWP; and
one of:
at least one of the first BWP is narrower than the second BWP or the first BWP is a partial BWP of the second BWP; or
at least one of the first BWP is wider than the second BWP or the second BWP is a partial BWP of the first BWP.

14. The method of claim 1, wherein at least one of:
opportunities of the plurality of opportunities are periodic;
transmitting the signal is performed on symbols comprising Physical Sidelink Feedback Channel (PSFCH) resources in the sidelink resource pool and on one or more frequency units without PSFCH resources; or
transmitting the signal is performed on symbols comprising PSFCH resources in the sidelink resource pool and on one or more frequency units not configured for PSFCH resources.

15. The method of claim 1, wherein at least one of:
the signal is a Medium Access Control Control Element (MAC CE);
the signal is a sidelink control information;
the signal is a reference signal;
the signal is a stand-alone sidelink control information;
transmitting the signal is performed via Physical Sidelink Control Channel (PSCCH), Physical Sidelink Shared Channel (PSSCH) or Physical Sidelink Feedback Channel (PSFCH).

16. The method of claim 1, wherein:
transmitting the first sidelink transmission to the second device is performed after transmitting the signal to at least the second device.

17. A first device performing sidelink communication with a second device using a sidelink resource pool, the first device comprising:
a control circuit;
a processor installed in the control circuit; and
a memory installed in the control circuit and operatively coupled to the processor, wherein the processor is configured to execute a program code stored in the memory to perform operations, the operations comprising:
receiving at least one of a configuration or an information, wherein at least one of the configuration or the information is indicative of a Discontinuous Reception (DRX) pattern, of the second device, associated with monitoring the sidelink resource pool;
transmitting a signal to at least the second device on a first opportunity of a plurality of opportunities, wherein the signal indicates the second device to perform at least one of monitoring or sensing for a first duration;
selecting a first candidate resource in the sidelink resource pool, wherein the first candidate resource is in a sleep time of the DRX pattern of the second device; and
transmitting a first sidelink transmission, comprising at least one of a sidelink data or a sidelink traffic, on the first candidate resource to the second device.

18. The first device of claim 17, the operations comprising:
receiving, from the second device, a response to the signal, wherein at least one of:
a timing of the first candidate resource is during the first duration; or
selecting the first candidate resource that is in the sleep time of the DRX pattern of the second device is allowed responsive to receiving the response to the signal.

19. A non-transitory computer-readable medium comprising processor-executable instructions, that when executed by a first device performing sidelink communication with a second device using a sidelink resource pool, cause performance of operations, the operations comprising:
receiving at least one of a configuration or an information, wherein:
at least one of the configuration or the information is indicative of a Discontinuous Reception (DRX) pattern, of the second device, associated with monitoring the sidelink resource pool; and
Physical Sidelink Feedback Channel (PSFCH) resources of the sidelink resource pool are configured, periodically with a period of N slots, in slots of the sidelink resource pool;
transmitting a signal to at least the second device on a first opportunity of a plurality of opportunities, wherein:
opportunities of the plurality of opportunities are on symbols comprising PSFCH resources in the sidelink resource pool and on one or more frequency units without PSFCH resources; and
the signal indicates the second device to perform at least one of monitoring or sensing for a first duration;
selecting a first candidate resource in the sidelink resource pool, wherein the first candidate resource is in a sleep time of the DRX pattern of the second device; and
transmitting a first sidelink transmission, comprising at least one of a sidelink data or a sidelink traffic, on the first candidate resource to the second device.

20. The non-transitory computer-readable medium of claim 19, wherein at least one of:
the signal indicates a length of time for the DRX pattern of the second device to be at least one of disabled or deactivated;
the signal indicates one or more DRX periods;
the signal indicates the first duration;
the first duration ends at a next opportunity, following the first opportunity, of the plurality of opportunities;
the first duration ends at at least one of an end of the one or more DRX periods or a start of a next DRX period following the one or more DRX periods;
the first duration ends at a start of a next DRX period following a current DRX period; or
the first duration comprises a current DRX cycle.
